(19) United States
(12) Patent Application Publication
(10) Pub. No.: US 2011/0319266 A1
(43) Pub. Date: Dec. 29, 2011

(54) HERBICIDAL COMPOSITION

(76) Inventors: Seiji Yamato, Nishinomiya-shi (JP); Yoshinobu Jin, Toyonaka-shi (JP)

(21) Appl. No.: 13/255,131

(22) PCT Filed: Mar. 12, 2010
(86) PCT No.: PCT/JP2010/054723

§ 371 Date: Sep. 7, 2011

(30) Foreign Application Priority Data
Mar. 13, 2009 (JP) 2009-060944

(51) Int. Cl. A01N 43/58; A01N 57/16; A01P 13/00; A01N 57/24

(52) U.S. Cl. 504/128; 504/137; 504/127

(57) ABSTRACT

There is provided a herbicidal composition containing compound represented by the formula (I): a compound rep-resented by the formula (I): wherein R¹ represents a C₁₋₆ alkyl group etc., R² represents hydrogen etc., G represents hydrogen etc., Z¹ represents a C₁₋₆ alkyl group, Z² represents a C₁₋₆ alkyl group, and n represents 0, 1, 2, 3 or 4; at least one compound selected from Group A consisting of metsulfuron-methyl, thif ensulf uron-methyl, etc.; and at least one compound selected from Group B consisting off enchlorazole-ethyl, cloquintocet-mexyl, and mef enpyr-diethyl.

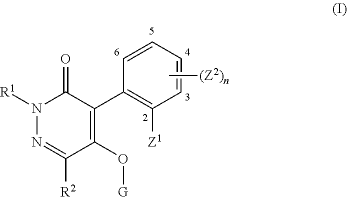

### TECHNICAL FIELD

The present invention relates to a herbicidal composition.

### BACKGROUND ART

Nowadays, a large number of herbicides are used. However, there are many kinds of weeds to be controlled and weeds grow over a long period. Therefore, there is a need for herbicides having high herbicidal activity, a wide spectrum of herbicidal activity and excellent crop selectivity.

WO 2007/119434 discloses that a certain pyridazinone compound has herbicidal activity.

The present invention is to provide a novel herbicidal composition.

### DISCLOSURE OF THE INVENTION

The present invention provides:

[1] A herbicidal composition containing a pyridazinone compound represented by the formula (I) (hereinafter may be referred to as the present compound), at least one compound selected from Group A and at least one compound selected from group B (hereinafter referred to as the herbicidal composition of the present invention).

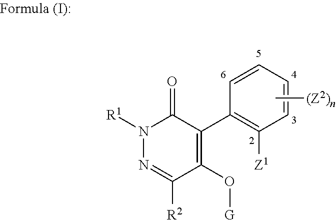

wherein R¹ represents a C₁₋₆ alkyl group or a (C₁₋₆ alkyloxy)C₁₋₆ alkyl group,
R² represents hydrogen or a C₁₋₆ alkyl group,
G represents hydrogen, a group represented by the formula:

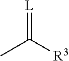

a group represented by the formula:

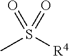

or a group represented by the formula:

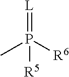

[wherein L represents oxygen or sulfur,

R³ represents a C₁₋₆ alkyl group, a C₃₋₈ cycloalkyl group, a C₂₋₆ alkenyl group, a C₂₋₆ alkynyl group, a C₆₋₁₀ aryl group, a (C₆₋₁₀ aryl)C₁₋₆ alkyl group, a C₁₋₆ alkyloxy group, a C₃₋₈ cycloalkyloxy group, a C₂₋₆ alkenyloxy group, a C₂₋₆ alkynyloxy group, a C₆₋₁₀ aryloxy group, a (C₆₋₁₀ aryl)C₁₋₆ alkyloxy group, an amino group, a C₁₋₆ alkylamino group, a C₂₋₆ alkenylamino group, a C₆₋₁₀ arylamino group, a di(C₁₋₆ alkyl)amino group, a di(C₂₋₆ alkenyl)amino group, a (C₁₋₆ alkyl) (C₆₋₁₀ aryl)amino group, or a 3- to 8-membered nitrogen-containing heterocyclic group,

R⁴ represents a C₁₋₆ alkyl group, a C₆₋₁₀aryl group, a C₁₋₆ alkylamino group or a di(C₁₋₆ alkyl)amino group, and

R⁵ and R⁶ may be the same or different, and represent a C₁₋₆ alkyl group, a C₃₋₈ cycloalkyl group, a C₂₋₆ alkenyl group, a C₆₋₁₀ aryl group, a C₁₋₆ alkyloxy group, a C₂₋₆ cycloalkyloxy group, a C₆₋₁₀ aryloxy group, a (C₆₋₁₀ aryl)C₁₋₆ alkyloxy group, a C₁₋₆ alkylthio group, a C₁₋₆ alkylamino group or a di(C₁₋₆ alkyl)amino group, wherein, each group represented by R³, R⁴, R⁵ and R⁶ is optionally halogenated, and the C₃₋₈ cycloalkyl group, the C₆₋₁₀ aryl group, the aryl moiety of the (C₆₋₁₀ aryl)C₁₋₆ alkyl group, the C₃₋₈ cycloalkyloxy group, the C₆₋₁₀ aryloxy group, the aryl moiety of the (C₆₋₁₀ aryl)C₁₋₆ alkyloxy group, the aryl moiety of the C₆₋₁₀ arylamino group, the aryl moiety of the (C₁₋₆ alkyl)(C₆₋₁₀ aryl)amino group, and the 3- to 8-membered nitrogen-containing heterocyclic group are optionally C₁₋₆ alkylated],

Z¹ represents a C₁₋₆ alkyl group,
Z² represents a C₁₋₆ alkyl group, and
n represents 0, 1, 2, 3 or 4, and when n represents an integer of 2 or more, each Z² may be the same or different, provided that the total number of carbon atoms in the groups represented by Z¹ and (Z²)n is two or more.

Group A: a group consisting of metsulfuron-methyl, thifensulfuron-methyl, tribenuron-methyl, chlorsulfuron, florasulam, bromoxynil or an agriculturally acceptable ester or salt thereof, pyrasulfotole, dicamba or an agriculturally acceptable ester or salt thereof, fluoroxypyr or an agriculturally acceptable ester thereof, 2,4-D or an agriculturally acceptable ester or salt thereof, and clopyralid or an agriculturally acceptable salt thereof.

Group B: a group consisting of fenchlorazole-ethyl, cloquintocet-mexyl, and mefenpyr-diethyl.

[2] The herbicidal composition according to [1], wherein the pyridazinone compound represented by the formula (I) is the compound in which n is an integer of 1 or more.
[3] The herbicidal composition according to [1], wherein the pyridazinone compound represented by the formula (I) is the compound in which n is 0 and Z¹ is a C₂₋₆ alkyl group.
[4] The herbicidal composition according to [1], wherein the pyridazinone compound represented by the formula (I) is the compound in which n is 1 or 2 and Z² is attached to the 4- and/or 6-position of the benzene ring.
[5] The herbicidal composition according to [1], [2] or
[4], wherein the pyridazinone compound represented by the formula (I) is the compound in which Z¹ is a C₁₋₃ alkyl group and Z² is a C₁₋₃ alkyl group.
[6] The herbicidal composition according to any one of [1] to [5], wherein the pyridazinone compound represented by the formula (I) is the compound in which G is hydrogen, a group represented by the formula:

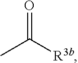

a group represented by the formula:

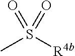

or a group represented by the formula:

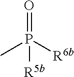

[wherein R^{3b} represents a C₁₋₆ alkyl group, a C₃₋₈ cycloalkyl group, a C₂₋₆ alkenyl group, a C₂₋₆ alkynyl group, a C₆₋₁₀ aryl group, a (C₆₋₁₀ aryl)C₁₋₆ alkyl group, a C₁₋₆ alkyloxy group, a C₃₋₆ cycloalkyloxy group, a C₂₋₆ alkenyloxy group, a C₆₋₁₀ aryloxy group, a (C₆₋₁₀ aryl)C₁₋₆ alkyloxy group, a C₁₋₆ alkylamino group, a C₆₋₁₀ arylamino group or a di(C₁₋₆ alkyl)amino group,
R^{4b} represents a C₁₋₆ alkyl group or a C₆₋₁₀ aryl group, and

R^{5b} and R^{6b} may be the same or different, and represent a C₁₋₆ alkyl group, a C₁₋₆ alkyloxy group, a C₆₋₁₀ aryloxy group or a C₁₋₆ alkylthio group,

wherein, each group represented by R^{3b}, R^{4b}, R^{5b} and R^{6b} is optionally halogenated, and the C₃₋₈ cycloalkyl group, the C₆₋₁₀ aryl group, the aryl moiety of the (C₆₋₁₀ aryl)C₁₋₆ alkyl group, the C₃₋₈ cycloalkyloxy group, the C₆₋₁₀ aryloxy group, the aryl moiety of the (C₆₋₁₀ aryl)C₁₋₆ alkyloxy group, and the aryl moiety of the C₆₋₁₀ arylamino group are optionally C₁₋₆ alkylated].

[7] The herbicidal composition according to any one of [1] to [5], wherein the pyridazinone compound represented by the formula (I) is the compound in which G is hydrogen, a group represented by the formula:

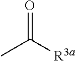

or a group represented by the formula:

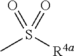

[wherein R^{3a} represents a C₁₋₆ alkyl group, a C₃₋₈ cycloalkyl group, a C₆₋₁₀ aryl group, a C₁₋₆ alkyloxy group, a C₂₋₆ alkenyloxy group or a di(C₁₋₆ alkyl)amino group, and R^{4a} represents a C₁₋₆ alkyl group,

wherein, each group represented by R^{3a} and R^{4a} is optionally halogenated, and the C₃₋₈ cycloalkyl group and the C₆₋₁₀ aryl group are optionally C₁₋₆ alkylated].

[8] The herbicidal composition according to any one of [1] to [7], wherein the pyridazinone compound represented by the formula (I) is the compound in which R² is hydrogen or a C₁₋₃ alkyl group.
[9] The herbicidal composition according to any one of [1] to [7], wherein the pyridazinone compound represented by the formula (I) is the compound in which R² is hydrogen or a methyl group. [10] The herbicidal composition according to any one of [1] to [9], wherein the pyridazinone compound represented by the formula (I) is the compound in which R¹ is a C₁₋₃ alkyl group or a (C₁₋₃ alkyloxy)C₁₋₃ alkyl group.
[11] A method of controlling weeds, which comprises the step of applying effective amounts of a pyridazinone compound represented by the formula (I), at least one compound selected from Group A and at least one compound selected from group B to weeds or soil where weeds grow.

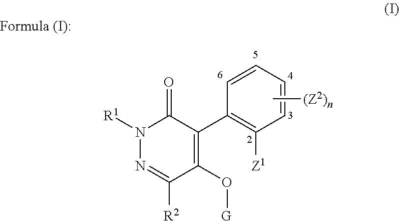

wherein R¹ represents a C₁₋₆ alkyl group or a (C₁₋₆ alkyloxy)C₁₋₆ alkyl group,
R² represents hydrogen or a C₁₋₆ alkyl group,
G represents hydrogen, a group represented by the formula:

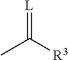

a group represented by the formula:

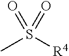

or a group represented by the formula:

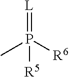

[wherein L represents oxygen or sulfur,

R³ represents a C₁₋₆ alkyl group, a C₃₋₈ cycloalkyl group, a C₂₋₆ alkenyl group, a C₂₋₆ alkynyl group, a C₆₋₁₀ aryl group, a (C₆₋₁₀ aryl)C₁₋₆ alkyl group, a C₁₋₆ alkyloxy group, a C₃₋₈ cycloalkyloxy group, a C₂₋₆ alkenyloxy group, a C₂₋₆ alkynyloxy group, a C₆₋₁₀ aryloxy group, a (C₆₋₁₀ aryl)C₁₋₆ alkyloxy group, an amino group, a C₁₋₆ alkylamino group, a C₂₋₆ alkenylamino group, a C₆₋₁₀ arylamino group, a di(C₁₋₆ alkyl)amino group, a di(C₂₋₆ alkenyl)amino group, a (C₁₋₆ alkyl)(C₆₋₁₀ aryl)amino group, or a 3- to 8-membered nitrogen-containing heterocyclic group,

R⁴ represents a C₁₋₆ alkyl group, a C₆₋₁₀aryl group, a C₁₋₆ alkylamino group or a di(C₁₋₆ alkyl)amino group, and

R⁵ and R⁶ may be the same or different, and represent a C₁₋₆ alkyl group, a C₃₋₈ cycloalkyl group, a C₂₋₆ alkenyl cycloalkyloxy group, a C₆₋₁₀ aryloxy group, a (C₆₋₁₀ aryl)C₁₋₆ alkyloxy group, a C₁₋₆ alkylthio group, a C₁₋₆ alkylamino group or a di(C₁₋₆ alkyl)amino group,

wherein, each group represented by R³, R⁴, R⁵ and R⁶ is optionally halogenated, and the C₃₋₆ cycloalkyl group, the C₆₋₁₀ aryl group, the aryl moiety of the (C₆₋₁₀ aryl)C₁₋₆ alkyl group, the C₃₋₆ cycloalkyloxy group, the C₆₋₁₀ aryloxy group, the aryl moiety of the (C₆₋₁₀ aryl)C₁₋₆ alkyloxy group, the aryl moiety of the C₆₋₁₀ arylamino group, the aryl moiety of the (C₁₋₆ alkyl)(C₆₋₁₀ aryl)amino group, and the 3- to 8-membered nitrogen-containing heterocyclic group are optionally C₁₋₆ alkylated],

Z¹ represents a C₁₋₆ alkyl group,
Z² represents a C₁₋₆ alkyl group, and
n represents 0, 1, 2, 3 or 4, and when n represents an integer of 2 or more, each Z² may be the same or different, provided that the total number of carbon atoms in the groups represented by Z¹ and (Z²)n is two or more.

Group A: a group consisting of metsulfuron-methyl, thifensulfuron-methyl, tribenuron-methyl, chlorsulfuron, florasulam, bromoxynil or an agriculturally acceptable ester or salt thereof, pyrasulfotole, dicamba or an agriculturally acceptable ester or salt thereof, fluoroxypyr or an agriculturally acceptable ester thereof, 2,4-D or an agriculturally acceptable ester or salt thereof, and clopyralid or an agriculturally acceptable salt thereof; and

Group B: a group consisting of fenchlorazole-ethyl, cloquintocet-mexyl, and mefenpyr-diethyl.

[12] Use of a composition containing a compound represented by the formula (I) to weeds or soil where weeds grow for weed control.

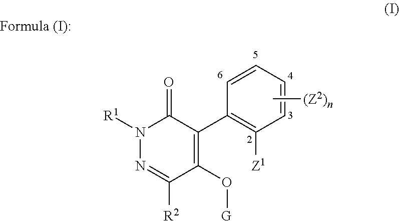

wherein R¹ represents a C₁₋₆ alkyl group or a (C₁₋₆ alkyloxy)C₁₋₆ alkyl group,
R² represents hydrogen or a C₁₋₆ alkyl group,
G represents hydrogen, a group represented by the formula:

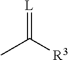

a group represented by the formula:

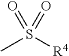

or a group represented by the formula:

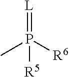

[wherein L represents oxygen or sulfur, represents a C₁₋₆ alkyl group, a C₃₋₈ cycloalkyl group, a C₂₋₆ alkenyl group, a C₂₋₆ alkynyl group, a C₆₋₁₀ aryl group, a (C₆₋₁₀ aryl)C₁₋₆ alkyl group, a C₁₋₆ alkyloxy group, a C₃₋₈ cycloalkyloxy group, a C₂₋₆ alkenyloxy group, a C₂₋₆ alkynyloxy group, a C₆₋₁₀ aryloxy group, a (C₆₋₁₀ aryl)C₁₋₆ alkyloxy group, an amino group, a C₁₋₆ alkylamino group, a C₂₋₆ alkenylamino group, a C₆₋₁₀ arylamino group, a di(C₁₋₆ alkyl)amino group, a di(C₂₋₆ alkenyl)amino group, a (C₁₋₆ alkyl) (C₆₋₁₀ aryl)amino group, or a 3- to 8-membered nitrogen-containing heterocyclic group,

R⁴ represents a C₁₋₆ alkyl group, a C₆₋₁₀aryl group, a C₁₋₆ alkylamino group or a di(C₁₋₆ alkyl)amino group, and

R⁵ and R⁶ may be the same or different, and represent a C₁₋₆ alkyl group, a C₃₋₈ cycloalkyl group, a C₂₋₆ alkenyl group, a C₆₋₁₀ aryl group, a C₁₋₆ alkyloxy group, a C₃₋₈ cycloalkyloxy group, a C₆₋₁₀ aryloxy group, a (C₆₋₁₀ aryl)C₁₋₆ alkyloxy group, a C₁₋₆ alkylthio group, a C₁₋₆ alkylamino group or a di(C₁₋₆ alkyl)amino group,

wherein, each group represented by R³, R⁴, R⁵ and R⁶ is optionally halogenated, and the C₃₋₈ cycloalkyl group, the C₆₋₁₀ aryl group, the aryl moiety of the (C₆₋₁₀ aryl)C₁₋₆ alkyl group, the C₃₋₈ cycloalkyloxy group, the C₆₋₁₀ aryloxy group, the aryl moiety of the (C₆₋₁₀ aryl)C₁₋₆ alkyloxy group, the aryl moiety of the C₆₋₁₀ arylamino group, the aryl moiety of the (C₁₋₆ alkyl)(C₆₋₁₀ aryl)amino group, and the 3- to 8-membered nitrogen-containing heterocyclic group are optionally C₁₋₆ alkylated],
Z¹ represents a C₁₋₆ alkyl group,
   Z² represents a C₁₋₆ alkyl group, and
   n represents 0, 1, 2, 3 or 4, and when n represents an integer of 2 or more, each Z² may be the same or different,

provided that the total number of carbon atoms in the groups represented by Z¹ and (Z²)n is two or more.

Group A: a group consisting of metsulfuron-methyl, thifensulfuron-methyl, tribenuron-methyl, chlorsulfuron, florasulam, bromoxynil or an agriculturally acceptable ester or salt thereof, pyrasulfotole, dicamba or an agriculturally acceptable ester or salt thereof, fluoroxypyr or an agriculturally acceptable ester thereof, 2,4-D or an agriculturally acceptable ester or salt thereof, and clopyralid or an agriculturally acceptable salt thereof; and

Group B: a group consisting of fenchlorazole-ethyl, cloquintocet-mexyl, and mefenpyr-diethyl.

The herbicidal composition of the present invention has synergistic weed control effect and/or excellent crop selectivity as compared with the case of using alone any one of the pyridadinone compound of the formula (I), a compound of Group A and a compound of Group B.

Examples of the herbicidal composition of the present invention include:

a herbicidal composition containing the present compound, metsulfuron-methyl and fenchlorazole-ethyl;
a herbicidal composition containing the present compound, metsulfuron-methyl and cloquintocet-mexyl;
a herbicidal composition containing the present compound, metsulfuron-methyl and mefenpyr-diethyl;
a herbicidal composition containing the present compound, thifensulfuron-methyl and fenchlorazole-ethyl;
a herbicidal composition containing the present compound, thifensulfuron-methyl and cloquintocet-mexyl;
a herbicidal composition containing the present compound, thifensulfuron-methyl and mefenpyr-diethyl;
a herbicidal composition containing the present compound, tribenuron-methyl and fenchlorazole-ethyl;
a herbicidal composition containing the present compound, tribenuron-methyl and cloquintocet-mexyl;
a herbicidal composition containing the present compound, tribenuron-methyl and mefenpyr-diethyl;
a herbicidal composition containing the present compound, chlorsulfuron and fenchlorazole-ethyl;
a herbicidal composition containing the present compound, chlorsulfuron and cloquintocet-mexyl;
a herbicidal composition containing the present compound, chlorsulfuron and mefenpyr-diethyl;
a herbicidal composition containing the present compound, florasulam and fenchlorazole-ethyl;
a herbicidal composition containing the present compound, florasulam and cloquintocet-mexyl;
a herbicidal composition containing the present compound, florasulam and mefenpyr-diethyl;
a herbicidal composition containing the present compound, bromoxynil or an agriculturally acceptable ester or salt thereof, and fenchlorazole-ethyl;
a herbicidal composition containing the present compound, bromoxynil or an agriculturally acceptable ester or salt thereof, and cloquintocet-mexyl;
a herbicidal composition containing the present compound, bromoxynil or an agriculturally acceptable ester or salt thereof, and mefenpyr-diethyl;
a herbicidal composition containing the present compound, pyrasulfotole and fenchlorazole-ethyl;
a herbicidal composition containing the present compound, pyrasulfotole and cloquintocet-mexyl;
a herbicidal composition containing the present compound, pyrasulfotole and mefenpyr-diethyl;
a herbicidal composition containing the present compound, dicamba or an agriculturally acceptable ester or salt thereof, and fenchlorazole-ethyl;
a herbicidal composition containing the present compound, dicamba or an agriculturally acceptable ester or salt thereof, and cloquintocet-mexyl;
a herbicidal composition containing the present compound, dicamba or an agriculturally acceptable ester or salt thereof, and mefenpyr-diethyl;
a herbicidal composition containing the present compound, fluoroxypyr or an agriculturally acceptable ester thereof, and fenchlorazole-ethyl;
a herbicidal composition containing the present compound, fluoroxypyr or an agriculturally acceptable ester thereof, and cloquintocet-mexyl;
a herbicidal composition containing the present compound, fluoroxypyr or an agriculturally acceptable ester thereof, and mefenpyr-diethyl;
a herbicidal composition containing the present compound, 2,4-D or an agriculturally acceptable ester or salt thereof, and fenchlorazole-ethyl;
a herbicidal composition containing the present compound 2,4-D or an agriculturally acceptable ester or salt thereof, and cloquintocet-mexyl;
a herbicidal composition containing the present compound, 2,4-D or an agriculturally acceptable ester or salt thereof, and mefenpyr-diethyl;
a herbicidal composition containing the present compound, clopyralid or an agriculturally acceptable salt thereof, and fenchlorazole-ethyl;
a herbicidal composition containing the present compound, clopyralid or an agriculturally acceptable salt thereof, and cloquintocet-mexyl; and
a herbicidal composition containing the present compound, clopyralid or an agriculturally acceptable salt thereof, and mefenpyr-diethyl.

As used herein, the “C₁₋₆ alkyl group” means an alkyl group having 1 to 6 carbon atoms, and examples of thereof include a methyl group, an ethyl group, a propyl group, an isopropyl group, a butyl group, an isobutyl group, a sec-butyl group, a tert-butyl group, a pentyl group, a 1-methylbutyl group, an isopentyl group, a neopentyl group, a hexyl group and an isohexyl group.

As used herein, the “C₃₋₈ cycloalkyl group” means a cycloalkyl group having 3 to 8 carbon atoms, and examples of thereof include a cyclopropyl group, a cyclopentyl group and a cyclohexyl group.

As used herein, the “C₂₋₆ alkenyl group” means an alkenyl group having 2 to 6 carbon atoms, and examples of thereof include an allyl group, a I-buten-3-yl group and a 3-buten-1-yl group.

As used herein, the “C₂₋₆ alkynyl group” means an alkynyl group having 2 to 6 carbon atoms, and examples of thereof include a propargyl group and a 2-butynyl group.

As used herein, the “C₆₋₁₀ aryl group” means an aryl group having 6 to 10 carbon atoms, and examples of thereof include a phenyl group and a naphthyl group.

As used herein, the “(C₆₋₁₀ aryl)C₁₋₆ alkyl group” means a C₁₋₆ alkyl group substituted with a C₆₋₁₀ aryl group, and examples of thereof include a benzyl group and a phenethyl group.

As used herein, the “C₁₋₆ alkyloxy group” means an alkyloxy group having 1 to 6 carbon atoms, and examples of thereof include a methoxy group, an ethoxy group, a propoxy group, an isopropoxy group and a tert-butoxy group.

As used herein, the “C₃₋₈ cycloalkyloxy group” means a cycloalkyloxy group having 3 to 8 carbon atoms, and examples of thereof include a cyclopropyloxy group and a cyclopentyloxy group.

As used herein, the “C₂₋₆ alkenyloxy group” means an alkenyloxy group having 2 to 6 carbon atoms, and examples of thereof include a vinyloxy group and an allyloxy group.

As used herein, the “C₂₋₆ alkynyloxy group” means an alkynyloxy group having 2 to 6 carbon atoms, and examples of thereof include a propargyloxy group and a 2-butynyloxy group.

As used herein, the “C₆₋₁₀ aryloxy group” means an aryloxy group having 6 to 10 carbon atoms, and examples of thereof include a phenoxy group and a naphthyloxy group.

As used herein, the “(C₆₋₁₀ aryl)C₁₋₆ alkyloxy group” means a C₁₋₆ alkyloxy group substituted with a C₆₋₁₀ aryl group, and examples of thereof include a benzyloxy group and a phenethyloxy group.

As used herein, the “C₁₋₆ alkylamino group” means an alkylamino group having 1 to 6 carbon atoms, and examples of thereof include a methylamino group and an ethylamino group.

As used herein, the “C₂₋₆ alkenylamino group” means an alkenylamino group having 2 to 6 carbon atoms, and examples of thereof include an allylamino group and a 3-butenylamino group.

As used herein, the “C₆₋₁₀ arylamino group” means an arylamino group having 6 to 10 carbon atoms, and examples of thereof include a phenylamino group and a naphthylamino group.

As used herein, the “di(C₁₋₆ alkyl)amino group” means an amino group substituted with two same or different C₁₋₆ alkyl groups, and examples of thereof include a dimethylamino group, a diethylamino group and an N-ethyl-N-methylamino group.

As used herein, the “di(C₂₋₆ alkenyl)amino group” means an amino group substituted with two same or different C₂₋₆ alkenyl groups, and examples of thereof include a diallylamino group and a di(3-butenyl)amino group.

As used herein, the “(C₁₋₆ alkyl)(C₆₋₁₀ aryl)amino group” means an amino group substituted with a C₁₋₆ alkyl group and a C₆₋₁₀ aryl group, and examples of thereof include a methylphenylamino group and an ethylphenylamino group.

As used herein, the “C₁₋₆ alkylthio group” means an alkylthio group having 1 to 6 carbon atoms, and examples of thereof include a methylthio group, an ethylthio group, a propylthio group and an isopropylthio group.

As used herein, the “(C₁₋₆ alkyloxy)C₁₋₆ alkyl group” means a C₁₋₆ alkyl group substituted with a C₁₋₆ alkyloxy group, and examples of thereof include a methoxyethyl group and an ethoxyethyl group.

As used herein, the “3- to 8-membered nitrogen-containing heterocyclic group” means an aromatic or alicyclic 3- to 8-membered heterocyclic group containing 1 to 3 nitrogen atoms and optionally containing 1 to 0.3 oxygen and/or sulfur atoms, and examples of thereof include a 1-pyrazolyl group, a 2-pyridyl group, a 2-pyrimidinyl group, a 2-thiazolyl group, a pyrrolidino group, a piperidino group and a morpholino group.

The present compound also includes an agriculturally acceptable salt of the compound represented by the formula (I).

Examples of the present compound include the following compounds.

A pyridazinone compound of the formula (I), wherein n is an integer of 1 or more.

A pyridazinone compound of the formula (I), wherein n is 0 and Z¹ is a C₂₋₆ alkyl group.

A pyridazinone compound of the formula (I), wherein n is 1 or 2 and Z² is attached to the 4- and/or 6-position of the benzene ring.

A pyridazinone compound of the formula (I), wherein G is hydrogen, a group represented by the formula:

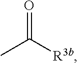

a group represented by the formula:

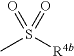

or a group represented by the formula:

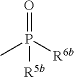

[wherein R^{3b} represents a C₁₋₆ alkyl group, a C₃₋₈ cycloalkyl group, a C₂₋₆ alkenyl group, a C₂₋₆ alkynyl group, a C₆₋₁₀ aryl group, a (C₆₋₁₀ aryl)C₁₋₆ alkyl group, a C₁₋₆ alkyloxy group, a C₃₋₈ cycloalkyloxy group, a C₂₋₆ alkenyloxy group, a C₆₋₁₀ aryloxy group, a (C₆₋₁₀ aryl)C₁₋₆ alkyloxy group, a C₁₋₆ alkylamino group, a C₆₋₁₀ arylamino group or a di(C₁₋₆ alkyl)amino group,
R⁴ represents a C₁₋₆ alkyl group or a C₆₋₁₀ aryl group,
R^{5b} and R^{6b} may be the same or different, and represent a C₁₋₆ alkyl group, a C₁₋₆ alkyloxy group, a C₆₋₁₀ aryloxy group or a C₁₋₆ alkylthio group,

wherein, each group represented by R^{3b}, R^{4b}, R^{5b} and R^{6b} is optionally halogenated, and the C₂₋₆ cycloalkyl group, the C₆₋₁₀ aryl group, the aryl moiety of the (C₆₋₁₀ aryl)C₁₋₆ alkyl group, the C₃₋₈ cycloalkyloxy group, the C₆₋₁₀ aryloxy group, the aryl moiety of the (C₆₋₁₀ aryl)C₁₋₆ alkyloxy group, and the aryl moiety of the C₆₋₁₀ arylamino group are optionally C₁₋₆ alkylated].

A pyridazinone compound of the formula (I), wherein G is hydrogen, a group represented by the formula:

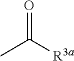

or a group represented by the formula:

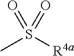

[wherein R^{3a} represents a C₁₋₆ alkyl group, a C₃₋₈ cycloalkyl group, a C₆₋₁₀ aryl group, a C₁₋₆ alkyloxy group, a C₂₋₆ alkenyloxy group or a di(C₁₋₆ alkyl)amino group, R^{4a} represents a C₁₋₆ alkyl group,

wherein, each group represented by R^{3a} and R^{4a} is optionally halogenated, and the C₃₋₈ cycloalkyl group and the C₆₋₁₀ aryl group are optionally C₁₋₆ alkylated.

A pyridazinone compound of the formula (I), wherein R¹ is a C₁₋₃ alkyl group or a (C₁₋₃ alkyloxy)C₁₋₃ alkyl group.

A pyridazinone compound of the formula (I), wherein R² is hydrogen or a C₁₋₃ alkyl group.

A pyridazinone compound of the formula (I), wherein R² is hydrogen or a methyl group.

A pyridazinone compound of the formula (I), wherein Z¹ is a C₁₋₃ alkyl group and Z² is a C₁₋₃ alkyl group.

A pyridazinone compound of the formula (I), wherein R¹ is a C₁₋₃ alkyl group or a (C₁₋₃ alkyloxy)C₁₋₃ alkyl group, and R² is hydrogen or a C₁₋₃ alkyl group.

A pyridazinone compound of the formula (I), wherein R¹ is a C₁₋₃ alkyl group or a (C₁₋₃ alkyloxy)C₁₋₃ alkyl group, and R² is a hydrogen or methyl group.

A pyridazinone compound of the formula (I), wherein R² is hydrogen or a C₁₋₃ alkyl group, and G is hydrogen, group represented by the formula:

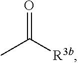

a group represented by the formula:

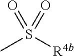

or a group represented by the formula:

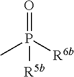

[wherein R^{3b}, R^{4b}, R^{5b} and R^{6b} are as defined above].

A pyridazinone compound of the formula (I), wherein R² is hydrogen or a C₁₋₃ alkyl group, and G is hydrogen, a group represented by the formula:

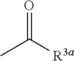

or a group represented by the formula:

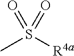

[wherein R^{3a} and R^{4a} are as defined above].

A pyridazinone compound of the formula (I), wherein R² is hydrogen or a methyl group, and G is hydrogen, a group represented by the formula:

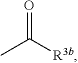

a group represented by the formula:

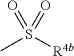

or a group represented by the formula:

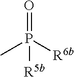

[wherein R^{3b}, R^{4b}, R^{5b} and R^{6b} are as defined above].

A pyridazinone compound of the formula (I), wherein R² is hydrogen or a methyl group, and G is hydrogen, a group represented by the formula:

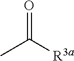

or a group represented by the formula:

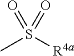

[wherein R^{3a} and R^{4a} are as defined above].

A pyridazinone compound of the formula (I), wherein R¹ is a C₁₋₃ alkyl group or a (C₁₋₃ alkyloxy)C₁₋₃ alkyl group, R² is hydrogen or a C₁₋₃ alkyl group, and G is hydrogen, a group represented by the formula:

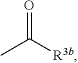

a group represented by the formula:

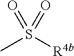

or a group represented by the formula:

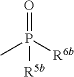

[wherein R^{3b}, R^{4b}, R^{5b} and R^{6b} are as defined above].

A pyridazinone compound of the formula (I), wherein R¹ is C₁₋₃ alkyl group or a (C₁₋₃ alkyloxy)C₁₋₃ alkyl group, R² is hydrogen or a C₁₋₃ alkyl group, and G is hydrogen, a group represented by the formula:

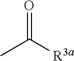

or a group represented by the formula:

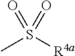

[wherein R^{3a} and R^{4a} are as defined above].

A pyridazinone compound of the formula (I), wherein R¹ is a C₁₋₃ alkyl group or a (C₁₋₃ alkyloxy)C₁₋₃ alkyl group, R² is hydrogen or a methyl group, and G is hydrogen, a group represented by the formula:

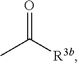

a group represented by the formula:

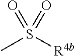

or a group represented by the formula:

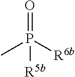

[wherein R^{3b}, R^{4b}, R^{5b} and R^{6b} are as defined above].

A pyridazinone compound of the formula (I), wherein R¹ is a C₁₋₃ alkyl group or a (C₁₋₃ alkyloxy)C₁₋₃ alkyl group, R² is hydrogen or a methyl group, and G is hydrogen, a group represented by the formula:

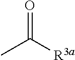

or a group represented by the formula:

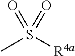

[wherein R^{3a} and R^{4a} are as defined above].

A pyridazinone compound of the formula (I), wherein R¹ is a C₁₋₃ alkyl group or a (C₁₋₃ alkyloxy)C₁₋₃ alkyl group, R² is hydrogen or a C₁₋₃ alkyl group,

n represents an integer of 0, 1 or 2, and when n represents 2, two Z²'s may be the same or different, and when n represents 1 or 2, Z² is attached to the 4- and/or 6-position of the benzene ring,
Z¹ is a C₁₋₆ alkyl group, and
Z² is a C₁₋₆ alkyl group.

A pyridazinone compound of the formula (I), wherein R¹ is a C₁₋₃ alkyl group or a (C₁₋₃ alkyloxy)C₁₋₃ alkyl group, R² is hydrogen or a C₁₋₃ alkyl group, and G is hydrogen, a group represented by the formula:

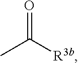

a group represented by the formula:

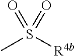

or a group represented by the formula:

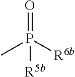

[wherein R^{3b}, R^{4b}, R^{5b} and R^{6b} are as defined above],
n represents an integer of 0, 1 or 2, and when n represents 2, two Z²'s may be the same or different, and when n represents 1 or 2, Z² is attached to the 4- and/or 6-position of the benzene ring,
Z¹ is a C₁₋₆ alkyl group, and
Z² is a C₁₋₆ alkyl group.

A pyridazinone compound of the formula (I), wherein R¹ is a C₁₋₃ alkyl group or a (C₁₋₃ alkyloxy)C₁₋₃ alkyl group, R² is a hydrogen or a C₁₋₃ alkyl group, and G is hydrogen, a group represented by the formula:

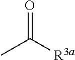

or a group represented by the formula:

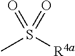

[wherein R^{3a} and R^{4a} are as defined above],
n represents an integer of 0, 1 or 2, and when n represents 2, two Z²'s may be the same or different, and when n represents 1 or 2, Z² is attached to the 4- and/or 6-position of the benzene ring,
Z¹ is a C₁₋₆ alkyl group, and
Z² is a C₁₋₆ alkyl group.

A pyridazinone compound of the formula (I), wherein R¹ is a C₁₋₃ alkyl group or a (C₁₋₃ alkyloxy)C₁₋₃ alkyl group, R² is hydrogen or a methyl group,

n represents an integer of 0, 1 or 2, and when n represents 2, two Z²'s may be the same or different, and when n represents 1 or 2, Z^{Z2} is attached to the 4- and/or 6-position of the benzene ring,
Z¹ is a C₁₋₆ alkyl group, and
Z² is a C₁₋₆ alkyl group.

A pyridazinone compound of the formula (I), wherein R¹ is a C₁₋₃ alkyl group or a (C₁₋₃ alkyloxy)C₁₋₃ alkyl group, R² is hydrogen or a methyl group, and G is hydrogen, a group represented by the formula:

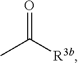

a group represented by the formula:

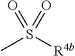

or a group represented by the formula:

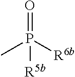

[wherein R^{3b}, R^{4b}, R^{5b} and R^{6b} are as defined above],
n represents an integer of 0, 1 or 2, and when n represents 2, two Z²'s may be the same or different, and when n represents 1 or 2, Z² is attached to the 4- and/or 6-position of the benzene ring,
Z¹ is a C₁₋₆ alkyl group, and
Z² is a C₁₋₆ alkyl group.

A pyridazinone compound of the formula (I), wherein R¹ is a C₁₋₃ alkyl group or a (C₁₋₃ alkyloxy)C₁₋₃ alkyl group, R² is hydrogen or a methyl group, and G is hydrogen, a group represented by the formula:

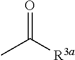

or a group represented by the formula:

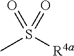

[wherein R^{3a} and R^{4a} are as defined above],
n represents an integer of 0, 1 or 2, and when n represents 2, two Z²'s may be the same or different, and when n represents 1 or 2, Z² is attached to the 4- and/or 6-position of the benzene ring,
Z¹ is a C₁₋₆ alkyl group, and
Z² is a C₁₋₆ alkyl group.

A pyridazinone compound of the formula (I-1):

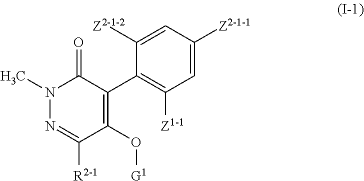

wherein R²⁻¹ is hydrogen or a C₁₋₃ alkyl group, G¹ is hydrogen, an optionally halogenated C₁₋₃ alkylcarbonyl group, a C₁₋₄ alkoxycarbonyl group, a C₂₋₄ alkenyloxycarbonyl group or a C₆₋₁₀ arylcarbonyl group,
Z¹⁻¹ is a C₁₋₃ alkyl group,

Z²⁻¹⁻¹ is a C₁₋₃ alkyl group, and

Z²⁻¹⁻² is hydrogen or a C₁₋₃ alkyl group.

A pyridazinone compound of the formula (I-1), wherein R²⁻¹ is hydrogen, a methyl group or an ethyl group, G¹ is hydrogen, an acetyl group, a propionyl group, a methoxycarbonyl group, an ethoxycarbonyl group, a tert-butoxycarbonyl group, an allyloxycarbonyl group or a benzoyl group,

Z¹⁻¹ is a methyl group or an ethyl group,
Z²⁻¹⁻¹ is a methyl group or an ethyl group, and
Z²⁻¹⁻² is hydrogen, a methyl group or an ethyl group.

A pyridazinone compound of the formula (I-2):

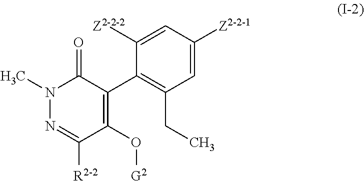

wherein R²⁻² is hydrogen or a C₁₋₃ alkyl group, G² is hydrogen, an optionally halogenated C₁₋₃ alkylcarbonyl or C₁₋₄ alkoxycarbonyl group, a C₂₋₄ alkenyloxycarbonyl group or a C₆₋₁₀ arylcarbonyl group,
Z²⁻²⁻¹ is hydrogen or a C₁₋₃ alkyl group, and
Z²⁻²⁻² is hydrogen or a C₁₋₃ alkyl group.

A pyridazinone compound of the formula (I-2), wherein

R²⁻² is hydrogen, a methyl group or an ethyl group, G² is hydrogen, an acetyl group, a methoxycarbonyl group, an ethoxycarbonyl group, a tert-butoxycarbonyl group, an allyloxycarbonyl group or a benzoyl group,

Z²⁻²⁻¹ is hydrogen, a methyl group or an ethyl group, and
Z²⁻²⁻² is hydrogen, a methyl group or an ethyl group.

Examples of an agriculturally acceptable ester or salt of bromoxynil include bromoxynil heptanoate, bromoxynil octanoate and a bromoxynil potassium salt.

Examples of an agriculturally acceptable ester or salt of dicamba include dicamba-methyl, dicamba-butotyl, dicamba-diglycolamine salt, dicamba-dimethylammonium, dicamba-diolamine, dicamba-isopropylammonium, dicamba-potassium and dicamba-sodium.

Examples of an agriculturally acceptable ester or salt of fluoroxypyr include fluoroxypyr-2-butoxy-1-methylethyl and fluoroxypyr-meptyl.

Examples of an agriculturally acceptable ester or salt of 2,4-D include 2,4-D-butotyl, 2,4-D-butyl, 2,4-D-dimethylammonium, 2,4-D-diolamine, 2,4-D-ethyl, 2,4-D-ethylhexyl, 2,4-D-isobutyl, 2,4-D-isoctyl, 2,4-D-isopropyl, 2,4-D-isopropylammonium, 2,4-D-sodium, 2,4-D-triisopropanolammonium and 2,4-D-trolamine.

Examples of an agriculturally acceptable salt of clopyralid include clopyralid-olamine, clopyralid-potassium and clopyralid-triisopropanolammonium.

The herbicidal composition of the present invention can control a wide variety of weeds in fields for crops, vegetables and trees, where conventional tillage or non-tillage cultivation is carried out. The herbicidal composition of the present invention can also be used in nonagricultural lands.

Examples of subjects which can be controlled by the herbicidal composition of the present invention include: weeds such as Digitaria ciliaris, Eleusine indica, Setaria viridis, Setaria faberi, Setaria glauca, Echinochloa crus-galli, Panicum dichotomiflorum, Panicum texanum, Brachiaria platyphylla, Brachiaria plantaginea, Brachiaria decumbens, Sorghum halepense, Andropogon sorghum, Cynodon dactylon, Avena fatua, Lolium multiflorum, Alopecurus myosuroides, Bromus tectorum, Bromus sterilis, Phalaris minor, Apera spica-venti, Poa annua, Agropyron repens, Cyperus iria, Cyperus rotundus, Cyperus esculentus, Portulaca oleracea, Amaranthus retroflexus, Amaranthus hybridus, Amaranthus palmeri, Amaranthus rudis, Abutilon theophrasti, Sida spinosa, Fallopia convolvulus, Polygonum scabrum, Persicaria pennsylvanica, Persicaria vulgaris, Rumex crispus, Rumex obtusifolius, Fallopia japonica, Chenopodium album, Kochia scoparia, Polygonum longisetum, Solanum nigrum, Datura stramonium, Ipomoea purpurea, Ipomoea hederacea, Ipomoea hederacea var. integriuscula, Ipomoea lacunosa, Convolvulus arvensis, Lamium purpureum, Lamium amplexicaule, Xanthium pensylvanicum, Helianthus annuus (wild sunflower), Matricaria perforata or inodora, Matricaria chamomilla, Chrysanthemum segetum, Matricaria matricarioides, Ambrosia artemisiifolia, Ambrosia trifida, Erigeron canadensis, Artemisia princeps, Solidago altissima, Conyza bonariensis, Sesbania exaltata, Cassia obtusifolia, Desmodium tortuosum, Trifolium repens, Pueraria lobata, Vicia angustifolia, Commelina communis, Commelina benghalensis, Galium aparine, Stellaria media, Raphanus raphanistrum, Sinapis arvensis, Capsella bursa-pastoris, Veronica persica, Veronica hederifolia, Viola arvensis, Viola tricolor, Papaver rhoeas, Myosotis scorpioides, Asclepias syriaca, Euphorbia helioscopia, Chamaesyce nutans, Geranium carolinianum, Erodium cicutarium, Equisetum arvense, Leersia japonica, Echinochloa oryzicola, Echinochloa crus-galli var. formosensis, Leptochloa chinensis, Cyperus difformis, Fimbristylis miliacea, Eleocharis acicularis, Scirpus juncoides, Scirpus wallichii, Cyperus serotinus, Eleocharis kuroguwai, Bolboschoenus koshevnikovii, Schoenoplectus nipponicus, Monochoria vaginalis, Lindernia procumbens, Dopatrium junceum, Rotala indica, Ammannia multiflora, Elatine triandra, Ludwigia epilobioides, Sagittaria pygmaea, Alisma canaliculatum, Sagittaria trifolia, Potamogeton distinctus, Oenanthe javanica, Callitriche palustris, Lindernia micrantha, Lindernia dubia, Eclipta prostrata, Murdannia keisak, Paspalum distichum, and Leersia oryzoides; aquatic plants such as Alternanthera philoxeroides, Limnobium spongia, water fern (Genus Salvinia), Pistia stratiotes, water pennywort (Genus Hydrocotyle), conferva (Genus Pithophora, Genus Cladophora), Ceratophyllum demersum, duckweed (Genus Lemna), Cabomba caroliniana, Hydrilla verticillata, Najas guadalupensis, pondweeds (Potamogeton crispus, Potamogeton illinoensis, Potamogeton pectinatus, etc.), watermeals (Genus Wolffia), water milfoils (Myriophyllum spicatum, Myriophyllum heterophyllum, etc.), and Eichhornia crassipes;

Bryopsida, Hepaticopsida, Anthocerotopsida;

Cyanobacteria;

Pteridopsida; and suckers of perennial crops (pomaceous fruits, stone fleshy fruits, berry fruits, nuts, citrus plants, hop, grape, etc.).

The herbicidal composition of the present invention can be used as a herbicide, defoliator or desiccant for agricultural lands such as dry fields, paddy fields, turfs or fruit orchards, or nonagricultural lands.

The herbicidal composition of the present invention could be used in the like place where the following plants (hereinafter, referred to as “crop plants”) are cultivated.

The crop plants include:

agricultural crops: maize, rice, wheat, barley, rye, oat, sorghum, cotton, soybean, peanut, buckwheat, sugar beet, rape, sunflower, sugarcane, tobacco and the like;

vegetables: solanaceous vegetables (for example, egg plant, tomato, green pepper, red pepper, potato and the like), cucurbitaceous vegetables (for example, cucumber, pumpkin, zucchini, watermelon, melon and the like), brassicaceous vegetables (for example, Japanese radish, turnip, horseradish, kohlrabi, Chinese cabbage, cabbage, leaf mustard, broccoli, cauliflower and the like), compositae vegetables (for example, burdock, garland chrysanthemum, artichoke, lettuce and the like), liliaceae vegetables (for example, leek, onion, garlic, asparagus and the like), umbelliferous vegetables (for example, carrot, parsley, celery, wild parsnip and the like), chenopodiaceous vegetables (for example, spinach, Swiss chard and the like), labiatae vegetables (for example, perilla, mint, basil and the like), strawberry, sweet potato, Japanese yam, taro, and the like;

fruits: pomaceous fruits (for example, apple, pear, Japanese pear, Chinese quince, quince and the like), stone fruits (for example, peach, plum, nectarine, Japanese plum, mahaleb cherry, apricot, prune and the like), citrus fruits (for example, tangerine, orange, lemon, lime, grapefruit and the like), nuts (for example, chestnut, walnut, hazel, almond, pistachio, cashew nut, macadamia nut and the like), berries (for example, blueberry, cranberry, blackberry, raspberry and the like), grape, persimmon, olive, loquat, banana, coffee, date palm, coconut palm, oil palm and the like;

trees other than fruit trees: tea plant, mulberry, flowering trees and shrubs (for example, azalea, camellia, hydrangea, Camellia sasanqua, Japanese star anise, Japanese flowering cherry, tulip tree, crape myrtle, fragrant orange-colored olive and the like), roadside trees (for example, ash plant, birch, American dogwood, eucalyptus, ginkgo, lilac, maple, willow oak, poplar, cercis, liquidambar, plane tree, zelkova, thuja, Abies, hemlock spruce, needle juniper, pine, spruce fir, yew, elm, horse chestnut, and the like), coral tree, podocarp, cedar, Japanese cypress, croton, Japanese spindle, Japanese Photinia and the like;

others: flowers (for example, rose, carnation, chrysanthemum, prairie gentian, gypsophila, gerbera, marigold, salvia, petunia, verbena, tulip, aster, gentian, lily, pansy, cyclamen, orchid, convallaria, lavender, stock, ornamental cabbage, primula, poinsettia, gladiolus, cattleya, daisy, cymbidium, begonia and the like), bio-fuel plants (Jatropha, safflower, camelina, switchgrass, Miscanthus, reed canary grass, giant reed, kenaf, cassaya, willow and the like), ornamental plants, and the like.

The “crop plants” include genetically modified crop plants.

The herbicidal composition of the present invention contains the present compound, at least one compound selected from Group A and at least one compound selected from Group B. The herbicidal composition of the present invention usually contains further an inert carrier, and an auxiliary agent for formulation such as a surfactant, a binder, a dispersant or a stabilizer, and is formulated into a wettable powder, a water dispersible granule, a suspension concentrate, a granule, a dry flowable formulation, an emulsifiable concentrate, a liquid formulation, an oil solution, a smoking agent, an aerosol or a microcapsule. The herbicidal composition of the present invention contains the present compound, at least one compound selected from Group A and at least one compound selected from Group B in a total amount of 0.1 to 80% by weight.

The inert carrier includes a solid carrier, a liquid carrier and a gas carrier.

Examples of the solid carrier include finely-divided powder and granules of clay [e.g., kaolin clay, diatomaceous earth, synthetic hydrated silicon oxide, agalmatolite clay (Fubasami clay), bentonite, or acid clay], talcs, and other inorganic minerals (e.g., sericite, quartz, sulfur, activated carbon, calcium carbonate, or hydrated silica).

Examples of the liquid carrier include water, alcohols (e.g. methanol, ethanol, etc.), ketones (e.g. acetone, methyl ethyl ketone, etc.), aromatic hydrocarbons (e.g. benzene, toluene, xylene, ethylbenzene, methylnaphthalene, etc.), aliphatic hydrocarbons (e.g. n-hexane, cyclohexane, kerosene, etc.), esters (e.g. ethyl acetate, butyl acetate, etc.), nitriles (e.g. acetonitrile, isobutyronitrile etc.), ethers (e.g. dioxane, diisopropyl ether, etc.), acid amides (e.g. N,N-dimethylformamide, dimethylacetamide, etc.), and halogenated hydrocarbons (e.g. dichloroethane, trichloroethylene, carbon tetrachloride, etc.).

Examples of the gas carrier include fluorocarbon, butane gas, liquefied petroleum gas (LPG), dimethyl ether, and carbon dioxide gas.

Examples of the surfactant include alkyl sulfonate esters, alkyl sulfate salts, alkylaryl sulfonate salts, alkylaryl ethers and their polyoxyethylene derivatives, polyoxyethylene glycol ethers, polyhydric alcohol esters, and sugar alcohol derivatives.

Examples of the auxiliary agent for formulation include specifically, casein, gelatin, polysaccharides (e.g. starch, gum arabic, cellulose derivatives, alginic acid, etc.), lignin derivatives, bentonite, sugars, synthetic water-soluble polymers (e.g. polyvinyl alcohol, polyvinyl pyrrolidone, polyacrylic acids, etc.), PAP (isopropyl acid phosphate), BHT (2,6-di-t-butyl-4-methylphenol), BHA (a mixture of 2-tert-butyl-4-methoxyphenol and 3-tert-butyl-4-methoxyphenol), vegetable oils, mineral oils, fatty acids, and fatty acid esters.

The method of controlling weeds of the present invention comprises the step of applying effective amounts of the present compound, at least one compound selected from Group A and at least one compound selected from Group B to weeds or soil where weeds grow. For the method of controlling weeds of the present invention, the herbicidal composition of the present invention is usually used.

Examples of application method of the herbicidal composition of the present invention include foliage treatment of weeds with the herbicidal composition of the present invention, treatment of the surface of soil where weeds grow with the herbicidal composition of the present invention, or soil incorporation of the herbicidal composition of the present invention into the soil where weeds grow. In the method of controlling weeds of the present invention, the present compound, at least one compound selected from Group A and at least one compound selected from Group B are used in a total amount of usually 1 to 5,000 g, preferably 10 to 3,000 g per 10,000 m² of an area where weed control is desired.

When the compound selected from Group A is metsulfuron-methyl, a weight ratio of the present compound to metsulfuron-methyl (the present compound:metsulfuron-methyl) contained in the herbicidal composition of the present invention is within a range from 1:0.001 to 1:10, preferably from 1:0.004 to 1:1.

When the compound selected from Group A is thifensulfuron-methyl, a weight ratio of the present compound to thifensulfuron-methyl (the present compound:thifensulfuron-methyl) contained in the herbicidal composition of the present invention is within a range from 1:0.005 to 1:100, preferably from 1:0.01 to 1:10.

When the compound selected from Group A is tribenuron-methyl, a weight ratio of the present compound to tribenuron-methyl (the present compound:tribenuron-methyl) contained in the herbicidal composition of the present invention is within a range from 1:0.001 to 1:50, preferably from 1:0.004 to 1:10.

When the compound selected from Group A is chlorsulfuron, a weight ratio of the present compound to chlorsulfuron (the present compound:chlorsulfuron) contained in the herbicidal composition of the present invention is within a range from 1:0.001 to 1:50, preferably from 1:0.004 to 1:10.

When the compound selected from Group A is florasulam, a weight ratio of the present compound to florasulam (the present compound:florasulam) contained in the herbicidal composition of the present invention is within a range from 1:0.001 to:10, preferably from 1:0.004 to 1:1.

When the compound selected from Group A is bromoxynil or an agriculturally acceptable ester or salt thereof, a weight ratio of the present compound to bromoxynil or an agriculturally acceptable ester or salt thereof (the present compound:bromoxynil or an agriculturally acceptable ester or salt thereof) contained in the herbicidal composition of the present invention is within a range from 1:0.1 to 1:1000, preferably from 1:0.5 to 1:100.

When the compound selected from Group A is pyrasulfotole, a weight ratio of the present compound to pyrasulfotole (the present compound:pyrasulfotole) contained in the herbicidal composition of the present invention is within a range from 1:0.01 to 1:50, preferably from 1:0.05 to 1:10.

When the compound selected from Group A is dicamba or an agriculturally acceptable ester or salt thereof, a weight ratio of the present compound to dicamba or an agriculturally acceptable ester or salt thereof (the present compound:dicamba or an agriculturally acceptable ester or salt thereof) contained in the herbicidal composition of the present invention is within a range from 1:0.01 to 1:100, preferably from 1:0.1 to 1:10.

When the compound selected from Group A is fluoroxypyr or an agriculturally acceptable ester thereof, a weight ratio of the present compound to fluoroxypyr or an agriculturally acceptable ester thereof (the present compound:fluoroxypyr or an agriculturally acceptable ester thereof) contained in the herbicidal composition of the present invention is within a range from 1:0.01 to 1:100, preferably from 1:0.1 to 1:10.

When the compound selected from Group A is 2,4-D or an agriculturally acceptable ester or salt thereof, a weight ratio of the present compound to 2,4-D or an agriculturally acceptable ester or salt thereof (the present compound: 2,4-D or an agriculturally acceptable ester or salt thereof) contained in the herbicidal composition of the present invention is within a range from 1:0.1 to 1:100, preferably from 1:0.5 to 1:20.

When the compound selected from Group A is clopyralid or an agriculturally acceptable salt thereof, a weight ratio of the present compound to clopyralid or an agriculturally acceptable salt thereof (the present compound:clopyralid or an agriculturally acceptable salt thereof) contained in the herbicidal composition of the present invention is within a range from 1:0.05 to 1:500, preferably from 1:0.1 to 1:50.

When the compound selected from Group B is fenchlorazole-ethyl, a weight ratio of the present compound to fenchlorazole-ethyl (the present compound:fenchlorazole-ethyl) contained in the herbicidal composition of the present invention is within a range from 1:0.01 to 1:10, preferably from 1:0.03 to 1:1.

When the compound selected from Group B is cloquintocet-mexyl, a weight ratio of the present compound to cloquintocet-mexyl (the present compound:cloquintocet-mexyl) contained in the herbicidal composition of the present invention is within a range from 1:0.01 to 1:10, preferably from 1:0.03 to 1:1.

When the compound selected from Group B is mefenpyr-diethyl, a weight ratio of the present compound to mefenpyr-diethyl (the present compound:mefenpyr-diethyl) contained in the herbicidal composition of the present invention is within a range from 1:0.01 to 1:10, preferably from 1:0.03 to 1:1.

When the herbicidal composition of the present invention contains the present compound, metsulfuron-methyl and fenchlorazole-ethyl, a weight ratio of the present compound, metsulfuron-methyl and fenchlorazole-ethyl (the present compound:metsulfuron-methyl:fenchlorazole-ethyl) is usually within a range from 1:0.001:0.01 to 1:10:10, preferably from 1:0.004:0.03 to 1:1:1.

When the herbicidal composition of the present invention contains the present compound, metsulfuron-methyl and cloquintocet-mexyl, a weight ratio of the present compound, metsulfuron-methyl and cloquintocet-mexyl (the present compound:metsulfuron-methyl:cloquintocet-mexyl) is usually within a range from 1:0.001:0.01 to 1:10:10, preferably from 1:0.004:0.03 to 1:1:1.

When the herbicidal composition of the present invention contains the present compound, metsulfuron-methyl and mefenpyr-diethyl, a weight ratio of the present compound, metsulfuron-methyl and mefenpyr-diethyl (the present compound:metsulfuron-methyl:mefenpyr-diethyl) is usually within a range from 1:0.001:0.01 to 1:10:10, preferably from 1:0.004:0.03 to 1:1:1.

When the herbicidal composition of the present invention contains the present compound, thifensulfuron-methyl and fenchlorazole-ethyl, a weight ratio of the present compounds, thifensulfuron-methyl and fenchlorazole-ethyl (the present compounds:thifensulfuron-methyl:fenchlorazole-ethyl) is usually within a range from 1:0.005:0.01 to 1:100:10, preferably from 1:0.01:0.03 to 1:10:1.

When the herbicidal composition of the present invention contains the present compound, thifensulfuron-methyl and cloquintocet-mexyl, a weight ratio of the present compound, thifensulfuron-methyl and cloquintocet-mexyl (the present compound:thifensulfuron-methyl:cloquintocet-mexyl) is usually within a range from 1:0.005:0.01 to 1:100:10, preferably from 1:0.01:0.03 to 1:10:1.

When the herbicidal composition of the present invention contains the present compound, thifensulfuron-methyl and mefenpyr-diethyl, a weight ratio of the present compound, thifensulfuron-methyl and mefenpyr-diethyl (the present compound:thifensulfuron-methyl:mefenpyr-diethyl) is usually within a range from 1:0.005:0.01 to 1:100:10, preferably from 1:0.01:0.03 to 1:10:1.

When the herbicidal composition of the present invention contains the present compound, tribenuron-methyl and fenchlorazole-ethyl, a weight ratio of the present compound, tribenuron-methyl and fenchlorazole-ethyl (the present compound:tribenuron-methyl:fenchlorazole-ethyl) is usually within a range from 1:0.001:0.01 to 1:50:10, preferably from 1:0.004:0.03 to 1:10:1.

When the herbicidal composition of the present invention contains the present compound, tribenuron-methyl and cloquintocet-mexyl, a weight ratio of the present compound, tribenuron-methyl and cloquintocet-mexyl (the present compound:tribenuron-methyl:cloquintocet-mexyl) is usually within a range from 1:0.001:0.01 to 1:50:10, preferably from 1:0.004:0.03 to 1:10:1.

When the herbicidal composition of the present invention contains the present compound, tribenuron-methyl and mefenpyr-diethyl, a weight ratio of the present compound, tribenuron-methyl and mefenpyr-diethyl (the present compound:tribenuron-methyl:mefenpyr-diethyl) is usually within a range from 1:0.001:0.01 to 1:50:10, preferably from 1:0.004:0.03 to 1:10:1.

When the herbicidal composition of the present invention contains the present compound, chlorsulfuron and fenchlorazole-ethyl, a weight ratio of the present compound, chlorsulfuron and fenchlorazole-ethyl (the present compound:chlorsulfuron: fenchlorazole-ethyl) is usually within a range from 1:0.001:0.01 to 1:50:10, preferably from 1:0.004:0.03 to 1:10:1.

When the herbicidal composition of the present invention contains the present compound, chlorsulfuron and cloquintocet-mexyl, a weight ratio of the present compound, chlorsulfuron and cloquintocet-mexyl (the present compound:chlorsulfuron:cloquintocet-mexyl) is usually within a range from 1:0.001:0.01 to 1:50:10, preferably from 1:0.004:0.03 to 1:10:1.

When the herbicidal composition of the present invention contains the present compound, chlorsulfuron and mefenpyr-diethyl, a weight ratio of the present compound, chlorsulfuron and mefenpyr-diethyl (the present compound:chlorsulfuron:mefenpyr-diethyl) is usually within a range from 1:0.001:0.01 to 1:50:10, preferably from 1:0.004:0.03 to 1:10:1.

When the herbicidal composition of the present invention contains the present compound, florasulam and fenchlorazole-ethyl, a weight ratio of the present compound, florasulam and fenchlorazole-ethyl (the present compound:florasulam:fenchlorazole-ethyl) is usually within a range from 1:0.001:0.01 to 1:10:10, preferably from 1:0.004:0.03 to 1:1:1.

When the herbicidal composition of the present invention contains the present compound, florasulam and cloquintocet-mexyl, a weight ratio of the present compound, florasulam and cloquintocet-mexyl (the present compound:florasulam:cloquintocet-mexyl) is usually within a range from 1:0.001:0.01 to 1:10:10, preferably from 1:0.004:0.03 to 1:1:1.

When the herbicidal composition of the present invention contains the present compound, florasulam and mefenpyr-diethyl, a weight ratio of the present compound, florasulam and mefenpyr-diethyl (the present compound:florasulam:mefenpyr-diethyl) is usually within a range from 1:0.001:0.01 to 1:10:10, preferably from 1:0.004:0.03 to 1:1:1.

When the herbicidal composition of the present invention contains the present compound, bromoxynil or an agriculturally acceptable ester or salt thereof, and fenchlorazole-ethyl, a weight ratio of the present compound, bromoxynil or an agriculturally acceptable ester or salt thereof, and fenchlorazole-ethyl (the present compound:bromoxynil or an agriculturally acceptable ester or salt thereof:fenchlorazole-ethyl) is usually within a range from 1:0.1:0.01 to 1:1000:10, preferably from 1:0.5:0.03 to 1:100:1.

When the herbicidal composition of the present invention contains the present compound, bromoxynil or an agriculturally acceptable ester or salt thereof, and cloquintocet-mexyl, a weight ratio of the present compound, bromoxynil or an agriculturally acceptable ester or salt thereof, and cloquintocet-mexyl (the present compound:bromoxynil or an agriculturally acceptable ester or salt thereof:cloquintocet-mexyl) is usually within a range from 1:0.1:0.01 to 1:1000:10, preferably from 1:0.5:0.03 to 1:100:1.

When the herbicidal composition of the present invention contains the present compound, bromoxynil or an agriculturally acceptable ester or salt thereof, and mefenpyr-diethyl, a weight ratio of the present compound, bromoxynil or an agriculturally acceptable ester or salt thereof, and mefenpyr-diethyl (the present compound:bromoxynil or an agriculturally acceptable ester or salt thereof:mefenpyr-diethyl) is usually within a range from 1:0.1:0.01 to 1:1000:10, preferably from 1:0.5:0.03 to 1:100:1.

When the herbicidal composition of the present invention contains the present compound, pyrasulfotole and fenchlorazole-ethyl, a weight ratio of the present compound, pyrasulfotole and fenchlorazole-ethyl (the present compound:pyrasulfotole:fenchlorazole-ethyl) is usually within a range from 1:0.01:0.01 to 1:50:10, preferably from 1:0.05:0.03 to 1:10:1.

When the herbicidal composition of the present invention contains the present compound, pyrasulfotole and cloquintocet-mexyl, a weight ratio of the present compound, pyrasulfotole and cloquintocet-mexyl (the present compound:pyrasulfotole:cloquintocet-mexyl) is usually within a range from 1:0.01:0.01 to 1:50:10, preferably from 1:0.05:0.03 to 1:10:1.

When the herbicidal composition of the present invention contains the present compound, pyrasulfotole and mefenpyr-diethyl, a weight ratio of the present compound, pyrasulfotole and mefenpyr-diethyl (the present compound:pyrasulfotole:mefenpyr-diethyl) is usually within a range from 1:0.01:0.01 to 1:50:10, preferably from 1:0.05:0.03 to 1:10:1. When the herbicidal composition of the present invention contains the present compound, dicamba or an agriculturally acceptable ester or salt thereof, and fenchlorazole-ethyl, a weight ratio of the present compound, dicamba or an agriculturally acceptable ester or salt thereof, and fenchlorazole-ethyl (the present compound:dicamba or an agriculturally acceptable ester or salt thereof:fenchlorazole-ethyl) is usually within a range from 1:0.01:0.01 to 1:100:10, preferably from 1:0.1:0.03 to 1:10:1.

When the herbicidal composition of the present invention contains the present compound, dicamba or an agriculturally acceptable ester or salt thereof, and cloquintocet-mexyl, a weight ratio of the present compound, dicamba or an agriculturally acceptable ester or salt thereof, and cloquintocet-mexyl (the present compound:dicamba or an agriculturally acceptable ester or salt thereof:cloquintocet-mexyl) is usually within a range from 1:0.01:0.01 to 1:100:10, preferably from 1:0.1:0.03 to 1:10:1.

When the herbicidal composition of the present invention contains the present compound, dicamba or an agriculturally acceptable ester or salt thereof, and mefenpyr-diethyl, a weight ratio of the present compound, dicamba or an agriculturally acceptable ester or salt thereof, and mefenpyr-diethyl (the present compound:dicamba or an agriculturally acceptable ester or salt thereof:mefenpyr-diethyl) is usually within a range from 1:0.01:0.01 to 1:100:10, preferably from 1:0.1:0.03 to 1:10:1.

When the herbicidal composition of the present invention contains the present compound, fluoroxypyr or an agriculturally acceptable ester thereof, and fenchlorazole-ethyl, a weight ratio of the present compound, fluoroxypyr or an agriculturally acceptable ester thereof, and fenchlorazole-ethyl (the present compound:fluoroxypyr or an agriculturally acceptable ester thereof:fenchlorazole-ethyl) is usually within a range from 1:0.01:0.01 to 1:100:10, preferably from 1:0.1:0.03 to 1:10:1.

When the herbicidal composition of the present invention contains the present compound, fluoroxypyr or an agriculturally acceptable ester thereof, and cloquintocet-mexyl, a weight ratio of the present compound, fluoroxypyr or an agriculturally acceptable ester thereof, and cloquintocet-mexyl (the present compound:fluoroxypyr or an agriculturally acceptable ester thereof:cloquintocet-mexyl) is usually within a range from 1:0.01:0.01 to 1:100:10, preferably from 1:0.1:0.03 to 1:10:1.

When the herbicidal composition of the present invention contains the present compound, fluoroxypyr or an agriculturally acceptable ester thereof, and mefenpyr-diethyl, a weight ratio of the present compound, fluoroxypyr or an agriculturally acceptable ester thereof, and mefenpyr-diethyl (the present compound:fluoroxypyr or an agriculturally acceptable ester thereof:mefenpyr-diethyl) is usually within a range from 1:0.01:0.01 to 1:100:10, preferably from 1:0.1:0.03 to 1:10:1.

When the herbicidal composition of the present invention contains the present compound, 2,4-D or an agriculturally acceptable ester or salt thereof, and fenchlorazole-ethyl, a weight ratio of the present compound, 2,4-D or an agriculturally acceptable ester or salt thereof, and fenchlorazole-ethyl (the present compound:2,4-D or an agriculturally acceptable ester or salt thereof:fenchlorazole-ethyl) is usually within a range from 1:0.1:0.01 to 1:100:10, preferably from 1:0.5:0.03 to 1:20:1.

When the herbicidal composition of the present invention contains the present compound, 2,4-D or an agriculturally acceptable ester or salt thereof, and cloquintocet-mexyl, a weight ratio of the present compound, 2,4-D or an agriculturally acceptable ester or salt thereof, and cloquintocet-mexyl (the present compound:2,4-D or an agriculturally acceptable ester or salt thereof:cloquintocet-mexyl) is usually within a range from 1:0.1:0.01 to 1:100:10, preferably from 1:0.5:0.03 to 1:20:1.

When the herbicidal composition of the present invention contains the present compound, 2,4-D or an agriculturally acceptable ester or salt thereof, and mefenpyr-diethyl, a weight ratio of the present compound, 2,4-D or an agriculturally acceptable ester or salt thereof, and mefenpyr-diethyl (the present compound:2,4-D or an agriculturally acceptable ester or salt thereof:mefenpyr-diethyl) is usually within a range from 1:0.1:0.01 to 1:100:10, preferably from 1:0.5:0.03 to 1:20:1.

When the herbicidal composition of the present invention contains the present compound, clopyralid or an agriculturally acceptable salt thereof, and fenchlorazole-ethyl, a weight ratio of the present compound, clopyralid or an agriculturally acceptable salt thereof, and fenchlorazole-ethyl (the present compound:clopyralid or an agriculturally acceptable salt thereof:fenchlorazole-ethyl) is usually within a range from 1:0.05:0.01 to 1:500:10, preferably from 1:0.1:0.03 to 1:50:1.

When the herbicidal composition of the present invention contains the present compound, clopyralid or an agriculturally acceptable salt thereof, and cloquintocet-mexyl, a weight ratio of the present compound, clopyralid or an agriculturally acceptable salt thereof, and cloquintocet-mexyl (the present compound:clopyralid or an agriculturally acceptable salt thereof:cloquintocet-mexyl) is usually within a range from 1:0.05:0.01 to 1:500:10, preferably from 1:0.1:0.03 to 1:50:1.

When the herbicidal composition of the present invention contains the present compound, clopyralid or an agriculturally acceptable salt thereof, and mefenpyr-diethyl, a weight ratio of the present compound, clopyralid or an agriculturally acceptable salt thereof, and mefenpyr-diethyl (the present compound:clopyralid or an agriculturally acceptable salt thereof:mefenpyr-diethyl) is usually within a range from 1:0.05:0.01 to 1:500:10, preferably from 1:0.1:0.03 to 1:50:1.

The herbicidal composition of the present invention can also be mixed or used in combination with other herbicides. The herbicidal composition of the present invention can also be mixed or used in combination with insecticides, acaricides, nematocides, fungicides, plant growth regulators, safeners, fertilizers or soil conditioners.

Examples of active ingredients for other herbicides that can be mixed or used in combination with the herbicidal composition of the present invention include:

(1) phenoxy fatty acid herbicidal compounds [2,4-PA, MCP, MCPB, phenothiol, mecoprop, triclopyr, clomeprop, naproanilide, etc.];
(2) benzoic acid herbicidal compounds [2,3,6-TBA, picloram, aminopyralid, quinclorac, quinmerac, etc.];
(3) urea herbicidal compounds [diuron, linuron, chlortoluron, isoproturon, fluometuron, isouron, tebuthiuron, methabenzthiazuron, cumyluron, daimuron, methyl-daimuron, etc.];
(4) triazine herbicidal compounds [atrazine, ametoryn, cyanazine, simazine, propazine, simetryn, dimethametryn, prometryn, metribuzin, triaziflam, indaziflam, etc.];
(5) bipyridinium herbicidal compounds [paraquat, diquat, etc.];
(6) hydroxybenzonitrile herbicidal compounds [ioxynil, etc.];
(7) dinitroaniline herbicidal compounds [pendimethalin, prodiamine, trifluralin, etc.];
(8) organophosphorous herbicidal compounds [amiprofos-methyl, butamifos, bensulide, piperophos, anilofos, glyphosate, glufosinate, glufosinate-P, bialaphos, etc.];
(9) carbamate herbicidal compounds [di-allate, tri-allate, EPTC, butylate, benthiocarb, esprocarb, molinate, dimepiperate, swep, chlorpropham, phenmedipham, phenisopham, pyributicarb, asulam, etc.];
(10) acid amide herbicidal compounds [propanil, propyzamide, bromobutide, etobenzanid, etc.];
(11) chloroacetanilide herbicidal compounds [acetochlor, alachlor, butachlor, dimethenamid, propachlor, metazachlor, metolachlor, pretilachlor, thenylchlor, pethoxamid, etc.];
(12) diphenylether herbicidal compounds [acifluorfen-sodium, bifenox, oxyfluorfen, lactofen, fomesafen, chlomethoxynil, aclonifen, etc.];
(13) cyclic imide herbicidal compounds [oxadiazon, cinidon-ethyl, carfentrazone-ethyl, surfentrazone, flumiclorac-pentyl, flumioxazin, pyraflufen-ethyl, oxadiargyl, pentoxazone, fluthiacet-methyl, butafenacil, benzfendizone, bencarbazone, saflufenacil, etc.];
(14) pyrazole herbicidal compounds [benzo[enap, pyrazolate, pyrazoxyfen, topramezone, etc.];
(15) triketone herbicidal compounds [isoxaflutole, benzobicyclon, sulcotrione, mesotrione, tembotrione, tefuryltrione, bicyclopyrone, etc.];
(16) aryloxyphenoxypropionate herbicidal compounds [clodinafop-propargyl, cyhalofop-butyl, diclofop-methyl, fenoxaprop-ethyl, fluazifop-butyl, haloxyfop-methyl, quizalofop-ethyl, metamifop, etc.];
(17) trioneoxime herbicidal compounds [alloxydim-sodium, sethoxydim, butroxydim, clethodim, cloproxydim, cycloxydim, tepraloxydim, tralkoxydim, profoxydim, etc.];
(18) sulfonylurea herbicidal compounds [sulfometuron-methyl, chlorimuron-ethyl, triasulfuron, bensulfuron-methyl, pyrazosulfuron-ethyl, primisulfuron-methyl, nicosulfuron, amidosulfuron, cinosulfuron, imazosulfuron, rimsulfuron, halosulfuron-methyl, prosulfuron, ethametsulfuron-methyl, triflusulfuron-methyl, flazasulfuron, cyclosulfamuron, flupyrsulfuron, sulfosulfuron, azimsulfuron, ethoxysulfuron, oxasulfuron, iodosulfuron-methyl-sodium, foramsulfuron, mesosulfuron-methyl, trifloxysulfuron, tritosulfuron, orthosulfamuron, flucetosulfuron, propyrisulfuron, metazosulfuron, etc.];
(19) imidazolinone herbicidal compounds [imazamethabenz-methyl, imazamethapyr, imazamox, imazapyr, imazaquin, imazethapyr, etc.];
(20) sulfonamide herbicidal compounds [flumetsulam, metosulam, diclosulam, cloransulam-methyl, penoxsulam, pyroxsulam, etc.];
(21) pyrimidinyloxybenzoate herbicidal compounds [pyrithiobac-sodium, bispyribac-sodium, pyriminobac-methyl, pyribenzoxim, pyriftalid, pyrimisulfan, etc.];
(22) other herbicidal active ingredients [bentazon, bromacil, terbacil, chlorthiamid, isoxaben, dinoseb, amitrole, cinmethylin, tridiphane, dalapon, diflufenzopyr-sodium, dithiopyr, thiazopyr, flucarbazone-sodium, propoxycarbazone-sodium, mefenacet, flufenacet, fentrazamide, cafénstrole, indanofan, oxaziclomefone, benfuresate, ACN, pyridate, chloridazon, norflurazon, flurtamone, diflufenican, picolinafen, beflubutamid, clomazone, amicarbazone, pinoxaden, pyraclonil, pyroxasulfone, thiencarbazone-methyl, aminocyclopyrachlor, ipfencarbazone, methiozolin, fenoxasulfone, etc.].

Examples of active ingredients for insecticides that can be mixed or used in combination with the herbicidal composition of the present invention include:

(1) organophosphorous insecticidal compounds:

acephate, butathiofos, chlorethoxyfos, chlorfenvinphos, chlorpyrifos, chlorpyrifos-methyl, cyanophos: CYAP, diazinon, dichlofenthion: ECP, dichlorvos: DDVP, dimethoate, dimethylvinphos, disulfoton, EPN, ethion, ethoprophos, etrimfos, fenthion: MPP, fenitrothion: MEP, fosthiazate, formothion, isofenphos, isoxathion, malathion, mesulfenfos, methidathion: DMTP, monocrotophos, naled: BRP, oxydeprofos: ESP, parathion, phosalone, phosmet: PMP, pirimiphos-methyl, pyridafenthion, quinalphos, phenthoate: PAP, profenofos, propaphos, prothiofos, pyraclorfos, salithion, sulprofos, tebupirimfos, temephos, tetrachlorvinphos, terbufos, thiometon, trichlorphon: DEP, vamidothion, phorate, cadusafos;

(2) carbamate insecticidal compounds:

alanycarb, bendiocarb, benfuracarb, BPMC, carbaryl, carbofuran, carbosulfan, cloethocarb, ethiofencarb, fenobucarb, fenothiocarb, fenoxycarb, furathiocarb, isoprocarb: MIPC, metolcarb, methomyl, methiocarb, oxamyl, pirimicarb, propoxur: PHC, XMC, thiodicarb, xylylcarb, aldicarb;

(3) pyrethroid compounds:

acrinathrin, allethrin, beta-cyfluthrin, bifenthrin, cycloprothrin, cyfluthrin, cyhalothrin, cypermethrin, empenthrin, deltamethrin, esfenvalerate, ethofenprox, fenpropathrin, fenvalerate, flucythrinate, flufenoprox, flumethrin, fluvalinate, halfenprox, imiprothrin, permethrin, prallethrin, pyrethrins, resmethrin, sigma-cypermethrin, silafluofen, tefluthrin, tralomethrin, transfluthrin, tetramethrin, phenothrin, cyphenothrin, alpha-cypermethrin, zeta-cypermethrin, lambda-cyhalothrin, gamma-cyhalothrin, furamethrin, tau-fluvalinate, metofluthrin, profluthrin, dimefluthrin, 2,3,5,6-tetrafluoro-4-(methoxymethyl)benzyl 2,2-dimethyl-3-(2-cyano-1-propenyl)cyclopropanecarboxylate, 2,3,5,6-tetrafluoro-4-(methoxymethyl)benzyl 2,2,3,3-tetramethylcyclopropanecarboxylate, protrifenbute;

(4) nereistoxin insecticidal compounds:

cartap, bensultap, thiocyclam, monosultap, bisultap;

(5) neonicotinoide compounds:

imidacloprid, nitenpyram, acetamiprid, thiamethoxam, thiacloprid, dinotefuran, clothianidin;

(6) benzoylurea insecticidal compounds:

chlorfluazuron, bistrifluoron, diflubenzuron, fluazuron, flucycloxuron, flufenoxuron, hexaflumuron, lufenuron, novaluron, noviflumuron, teflubenzuron, triflumuron;

(7) phenylpyrazole insecticidal compounds:

acetoprole, ethiprole, fipronil, vaniliprole, pyriprole, pyrafluprole.

(8) Bt toxin:

live spores or crystal toxins originated from Bacillus thuringiesis and a mixture thereof;

(9) hydrazine insecticidal compounds:

chromafenozide, halofenozide, methoxyfenozide, tebufenozide;

(10) organic chlorine insecticidal compounds:

aldrin, dieldrin, chlordane, DDT, dienochlor, endosulfan, methoxychlor;

(11) other insecticidal active ingredients:

machine oil, nicotine-sulfate; avermectin-B, bromopropylate, buprofezin, chlorphenapyr, cyromazine, DCIP (dichlorodiisopropyl ether), D-D(1,3-Dichloropropene), emamectin-benzoate, fenazaquin, flupyrazofos, hydroprene, methoprene, indoxacarb, metoxadiazone, milbemycin-A, pymetrozine, pyridalyl, pyriproxyfen, spinosad, sulfluramid, tolfenpyrad, triazamate, flubendiamide, lepimectin, aluminium phosphide, arsenous oxide, benclothiaz, calcium cyanamide, calcium polysulfide, DSP, flonicamid, flurimfen, formetanate, hydrogen phosphide, metam-ammonium, metam-sodium, methyl bromide, potassium oleate, spiromesifen, sulfur, metaflumizone, spirotetramat, pyrifluquinazone, spinetoram, chlorantraniliprole, tralopyril, diafenthiuron; a compound represented by the formula (A):

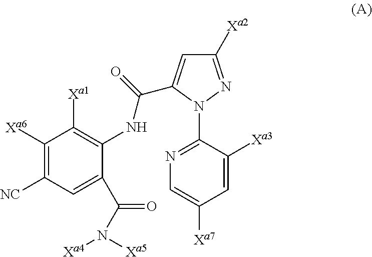

wherein X^{a1} represents a methyl group, chlorine, bromine or fluorine, X^{a2} represents fluorine, chlorine, bromine, a C₁-C₄ haloalkyl group or a C₁-C₄haloalkoxy group, X^{a3} represents fluorine, chlorine or bromine, X^{a4} represents an optionally substituted C₁-C₄ alkyl group, an optionally substituted C₃-C₄ alkenyl group, an optionally substituted C₃-C₄ alkynyl group, an optionally substituted C₃-C₅ cycloalkylalkyl group or hydrogen, X^{a5} represents hydrogen or a methyl group, X^{a6} represents hydrogen, fluorine or chlorine, and X^{a7} represents hydrogen, fluorine or chlorine;
a compound represented by the formula (B):

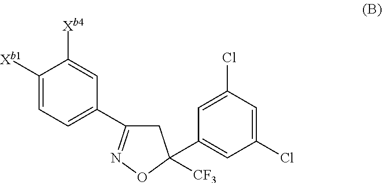

wherein X^{b1} represents a X^{b2}—NH—C(═O) group, a X^{b2}-C(═O)—NH—CH₂ group, a X^{b3}—S(O) group, an optionally substituted pyrrol-1-yl group, an optionally substituted imidazol-1-yl group, an optionally substituted pyrazol-1-yl group or an optionally substituted 1,2,4-triazol-1-yl group, X^{b2} represents an optionally substituted C₁-C₄ haloalkyl group such as a 2,2,2-trifluoroethyl group, or an optionally substituted C₃-C₆ cycloalkyl group such as a cyclopropyl group, X^{b3} represents an optionally substituted C₁-C₄ alkyl group such as methyl, and X″ represents hydrogen, chlorine, a cyano group or a methyl group; and
a compound represented by the formula (C):

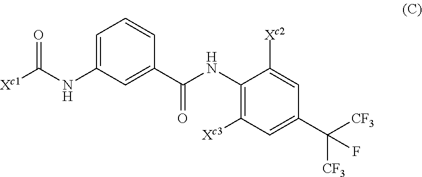

wherein X^{c1} represents an optionally substituted C₁-C₄ alkyl group such as a 3,3,3-trifluoropropyl group, an optionally substituted C₁-C₄alkoxy group such as a 2,2,2-trichloroethoxy group, an optionally substituted phenyl group such as a 4-cyanophenyl group, or an optionally substituted pyridyl group such as a 2-chloro-3-pyridyl group, X^{c2} represents a methyl group or a trifluoromethylthio group, and X^{c3} represents a methyl group or halogen.

Examples of active ingredients for acaricides that can be mixed or used in combination with the herbicidal composition of the present invention include: acequinocyl, amitraz, benzoximate, bifenazate, bromopropylate, chinomethionat, chlorobenzilate, CPCBS(chlorfenson), clofentezine, cyflumetofen, kelthane(dicofol), etoxazole, fenbutatin oxide, fenothiocarb, fenpyroximate, fluacrypyrim, halfenprox, hexythiazox, propargite: BPPS, polynactins, pyridaben, pyrimidifen, tebufenpyrad, tetradifon, spirodiclofen, spiromesifen, spirotetramat, amidoflumet, and cyenopyrafen.

Examples of active ingredients for nematocides that can be mixed or used in combination with the herbicidal composition of the present invention include: DCIP, fosthiazate, levamisol, methylsothiocyanate, morantel tartarate, and imicyafos.

Examples of active ingredients for fungicides that can be mixed or used in combination with the herbicidal composition of the present invention include:

(1) polyhaloalkylthio fungicidal compounds [captan, folpet, etc.];
(2) drganophosphorous fungicidal compounds [IBP, EDDP, tolclofos-methyl, etc.];
(3) benzimidazole fungicidal compounds [benomyl, carbendazim, thiophanate-methyl, thiabendazole, etc.];
(4) carboxamide fungicidal compounds [carboxin, mepronil, flutolanil, thifluzamid, furametpyr, boscalid, penthiopyrad, etc.];
(5) dicarboxylmide fungicidal compounds [procymidone, iprodione, vinclozolin, etc.];
(6) acylalanine fungicidal compounds [metalaxyl, etc.];
(7) azole fungicidal compounds [triadimefon, triadimenol, propiconazole, tebuconazole, cyproconazole, epoxiconazole, prothioconazole, ipconazole, triflumizole, prochloraz, penconazole, flusilazole, diniconazole, bromuconazole, difenoconazole, metconazole, tetraconazole, myclobutanil, fenbuconazole, hexaconazole, fluquinconazole, triticonazole, bitertanol, imazalil, flutriafol, etc.];
(8) morpholine fungicidal compounds [dodemorph, tridemorph, fenpropimorph, etc.];
(9) strobilurin compounds [azoxystrobin, kresoxim-methyl, metominostrobin, trifloxystrobin, picoxystrobin, pyraclostrobin, fluoxastrobin, dimoxystrobin, etc.];
(10) antibiotics [validamycin A, blasticidin S, kasugamycin, polyoxin, etc.];
(11) dithiocarbamate fungicidal compounds [mancozeb, maneb, thiuram, etc.]; and
(12) other fungicidal active ingrdients [fthalide, probenazole, isoprothiolane, tricyclazole, pyroquilon, ferimzone, acibenzolar S-methyl, carpropamid, diclocymet, fenoxanil, tiadinil, diclomezine, teclofthalam, pencycuron, oxolinic acid, TPN, triforine, fenpropidin, spiroxamine, fluazinam, iminoctadine, fenpiclonil, fludioxonil, quinoxyfen, fenhexamid, silthiofam, proquinazid, cyflufenamid, bordeaux mixture, dichlofluanid, cyprodinil, pyrimethanil, mepanipyrim, diethofencarb, pyribencarb, famoxadone, fenamidone, zoxamide, ethaboxam, amisulbrom, iprovalicarb, benthiavalicarb, cyazofamid, mandipropamid, metrafenone, fluopiram, bixafen, etc.].

Examples of active ingredients for plant growth regulators that can be mixed or used in combination with the herbicidal composition of the present invention include: hymexazol, paclobutrazol, uniconazole-P, inabenfide, prohexadione-calcium, aviglycine, 1-naphthaleneacetamide, abscisic acid, indolebutyric acid, ethychlozate, ethephon, cloxyfonac, chlormequat, dichlorprop, gibberellins, prohydrojasmon, benzyladenine, forchlorfenuron, maleic hydrazide, calcium peroxide, mepiquat-chloride, and 4-CPA (4-chlorophenoxyacetic acid).

Examples of active ingredients for safeners that can be mixed or used in combination with the herbicidal composition of the present invention include: furilazole, dichlormid, benoxacor, allidochlor, isoxadifen-ethyl, fenclorim, cyprosulfamide, cyometrinil, oxabetrinil, fluxofenim, flurazole, 2-dichloromethyl-2-methyl-1,3-dioxolane, and 1,8-naphthalic anhydride.

The present compound can be produced, for example, by the following Production Processes.

### Production Process 1

A compound represented by the formula (I-a), which is the present compound wherein G is hydrogen, can be produced by reacting a compound represented by the formula (II) with a metal hydroxide.

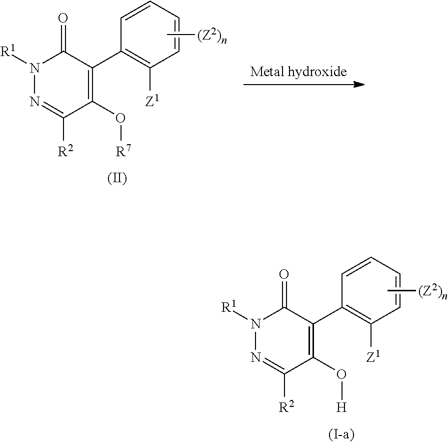

wherein R⁷ represents a C₁₋₆ alkyl group, and R¹, R², Z¹, Z² and n are as defined above.

The reaction is usually performed in a solvent. Examples of the solvent used in the reaction include water; ethers such as tetrahydrofuran and dioxane; and mixtures thereof.

Examples of the metal hydroxide used in the reaction include hydroxides of alkali metals such as sodium hydroxide and potassium hydroxide. The amount of the metal hydroxide used in the reaction is usually from 1 to 120 mol, preferably from 1 to 40 mol per 1 mol of the compound represented by the formula (II).

The reaction temperature is usually from room temperature to the boiling point of the solvent, preferably a boiling point of the solvent. The reaction can be also performed in a sealed tube or a high pressure resistant closed vessel while heating. The reaction time is usually from about 5 minutes to several weeks.

The progress of the reaction can be confirmed by analyzing a portion of the reaction mixture by thin layer chromatography or high performance liquid chromatography.

After completion of the reaction, the compound represented by the formula (I-a) can be isolated, for example, by neutralizing the reaction mixture with an addition of an acid, mixing the reaction mixture with water followed by extraction with an organic solvent, and then drying and concentrating the resulting organic layer.

### Production Process 2

A compound represented by the formula (I-b), which is the present compound wherein G is a group other than hydrogen, can be produced by reacting the compound represented by the formula (I-a) with a compound represented by the formula (III).

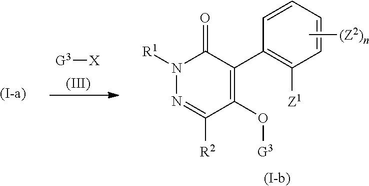

wherein G³ is as defined for G other thanhydrogen; X represents halogen or a group represented by the formula OG³; and R¹, R², Z¹, Z² and n are as defined above.

The reaction is performed in a solvent. Examples of the solvent used in the reaction include aromatic hydrocarbons such as benzene, toluene and xylene; ethers such as diethylether, diisopropylether, dioxane, tetrahydrofuran and dimethoxyethane; halogenated hydrocarbons such as dichloromethane, chloroform and 1,2-dichloroethane; amides such as dimethylformamide and dimethylacetamide; sulfoxides such as dimethyl sulfoxide; nuitriles such as acetonitrile; sulfones such as sulfolane; and mixtures thereof.

The amount of the compound represented by the formula (III) used in the reaction is usually 1 mol or more, preferably from 1 to 3 mol per 1 mol of the compound represented by the formula (I-a).

The reaction is usually performed in the presence of a base. Examples of the base used in the reaction include organic bases such as triethylamine, tripropylamine, pyridine, dimethylaminopyridine and 1,8-diazabicyclo[5.4.0]-7-undecene; and inorganic bases such as sodium hydroxide, potassium hydroxide, calcium hydroxide, sodium carbonate, potassium carbonate, sodium hydrogen carbonate, calcium carbonate and sodium hydride. The amount of the base used in the reaction is usually froth 0.5 to 10 mol, preferably from 1 to 5 mol per 1 mol of the compound represented by the formula (I-a).

The reaction temperature is usually from −30 to 180° C., preferably from −10 to 50° C. The reaction time is usually from 10 minutes to 30 hours.

The progress of the reaction can be confirmed by analyzing a portion of the reaction mixture by thin layer chromatography or high performance liquid chromatography.

After completion of the reaction, the compound represented by the formula (I-b) can be isolated, for example, by mixing the reaction mixture with water followed by extraction with an organic solvent, and then drying and concentrating the resulting organic layer.

### Production Process 3

A compound represented by the formula (I-a), which is the present, compound wherein G is hydrogen, can be produced by reacting a compound represented by the formula (VI) with a base.

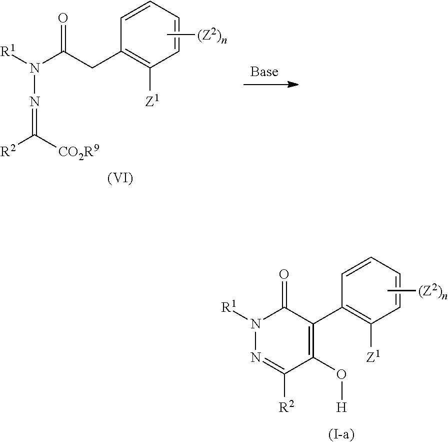

wherein R⁹ represents a C₁₋₆ alkyl group, and R¹, R², Z¹, Z² and n are as defined above.

The reaction is usually performed in a solvent. Examples of the solvent used in the reaction include aromatic hydrocarbons such as benzene, toluene and xylene; ethers such as diethylether, diisopropylether, dioxane, tetrahydrofuran and dimethoxyethane; halogenated hydrocarbons such as dichloromethane, chloroform and 1,2-dichloroethane; amides such as dimethylformamide and dimethylacetamide; nuitriles such as acetonitrile; sulfones such as sulfolane; and mixtures thereof.

Examples of the base used in the reaction include metal alkoxides such as potassium tert-butoxide; alkali metal hydrides such as sodium hydride; and organic bases such as triethylamine, tributylamine and N,N-diisopropylethylamine. The amount of the base used in the reaction is usually from 1 to 10 mol, preferably from 2 to 5 mol per 1 mol of the compound represented by the formula (VI).

The reaction temperature is usually from −60 to 180° C., and preferably from −10 to 100° C. The reaction time is usually from 10 minutes to 30 hours.

The progress of the reaction can be confirmed by analyzing a portion of the reaction mixture by thin layer chromatography or high performance liquid chromatography. After completion of the reaction, the compound represented by the formula (I-a) can be isolated, for example, by mixing the reaction mixture with water followed by extraction with an organic solvent, and then drying and concentrating the resulting organic layer.

### Reference Production Process 1

The compound represented by the formula (II) can be produced, for example, by a process shown below.

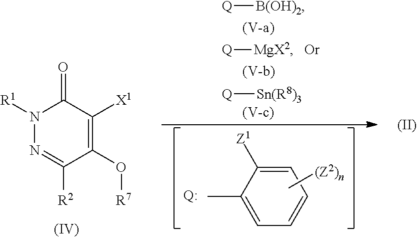

wherein X¹ represents a leaving group (for example, halogen such as chlorine, bromine or iodine), X² represents halogen, R⁸ represents a C₁₋₆ alkyl group, and R¹, R², R⁷, Z¹, Z² and n are as defined above.
Reaction of the Compound of the Formula (IV) with the Compound of the Formula (V-a):

The reaction is performed in a solvent. Examples of the solvent used in the reaction include aromatic hydrocarbons such as benzene, toluene and xylene; alcohols such as methanol, ethanol and propanol; ethers such as diethylether, diisopropylether, dioxane, tetrahydrofuran and dimethoxyethane; ketones such as acetone and methyl ethyl ketone; amides such as dimethylformamide and dimethylacetamide; sulfoxides such as dimethyl sulfoxide; sulfones such as sulfolane; water; and mixtures thereof.

The reaction is performed in the presence of a base. Examples of the base used in the reaction include organic bases such as triethylamine, tripropylamine, pyridine, dimethylaniline, dimethylaminopyridine and 1,8-diazabicyclo[5.4.0]-7-undecene; and inorganic bases such as sodium hydroxide, potassium hydroxide, calcium hydroxide, sodium carbonate, potassium carbonate, sodium hydrogen carbonate, calcium carbonate, cesium carbonate and potassium phosphonate. The amount of the base used in the reaction is usually from 0.5 to 10 mol, preferably from 1 to 5 mol per 1 mol of the compound represented by the formula (IV).

The reaction is performed in the presence of a palladium catalyst such as tetrakis(triphenylphosphine)palladium or dichlorobis(triphenylphosphine)palladium. The amount of the palladium catalyst used in the reaction is usually from 0.001 to 0.5 mol, preferably from 0.01 to 0.2 mol per 1 mol of the compound represented by the formula (IV). The reaction can also be performed in the presence of a quaternary ammonium salt. Examples of the quaternary ammonium salt which can be used in the reaction include tetrabutylammonium bromide.

The reaction temperature is usually from 20 to 180° C., preferably from 60 to 150° C. The reaction time is usually from 30 minutes to 100 hours. The progress of the reaction can be confirmed by analyzing a portion of the reaction mixture by thin layer chromatography or high performance liquid chromatography. After completion of the reaction, the compound represented by the formula (II) can be isolated, for example, by mixing the reaction mixture with water followed by extraction with an organic solvent, and then drying and concentrating the resulting organic layer.

Reaction of the Compound of the Formula (IV) with the Compound of the Formula (V-b):

The reaction is performed in a solvent. Examples of the solvent used in the reaction include aromatic hydrocarbons such as benzene, toluene and xylene; ethers such as diethylether, diisopropylether, dioxane, tetrahydrofuran and dimethoxyethane; and mixtures thereof.

The reaction is performed in the presence of a nickel catalyst such as dichlorobis(1,3-diphenylphosphino)propanenickel or dichlorobis(triphenylphosphine)nickel; or a palladium catalyst such as tetrakis(triphenylphosphine)palladium or dichlorobis(triphenylphosphine)palladium. The amount of the catalyst used in the reaction is usually from 0.001 to 0.5 mol, preferably from 0.01 to 0.2 mol per 1 mol of the compound represented by the formula (IV).

The reaction temperature is usually from −80 to 180° C., preferably from −30 to 150° C. The reaction time is usually 30 minutes to 100 hours. The progress of the reaction can be confirmed by analyzing a portion of the reaction mixture by thin layer chromatography or high performance liquid chromatography. After completion of the reaction, the compound represented by the formula (II) can be isolated, for example, by mixing the reaction mixture with water followed by extraction with an organic solvent, and then drying and concentrating the resulting organic layer.

Reaction of the Compound of the Formula (IV) with the Compound of the Formula (V-c):

The reaction is performed in a solvent. Examples of the solvent used in the reaction include aromatic hydrocarbons such as benzene, toluene and xylene; ethers such as diethylether, diisopropylether, dioxane, tetrahydrofuran and dimethoxyethane; halogenated hydrocarbons such as chloroform and 1,2-dichloroethane; amides such as dimethylformamide and dimethylacetamide; and mixtures thereof.

The reaction is performed in the presence of a palladium catalyst such as tetrakis(triphenylphosphine)palladium or dichlorobis(triphenylphosphine)palladium. The amount of the catalyst used in the reaction is usually from 0.001 to 0.5 mol, preferably from 0.01 to 0.2 mol per 1 mol of the compound represented by the formula (IV).

The reaction temperature is usually from −80 to 180° C., preferably from −30 to 150° C. The reaction time is usually from 30 minutes to 100 hours. The progress of the reaction can be confirmed by analyzing a portion of the reaction mixture by thin layer chromatography or high performance liquid chromatography. After completion of the reaction, the compound represented by the formula (II) can be isolated, for example, by mixing the reaction mixture with water followed by extraction with an organic solvent, and then drying and concentrating the resulting organic layer.

### Reference Production Process 2

The compound represented by the formula (VI) can be produced by reacting a compound represented by the formula (VII) with a compound represented by the formula (VIII).

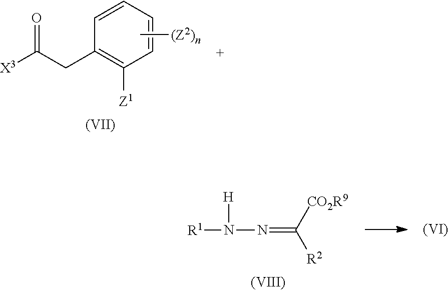

wherein X³ represents halogen, and R¹, R², R⁹, Z¹, Z² and n are as defined above.

The reaction is usually performed in a solvent. Examples of the solvent used in the reaction include nitriles such as acetonitrile; ketones such as acetone; aromatic hydrocarbons such as benzene, toluene and xylene; ethers such as diethylether, diisopropylether, dioxane, tetrahydrofuran and dimethoxyethane; halogenated hydrocarbons such as dichloromethane, chloroform and 1,2-dichloroethane; amides such as dimethylformamide and dimethylacetamide; sulfones such as sulfolane; and mixtures thereof.

The reaction is usually performed in the presence of a base. Examples of the base used in the reaction include organic bases such as triethylamine, tripropylamine, pyridine, dimethylaminopyridine, 1,8-diazabicyclo[5.4.0]-7-undecene and 1,4-diazabicyclo[2.2.2]octane; and inorganic bases such as sodium hydroxide, potassium hydroxide, calcium hydroxide, sodium carbonate, potassium carbonate, sodium hydrogen carbonate, calcium carbonate and sodium hydride.

The amount of the compound represented by the formula (VIII) used in the reaction is usually 1 mol or more, preferably from 1 to 3 mol per 1 mol of the compound represented by the formula (VII). The amount of the base used in the reaction is usually from 0.5 to 10 mol, preferably from 1 to 5 mol per 1 mol of the compound represented by the formula (VII).

The reaction temperature is usually from −30 to 180° C., preferably from −10 to 50° C. The reaction time is usually from 10 minutes to 30 hours.

The progress of the reaction can be confirmed by analyzing a portion of the reaction mixture by thin layer chromatography or high performance liquid chromatography. After completion of the reaction, the compound represented by the formula (VI) can be isolated, for example, by mixing the reaction mixture with water followed by extraction with an organic solvent, and then drying and concentrating the resulting organic layer.

The compound represented by the formula (VII) can be produced by reacting a compound represented by the formula (IX):

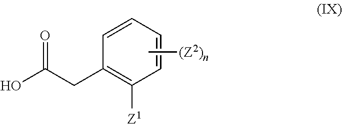

wherein Z¹, Z² and n are as defined above, with a halogenating agent (for example, thionyl chloride, thionyl bromide, phosphorus oxychloride, oxalyl chloride, etc.).

Specific examples of the present compound include:

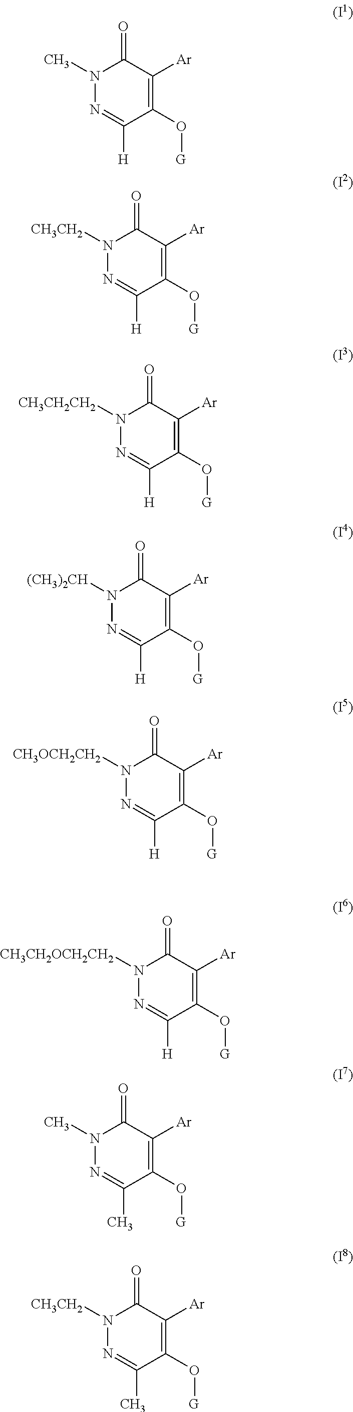

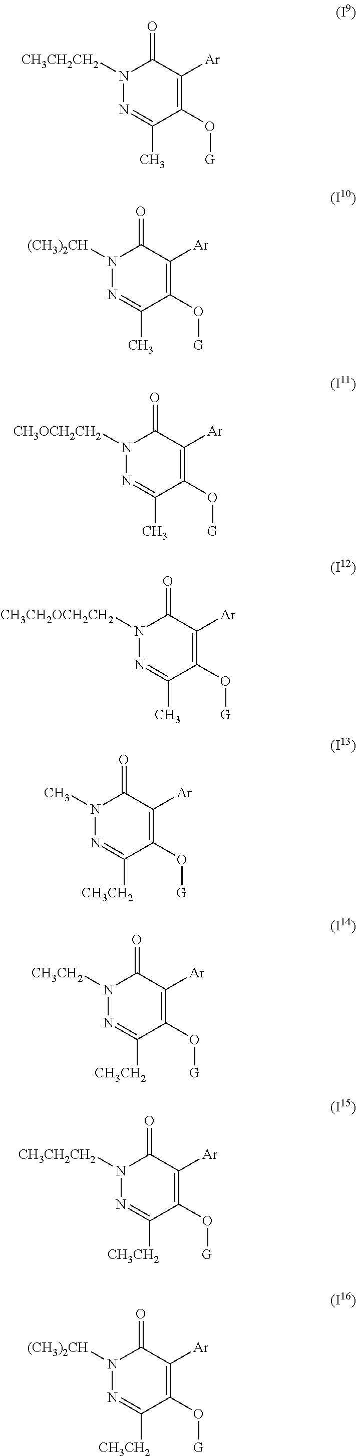

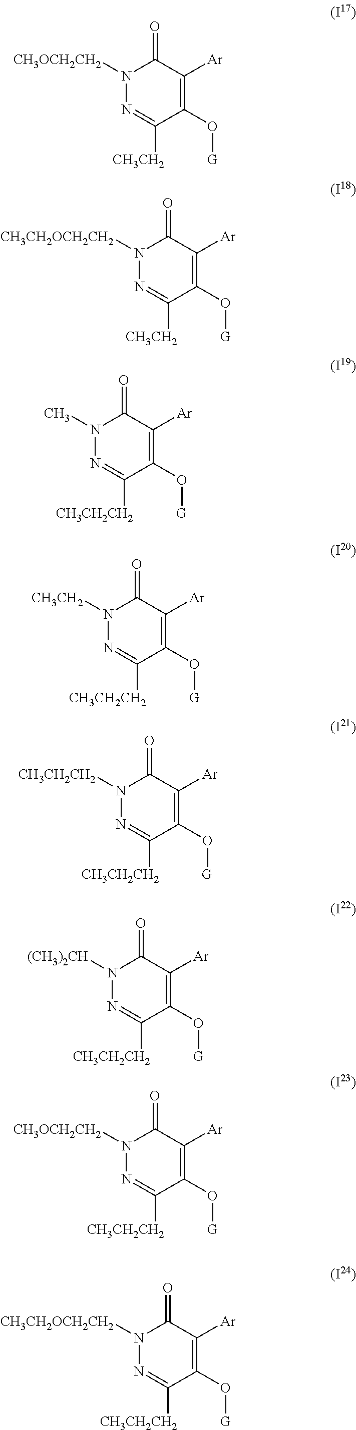

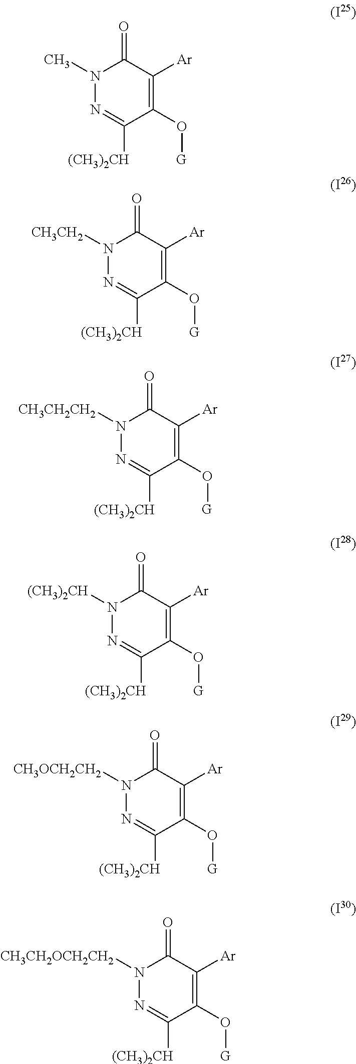

1) a pyridazinone compound represented by any one of the formula (I¹) to (I³⁰), wherein Ar is a 2-ethylphenyl group, and G is hydrogen, an acetyl group, a trifluoroacetyl group, a propionyl group, a butyryl group, an isobutyryl group, an isovaleryl group, a pivaloyl group, a cyclohexylcarbonyl group, a benzoyl group, a benzylcarbonyl group, a methoxycarbonyl group, an ethoxycarbonyl group, a propoxycarbonyl group, an isopropoxycarbonyl group, a butoxycarbonyl group, an isobutoxycarbonyl group, a tert-butoxycarbonyl group, an allyloxycarbonyl group, a phenoxycarbonyl group, a dimethylaminocarbonyl group, a dimethylaminothiocarbonyl group, a methanesulfonyl group, a trifluoromethanesulfonyl group, a benzenesulfonyl group, p-toluenesulfonyl group or a diethoxyphosphoryl group;
2) a pyridazinone compound represented by any one of the formula (I¹) to (I³⁰), wherein Ar is a 2-propylphenyl group, and G is hydrogen, an acetyl group, a trifluoroacetyl group, a propionyl group, a butyryl group, an isobutyryl group, an isovaleryl group, a pivaloyl group, a cyclohexylcarbonyl group, a benzoyl group, a benzylcarbonyl group, a methoxycarbonyl group, an ethoxycarbonyl group, a propoxycarbonyl group, an isopropoxycarbonyl group, a butoxycarbonyl group, an isobutoxycarbonyl group, a tert-butoxycarbonyl group, an allyloxycarbonyl group, a phenoxycarbonyl group, a dimethylaminocarbonyl group, a dimethylaminothiocarbonyl group, a methanesulfonyl group, a trifluoromethanesulfonyl group, a benzenesulfonyl group, a p-toluenesulfonyl group or a diethoxyphosphoryl group;
3) a pyridazinone compound represented by any one of the formula (I¹) to (I³⁰), wherein Ar is a 2,4-dimethylphenyl group, and G is hydrogen, an acetyl group, a trifluoroacetyl group, a propionyl group, a butyryl group, an isobutyryl group, an isovaleryl group, a pivaloyl group, a cyclohexylcarbonyl group, a benzoyl group, a benzylcarbonyl group, a methoxycarbonyl group, an ethoxycarbonyl group, a propoxycarbonyl group, an isopropoxycarbonyl group, a butoxycarbonyl group, an isobutoxycarbonyl group, a tert-butoxycarbonyl group, an allyloxycarbonyl group, a phenoxycarbonyl group, a dimethylaminocarbonyl group, a dimethylaminothiocarbonyl group, a methanesulfonyl group, a trifluoromethanesulfonyl group, a benzenesulfonyl group, a p-toluenesulfonyl group or a diethoxyphosphoryl group;
4) a pyridazinone compound represented by any one of the formula (I¹) to (I³⁰), wherein Ar is a 2,6-dimethylphenyl group, and G is hydrogen, an acetyl group, a trifluoroacetyl group, a propionyl group, a butyryl group, an isobutyryl group, an isovaleryl group, a pivaloyl group, a cyclohexylcarbonyl group, a benzoyl group, a benzylcarbonyl group, a methoxycarbonyl group, an ethoxycarbonyl group, a propoxycarbonyl group, an isopropoxycarbonyl group, a butoxycarbonyl group, an isobutoxycarbonyl group, a tert-butoxycarbonyl group, an allyloxycarbonyl group, a phenoxycarbonyl group, a dimethylaminocarbonyl group, a dimethylaminothiocarbonyl group, a methanesulfonyl group, a trifluoromethanesulfonyl group, a benzenesulfonyl group, a p-toluenesulfonyl group or a diethoxyphosphoryl group;
5) a pyridazinone compound represented by any one of the formula (I¹) to (I³⁰), wherein Ar is a 2-ethyl-4-methylphenyl group, and G is hydrogen, an acetyl group, a trifluoroacetyl group, a propionyl group, a butyryl group, an isobutyryl group, an isovaleryl group, a pivaloyl group, a cyclohexylcarbonyl group, a benzoyl group, a benzylcarbonyl group, a methoxycarbonyl group, an ethoxycarbonyl group, a propoxycarbonyl group, an isopropoxycarbonyl group, a butoxycarbonyl group, an isobutoxycarbonyl group, a tert-butoxycarbonyl group, an allyloxycarbonyl group, a phenoxycarbonyl group, a dimethylaminocarbonyl group, a dimethylaminothiocarbonyl group, a methanesulfonyl group, a trifluoromethanesulfonyl group, a benzenesulfonyl group, a p-toluenesulfonyl group or a diethoxyphosphoryl group;
6) a pyridazinone compound represented by any one of the formula (I¹) to (I³⁰), wherein Ar is a 2-ethyl-6-methylphenyl group, and G is hydrogen, an acetyl group, a trifluoroacetyl group, a propionyl group, a butyryl group, an isobutyryl group, an isovaleryl group, a pivaloyl group, a cyclohexylcarbonyl group, a benzoyl group, a benzylcarbonyl group, a methoxycarbonyl group, an ethoxycarbonyl group, a propoxycarbonyl group, an isopropoxycarbonyl group, a butoxycarbonyl group, an isobutoxycarbonyl group, a tert-butoxycarbonyl group, an allyloxycarbonyl group, a phenoxycarbonyl group, a dimethylaminocarbonyl group, a dimethylaminothiocarbonyl group, a methanesulfonyl group, a trifluoromethanesulfonyl group, a benzenesulfonyl group, a p-toluenesulfonyl group or a diethoxyphosphoryl group;
7) a pyridazinone compound represented by any one of the formula (I¹) to (I³⁰), wherein Ar is a 2,6-diethylphenyl group, and G is hydrogen, an acetyl group, trifluoroacetyl group, a propionyl group, a butyryl group, an isobutyryl group, an isovaleryl group, a pivaloyl group, a cyclohexylcarbonyl group, a benzoyl group, a benzylcarbonyl group, a methoxycarbonyl group, an ethoxycarbonyl group, a propoxycarbonyl group, an isopropoxycarbonyl group, a butoxycarbonyl group, an isobutoxycarbonyl group, a tert-butoxycarbonyl group, an allyloxycarbonyl group, a phenoxycarbonyl group, a dimethylaminocarbonyl group, a dimethylaminothiocarbonyl group, a methanesulfonyl group, a trifluoromethanesulfonyl group, a benzenesulfonyl group, a p-toluenesulfonyl group or a diethoxyphosphoryl group;
8) a pyridazinone compound represented by any one of the formula (I¹) to (I³⁰), wherein Ar is a 2,4,6-trimethylphenyl group, and G is hydrogen, an acetyl group, a trifluoroacetyl group, a propionyl group, a butyryl group, an isobutyryl group, an isovaleryl group, a pivaloyl group, a cyclohexylcarbonyl group, a benzoyl group, a benzylcarbonyl group, a methoxycarbonyl group, an ethoxycarbonyl group, a propoxycarbonyl group, an isopropoxycarbonyl group, a butoxycarbonyl group, an isobutoxycarbonyl group, a tert-butoxycarbonyl group, an allyloxycarbonyl group, a phenoxycarbonyl group, a dimethylaminocarbonyl group, a dimethylaminothiocarbonyl group, a methanesulfonyl group, a trifluoromethanesulfonyl group, a benzenesulfonyl group, a p-toluenesulfonyl group or a diethoxyphosphoryl group;
9) a pyridazinone compound represented by any one of the formula (I¹) to (I³⁰), wherein Ar is a 2-ethyl-4,6-dimethylphenyl group, and G is hydrogen, an acetyl group, a trifluoroacetyl group, a propionyl group, a butyryl group, an isobutyryl group, an isovaleryl group, a pivaloyl group, a cyclohexylcarbonyl group, a benzoyl group, benzylcarbonyl group, a methoxycarbonyl group, an ethoxycarbonyl group, a propoxycarbonyl group, an isopropoxycarbonyl group, a butoxycarbonyl grOup, an isobutoxycarbonyl group, a tert-butoxycarbonyl group, an allyloxycarbonyl group, a phenoxycarbonyl group, a dimethylaminocarbonyl group, a dimethylaminothiocarbonyl group, a methanesulfonyl group, a trifluoromethanesulfonyl group, a benzenesulfonyl group, a p-toluenesulfonyl group or a diethoxyphosphoryl group;
10) a pyridazinone compound represented by any one of the formula (I¹) to (I³⁰), wherein Ar is a 2,6-diethyl-4-methylphenyl group, and G is hydrogen, an acetyl group, a trifluoroacetyl group, a propionyl group, a butyryl group, an isobutyryl group, an isovaleryl group, a pivaloyl group, a cyclohexylcarbonyl group, a benzoyl group, a benzylcarbonyl group, a methoxycarbonyl group, an ethoxycarbonyl group, a propoxycarbonyl group, an isopropoxycarbonyl group, a butoxycarbonyl group, an isobutoxycarbonyl group, a tert-butoxycarbonyl group, an allyloxycarbonyl group, a phenoxycarbonyl group, a dimethylaminocarbonyl group, a dimethylaminothiocarbonyl group, a methanesulfonyl group, a trifluoromethanesulfonyl group, a benzenesulfonyl group, a p-toluenesulfonyl group or a diethoxyphosphoryl group;
11) a pyridazinone compound represented by any one of the formula (I¹) to (I³⁰), wherein Ar is a 2,4,6-triethylphenyl group, and G is hydrogen, an acetyl group, a trifluoroacetyl group, a propionyl group, a butyryl group, an isobutyryl group, an isovaleryl group, a pivaloyl group, a cyclohexylcarbonyl group, a benzoyl group, a benzylcarbonyl group, a methoxycarbonyl group, an ethoxycarbonyl group, a propoxycarbonyl group, an isopropoxycarbonyl group, a butoxycarbonyl group, an isobutoxycarbonyl group, a tert-butoxycarbonyl group, an allyloxycarbonyl group, a phenoxycarbonyl group, a dimethylaminocarbonyl group, a dimethylaminothiocarbonyl group, a methanesulfonyl group, a trifluoromethanesulfonyl group, a benzenesulfonyl group, a p-toluenesulfonyl group or a diethoxyphosphoryl group;
12) a pyridazinone compound represented by any one of the formula (I¹) to (I³⁰), wherein Ar is a 2,4-diethylphenyl group, and G is hydrogen, an acetyl group, a trifluoroacetyl group, a propionyl group, a butyryl group, an isobutyryl group, an isovaleryl group, a pivaloyl group, a cyclohexylcarbonyl group, a benzoyl group, a benzylcarbonyl group, a methoxycarbonyl group, an ethoxycarbonyl group, a propoxycarbonyl group, an isopropoxycarbonyl group, a butoxycarbonyl group, an isobutoxycarbonyl group, a tert-butoxycarbonyl group, an allyloxycarbonyl group, a phenoxycarbonyl group, a dimethylaminocarbonyl group, a dimethylaminothiocarbonyl group, a methanesulfonyl group, a trifluoromethanesulfonyl group, a benzenesulfonyl group, a p-toluenesulfonyl group or a diethoxyphosphoryl group; and
13) a pyridazinone compound represented by any one of the formula (I¹) to (I³⁰), wherein Ar is a 2,4-diethyl-6-methylphenyl group, and G is hydrogen, an acetyl group, a trifluoroacetyl group, a propionyl group, a butyryl group, an isobutyryl group, an isovaleryl group, a pivaloyl group, a cyclohexylcarbonyl group, a benzoyl group, a benzylcarbonyl group, a methoxycarbonyl group, an ethoxycarbonyl group, a propoxycarbonyl group, an isopropoxycarbonyl group, a butoxycarbonyl group, an isobutoxycarbonyl group, a tert-butoxycarbonyl group, an allyloxycarbonyl group, a phenoxycarbonyl group, a dimethylaminocarbonyl group, a dimethylaminothiocarbonyl group, a methanesulfonyl group, a trifluoromethanesulfonyl group, a benzenesulfonyl group, a p-toluenesulfonyl group or a diethoxyphosphoryl group.

### EXAMPLES

The present invention will be specifically illustrated by way of Production Examples, Formulation Examples and Test Example, but the present invention is not limited to these Examples.

Herein, the term “part(s)” means part(s) by weight.

### Production Example 1

A mixture of 3.193 g of 4-(2-ethylphenyl)-5-methoxy-2-methyl-3(2H)-pyridazinone [compound II-1], 50 mL of water, 4.657 g of potassium hydroxide (purity: 85%) and 5 mL of 1,4-dioxane was heated under reflux for 36 hours. The reaction mixture was cooled. To the reaction mixture, concentrated hydrochloric acid, 10 mL of water and 100 mL of ethyl acetate were added. Insoluble matters in the mixture were removed by filtration and the filtrate was made phase-separated. The organic layer was washed sequentially with water and an aqueous saturated sodium chloride solution, dried over anhydrous magnesium sulfate and then concentrated. The residue was washed with an ethyl acetate-hexane mixed solvent (1:2) to obtain 2.050 g of 4-(2-ethylphenyl)-5-hydroxy-2-methyl-3(2H)-pyridazinone [compound I-a-1] as a colorless crystal.

The compound I-a-1 and other compounds produced in the same manner as Production Example 1 are shown in Table 1. The compound represented by the formula (I-a):

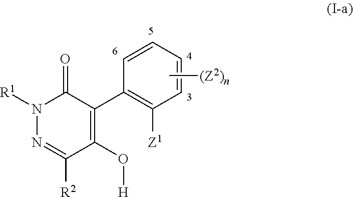

TABLE 1

| | | | | | Melting |
|---|---|---|---|---|---|
| Compound | R¹ | R² | Z¹ | (Z²)ₙ | point/° C. |
| I-a-1 | Me | H | Et | — | 218-220 |
| I-a-2 | Et | H | Et | — | 190-192 |
| I-a-3 | i-Pr | H | Et | — | 226-227 |
| I-a-4 | MeOCH₂CH₂ | H | Et | — | 137-139 |
| I-a-5 | Me | H | Pr | — | 210-211 |
| I-a-6 | Me | H | Me | 6-Me | 267-271 |
| I-a-7 | Me | H | Et | 6-Me | 239-242 |
| I-a-8 | Me | H | Et | 6-Et | 247-249 |
| I-a-9 | Me | H | Me | 4-Me | 219-220 |
| I-a-10 | Me | H | Me | 4-Me, 6-Me | 272-275 |
| I-a-11 | Et | H | Me | 4-Me, 6-Me | >300 |
| I-a-12 | Me | H | Et | 4-Me, 6-Et | 254-255 |

### Production Example 2

Under a nitrogen atmosphere, a solution of 1.9 g of ethyl 2-[2-(2,6-diethyl-4-methylphenylacetyl)-2-methylhydrazono]propanoate [compound VI-2] in 55 mL of toluene was added dropwise to 13 mL of a solution (1 mol/L) of potassium tert-butoxide in tetrahydrofuran at room temperature over about 1 hour. This mixture was stirred at room temperature for 30 minutes. The reaction mixture was concentrated under reduced pressure. To the resultant residue, 30 mL of ice water was added, followed by washing with tert-butyl methyl ether (20 mL×2). To the aqueous layer, 1.6 g of 35% hydrochloric acid was added, followed by extraction with ethyl acetate (20 mL×3). The organic layer was washed with an aqueous saturated sodium chloride solution (20 mL×2), dried over anhydrous magnesium sulfate and concentrated under reduced pressure. The resultant residue was subjected to silica gel column chromatography (ethyl acetate:hexane=1:3) to obtain 0.76 g of a solid. The solid was washed with cold hexane and dried to obtain 0.59 g of 4-(2,6-diethyl-4-methylphenyl)-5-hydroxy-2,6-dimethyl-3(2H)-pyridazinone [compound I-a-14] as white powder.

The compound I-a-14 and other compounds produced in the same manner as Production Example 2 are shown in Table 2.

The compound represented by the formula (I-a):

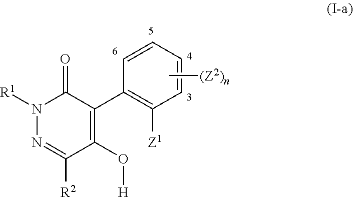

TABLE 2

| | | | | | Melting |
|---|---|---|---|---|---|
| Compound | R¹ | R² | Z¹ | (Z²)ₙ | point/° C. |
| I-a-13 | Me | Me | Me | 4-Me, 6-Me | 199-201 |
| I-a-14 | Me | Me | Et | 4-Me, 6-Et | 205-206 |
| I-a-15 | Me | Me | Et | — | 171-172 |
| I-a-16 | Me | Me | Et | 4-Me | 187-188 |
| I-a-17 | Me | Me | Et | 4-Et, 6-Et | 188-190 |
| I-a-18 | Me | Me | Et | 4-Me, 6-Me | 176-177 |
| I-a-19 | Me | Et | Et | 4-Me, 6-Et | 194-195 |
| I-a-20 | Me | Et | Et | 4-Me | 148-149 |
| I-a-21 | Me | Et | Et | 4-Me, 6-Me | 188-189 |
| I-a-22 | Me | Et | Me | 4-Me, 6-Me | 210-211 |
| I-a-23 | Me | i-Pr | Et | 4-Me, 6-Et | 208-210 |
| I-a-24 | Me | Pr | Et | 4-Me, 6-Et | 175-176 |
| I-a-25 | Me | Et | Et | 4-Et, 6-Et | 170-171 |
| I-a-26 | Me | Pr | Et | 4-Et, 6-Et | 174-175 |
| I-a-27 | Me | Me | Et | 4-Et | 178-180 |
| I-a-28 | Me | Et | Et | 4-Et | 163-164 |
| I-a-29 | Me | Me | Et | 4-Et, 6-Me | 168-169 |
| I-a-30 | Me | Me | Et | 6-Et | 187-188 |

### Production Example 3

To 0.326 g of the compound I-a-1, 12 mL of tetrahydrofuran and 0.40 mL of triethylamine were added. To this mixture, 0.25 mL of benzoyl chloride was added under ice cooling. The mixture was stirred under ice cooling for 10 minutes and then stirred at room temperature for 3 hours. To the reaction mixture, 30 mL of water was added, followed by extraction twice with 30 mL of ethyl acetate. The organic layer was washed with an aqueous saturated sodium chloride solution, dried over anhydrous magnesium sulfate and concentrated. The residue was subjected to silica gel column chromatography (ethyl acetate:hexane=1:2, 2:1) to obtain 0.463 g of 5-benzoyloxy-4-(2-ethylphenyl)-2-methyl-3(2H)-pyridazinone [compound I-b-1] as a colorless oil.

The compound I-b-1 and other compounds produced in the same manner as Production Example 3 are shown in Table 3. The compound represented by the formula (I-b):

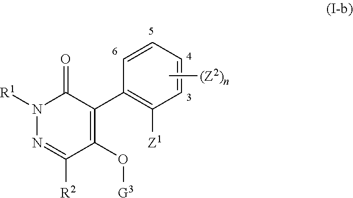

TABLE 3

| | | | | | | Melting |
|---|---|---|---|---|---|---|
| No. | R¹ | R² | Z¹ | (Z²)n | G³ | point/° C. |
| I-b-1 | Me | H | Et | — | COPh | * |
| I-b-2 | Me | H | Et | — | COMe | 69-70 |
| I-b-3 | Me | H | Et | — | COEt | * |
| I-b-4 | Me | H | Et | — | COi-Pr | 77-79 |
| I-b-5 | Me | H | Et | — | COt-Bu | 56-59 |
| I-b-6 | Me | H | Et | — | COc-Hex | * |
| I-b-7 | Me | H | Et | — | CO₂Me | 81-82 |
| I-b-8 | Me | H | Et | — | CONMe₂ | * |
| I-b-9 | Me | H | Et | — | SO₂Me | * |
| I-b-10 | Me | H | Pr | — | COMe | 78-79 |
| I-b-11 | Me | H | Me | 4-Me, 6-Me | COt-Bu | 93-96 |
| I-b-12 | Me | H | Et | 4-Me, 6-Et | COMe | 99-101 |
| I-b-13 | Me | Me | Me | 4-Me, 6-Me | COMe | 130-131 |
| I-b-14 | Me | Me | Et | 4-Me, 6-Et | COMe | 133-134 |
| I-b-15 | Me | Me | Et | 4-Me, 6-Et | COt-Bu | 105-106 |
| I-b-16 | Me | Me | Et | — | COMe | 148-149 |
| I-b-17 | Me | Me | Et | — | COt-Bu | 89 |
| I-b-18 | Me | Me | Et | 4-Me, 6-Et | CO₂Et | 73-74 |
| I-b-19 | Me | Me | Et | 4-Me, 6-Et | COPh | 145-146 |
| I-b-20 | Me | Me | Et | 4-Me | COMe | 142-143 |
| I-b-21 | Me | Me | Et | 4-Et, 6-Et | COMe | 103-104 |
| I-b-22 | Me | Me | Et | 4-Me, 6-Me | COMe | 106-107 |
| I-b-23 | Me | Me | Et | 4-Me, 6-Et | COEt | 103-104 |
| I-b-24 | Me | Me | Et | 4-Me, 6-Et | COi-Pr | 102-103 |
| I-b-25 | Me | Me | Et | 4-Me, 6-Et | CO₂Me | 95-96 |
| I-b-26 | Me | Me | Et | 4-Me, 6-Et | CO₂Ph | 105 |
| I-b-27 | Me | Me | Et | 4-Me, 6-Et | SO₂Me | 153-154 |
| I-b-28 | Me | Me | Et | 4-Me, 6-Et | SO₂CF₃ | 63-67 |
| I-b-29 | Me | Et | Et | 4-Me, 6-Et | COMe | 133-134 |
| I-b-30 | Me | Pr | Et | 4-Me, 6-Et | COMe | 161-162 |
| I-b-31 | Me | i-Pr | Et | 4-Me, 6-Et | COMe | 159-160 |
| I-b-32 | Me | Et | Et | 4-Et, 6-Et | COMe | 117-118 |
| I-b-33 | Me | Me | Et | 4-Et | COMe | 115-116 |
| I-b-34 | Me | Me | Et | 6-Et | COMe | 127-128 |
| I-b-35 | Me | Me | Et | 4-Me, 6-Me | CO₂Et | 65-67 |
| I-b-36 | Me | Me | Et | 4-Et, 6-Et | CO₂Me | 116-117 |
| I-b-37 | Me | Me | Et | 4-Me, 6-Me | CO₂Me | 95-96 |
| I-b-38 | Me | Me | Et | 4-Et, 6-Et | CO₂CH₂CH═CH₂ | 87-88 |
| I-b-39 | Me | Me | Et | 4-Me, 6-Et | CO₂CH₂CH═CH₂ | 62-63 |
| I-b-40 | Me | Me | Et | 4-Et, 6-Et | CO₂i-Bu | 70-72 |
| I-b-41 | Me | Me | Et | 4-Et, 6-Et | CO₂Bu | 62-63 |
| I-b-42 | Me | Me | Et | 4-Et, 6-Et | CO₂Pr | 55-58 |
| I-b-43 | Me | Me | Et | 4-Et, 6-Et | CO₂i-Pr | 86-87 |
| I-b-44 | Me | Me | Et | 4-Me, 6-Me | CO₂CH₂CH═CH₂ | 48-49 |
| I-b-45 | Me | Me | Et | 4-Me, 6-Me | CO₂Et | * |
| I-b-46 | Me | Me | Et | 4-Et, 6-Et | CSNMe₂ | * |

Regarding the compounds with asterisk (*) in the column of melting point in Table 3, ¹H NMR data are shown below.

### Compound I-b-1:

¹H NMR (CDCl₃) δ ppm: 1.14 (3H, t, J=7.7 Hz), 2.45-2.62 (2H, m), 3.88 (3H, s), 7.09-7.12 (1H, m), 7.15-7.20 (1H, m), 7.28-7.30 (2H, m), 7.37-7.42 (2H, m), 7.55-7.60 (1H, m), 7.81-7.84 (2H, m), 7.95 (1H, s).

### Compound I-b-3:

¹H NMR (CDCl₃) δ ppm: 0.94 (3H, t, J=7.6 Hz), 1.13 (3H, t, J=7.7 Hz), 2.27 (2H, dq, J=1.4, 7.6 Hz), 2.38-2.56 (2H, m), 3.84 (3H, s), 7.00-7.03 (1H, m), 7.18-7.23 (1H, m), 7.30-7.35 (2H, m), 7.75 (1H, s).

### Compound I-b-6:

¹H NMR (CDCl₃) δ ppm: 1.13 (3H, t, J=7.7 Hz), 1.10-1.22 (5H, m), 1.5-1.7 (5H, m), 2.28 (1H, br.), 2.38-2.55 (2H, m), 3.84 (3H, s), 6.99-7.02 (1H, m), 7.17-7.22 (1H, m), 7.29-7.36 (2H, m), 7.72 (1H, s).

### Compound I-b-8:

¹H NMR (CDCl₃) δ ppm: 1.11 (3H, t, J=7.7 Hz), 2.40-2.57 (2H, m), 2.64 (3H, s), 2.85 (3H, s), 3.83 (3H, s), 7.05-7.08 (1H, m), 7.19-7.24 (1H, m), 7.30-7.36 (2H, m), 7.95 (1H, s).

### Compound I-b-9:

¹H NMR (CDCl₃) δ ppm: 1.18 (3H, t, J=7.6 Hz), 2.43-2.57 (2H, m), 2.58 (3H, s), 3.85 (3H, s), 7.16-7.19 (1H, m), 7.25-7.30 (1H, m), 7.36-7.43 (2H, m), 7.96 (1H, s).

### Compound I-b-45:

¹H NMR (CDCl₃) δ ppm: 1.10 (3H, t, J=7.6 Hz), 1.12 (3H, t, J=6.8 Hz), 2.05 (3H, s), 2.30 (3H, s), 2.31 (3H, s), 2.31-2.37 (2H, m), 3.82 (3H, s), 4.07 (2H, q, J=6.8 Hz), 6.90 (1H, s) 6.94 (1H, s).

### Compound (I-b-46):

¹H NMR (CDCl₃) δ ppm: 1.06 (3H, t, J=7.6 Hz), 1.17 (3H, t, J=7.6 Hz), 1.24 (3H, t, J=7.6 Hz), 2.35 (2H, q, J=7.6 Hz), 2.35 (3H, s), 2.46-2.66 (4H, m), 2.84 (3H, s), 3.17 (3H, s), 3.82 (3H, s), 6.90 (1H, s), 6.98 (1H, s).

### Production Example 4

A mixture of 0.31 g of the compound (I-a-17), 5 mL of tetrahydrofuran, 96 mg of sodium hydride (about 60% in oil), and 0.39 mL of di-tert-butyl dicarbonate was heated under reflux for 4.5 hours. The reaction mixture was cooled to room temperature. Then, 3 mL of 1 mol/L hydrochloric acid was added to the reaction mixture, followed by extraction with tert-butyl methyl ether (20 mL×2). The organic layer was washed with an aqueous saturated sodium chloride solution (10 mL×2), dried over anhydrous magnesium sulfate and then concentrated. The residue was subjected to silica gel column chromatography (ethyl acetate:hexane=1:4) to obtain 0.41 g of 5-tert-butoxycarbonyloxy-2,6-dimethyl-4-(2,4,6-triethylphenyl)-3(2H)-pyridazinone [compound (I-b-47)] as a solid.

¹H NMR (CDCl₃) δ ppm: 1.12 (6H, t, J=7.6 Hz), 1.24 (3H, t, J=7.6 Hz), 1.27 (9H, s), 2.30 (3H, s), 2.32-2.39 (4H, m), 2.63 (2H, q, J=7.6 Hz), 3.81 (3H, s), 6.96 (2H, s).

### Production Example 5

A mixture of 0.30 g of the compound (I-a-17), 5 mL of chloroform, 0.26 mL of N,N-diisopropylethylamine, 12 mg of 4-(dimethylamino)pyridine and 0.22 mL of diethyl chlorophosphate was stirred at room temperature for 4 hours. The reaction mixture was adjusted to pH 4 by an addition of hydrochloric acid, followed by extraction with chloroform (10 mL×2). The organic layer was dried over anhydrous sodium sulfate and then concentrated. The residue was subjected to silica gel column chromatography (ethyl acetate:hexane=1:2) to obtain 0.14 g of 5-(diethoxyphosphoryloxy)-2,6-dimethyl-4-(2,4,6-triethylphenyl)-3(2H)-pyridazinone [compound (I-b-48)] as a colorless oil.

¹H NMR (CDCl₃) δ ppm: 1.13 (6H, td, J=7.2 Hz, 1.2 Hz), 1.14 (6H, t, J=7.6 Hz), 1.23 (3H, t, J=7.6 Hz), 2.33-2.43 (4H, m), 2.46 (3H, s), 2.63 (2H, q, J=7.6 Hz), 3.53-3.68 (4H, m) 3.78 (3H, s), 6.99 (2H, s).

An example of production of the compound represented by the formula (II) is shown in Reference Example 1.

### Reference Example 1

To a mixture of 2.516 g of 4-chloro-5-methoxy-2-methyl-3(2H)-pyridazinone, 2.575 g of 2-ethylphenylboronic acid and 3.333 g of sodium carbonate, 30 mL of 1,4-dioxane and 20 mL of water were added. To this mixture, 2.417 g of tetrabutylammonium bromide and 0.657 g of tetrakis(triphenylphosphine)palladium were added, followed by heating under reflux under a nitrogen atmosphere for 17 hours. After the reaction mixture was cooled, 50 mL of water was added, followed by extraction sequentially with 100 mL of ethyl acetate and 30 mL of ethyl acetate. The organic layer was washed with an aqueous saturated sodium chloride solution, dried over anhydrous magnesium sulfate and then concentrated. The residue was washed with an ethyl acetate-hexane mixed solvent (1:2) to obtain 3.238 g of 4-(2-ethylphenyl)-5-methoxy-2-methyl-3(2H)-pyridazinone [compound II-1] as a yellow crystal.

The compound II-1 and other compounds represented by the general formula (II) produced in the same manner as Reference Example 1 are shown in Table 4.

The compound represented by the formula (II):

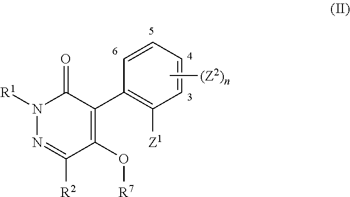

TABLE 4

| | | | | | | Melting |
|---|---|---|---|---|---|---|
| No. | R¹ | R² | Z¹ | (Z²)ₙ | R⁷ | point/° C. |
| II-1 | Me | H | Et | — | Me | 127-130 |
| II-2 | Et | H | Et | — | Me | * |
| II-3 | i-Pr | H | Et | — | Me | 121-123 |
| II-4 | MeOCH₂CH₂ | H | Et | — | Me | * |
| II-5 | Me | H | Pr | — | Me | 86-88 |
| II-6 | Me | H | Me | 6-Me | Me | 187-189 |
| II-7 | Me | H | Et | 6-Me | Me | * |
| II-8 | Me | H | Et | 6-Et | Me | 165-166 |
| II-9 | Me | H | Me | 4-Me | Me | 141-142 |
| II-10 | Me | H | Me | 4-Me, 6-Me | Me | 186-192 |
| II-11 | Et | H | Me | 4-Me, 6-Me | Me | 100-102 |
| II-12 | Me | H | Et | 4-Me, 6-Et | Me | 147-149 |

Regarding the compounds with asterisk (*) in the column of melting point in Table 4, ¹H NMR data are shown below.

### Compound II-2:

¹H NMR (CDCl₃) δ ppm: 1.12 (3H, t, J=7.7 Hz), 1.39 (3H, t, J=7.3 Hz), 2.40-2.53 (2H, m), 3.81 (3H, s), 4.19-4.30 (2H, m), 7.10 (1H, d, J=7.6 Hz), 7.21-7.26 (1H, m), 7.30-7.33 (2H, m), 7.88 (1H, s).

### Compound II-4:

¹H NMR (CDCl₃) δ ppm: 1.12 (3H, t, J=7.7 Hz), 2.38-2.52 (2H, m), 3.38 (3H, s), 3.82 (3H, s), 3.77-3.84 (2H, m), 4.40 (2H, t, J=5.6 Hz), 7.11 (1H, d, J=7.6 Hz), 7.21-7.26 (1H, m), 7.30-7.34 (2H, m), 7.90 (1H, s).

### Compound II-7:

¹H NMR (CDCl₃) δ ppm: 1.08 (3H, t, J=7.7 Hz), 2.07 (3H, s), 2.30-2.45 (2H, m), 3.81 (3H, s), 3.82 (3H, s), 7.10 (1H, d, J=7.6 Hz), 7.13 (1H, d, J=7.6 Hz), 7.24 (1H, t, J=7.6 Hz), 7.85 (1H, s).

A typical example of production of the compound represented by the formula (V-a) is shown in Reference Example 2.

### Reference Example 2

To 15.5 mL of butyl lithium (1.6 mol/L hexane solution), a solution of 4.412 g of 2-propylbromobenzene in 45 mL of tetrahydrofuran was added dropwise under a nitrogen atmosphere at −70° C. over 85 minutes. The resultant mixture was stirred at −70° C. for 30 minutes. Thereto was added dropwise 3.75 mL of trimethyl borate at −70° C. over 15 minute. This mixture was stirred at −70° C. for 1 hour and then at room temperature for 18 hours. To the reaction mixture, 33 mL of 2 mol/L hydrochloric acid was added dropwise over 10 minutes, followed by stirring at room temperature for 4 hours. To this mixture was added 20 mL of water, followed by extraction with 70 mL of ethyl acetate. The organic layer was washed with an aqueous saturated sodium chloride solution, dried over anhydrous magnesium sulfate and then concentrated. The residue was subjected to silica gel column chromatography (ethyl acetate:hexane=1:2→2:1) to obtain 1.641 g of 2-propylphenylboronic acid as a colorless crystal.

¹H NMR (CDCl₃) δ ppm: 1.01 (3H, t, J=7.4 Hz), 1.69-1.79 (2H, m), 3.15-3.20 (2H, m), 4.0-6.0 (2H, br.), 7.28-7.33 (2H, m), 7.47 (1H, dt, J=1.5, 7.6 Hz), 8.20-8.23 (1H, m).

In the same manner as Reference Example 2, the following compounds represented by the formula (V-a) were produced.

### 2-Ethyl-6-methylphenylboronic acid

Melting point: 90 to 91° C.,

¹H NMR (CDCl₃) δ ppm: 1.22 (3H, t, J=7.6 Hz), 2.35 (3H, s), 2.64 (2H, q, J=7.6 Hz), 4.0-5.5 (2H, br.), 6.98 (1H, d, J=7.7 Hz), 7.01 (1H, d, J=7.7 Hz), 7.18 (1H, t, J=7.7 Hz).

### 2,6-Diethyl-4-methylphenylboronic acid

Melting point: 111 to 113° C.,

¹H NMR (CDCl₃) δ ppm: 1.23 (6H, t, J=7.7 Hz), 2.31 (3H, s), 2.63 (4H, q, J=7.7 Hz), 4.0-5.0 (2H, br.), 6.88 (2H, s).

A typical example of production of the compound represented by the formula (VI) is shown in Reference Example 3.

### Reference Example 3

To a mixture of 2.0 g of ethyl 2-(methylhydrazono)propanoate, 35 mL of acetonitrile and 1.5 g of potassium carbonate, a solution of 2.6 g of 2,6-diethyl-4-methylphenylacetyl chloride in 10 mL of acetonitrile was added dropwise under ice cooling over about 20 minutes. This mixture was stirred at room temperature for 3.5 hours. The reaction mixture was concentrated under reduced pressure. To the residue was added 20 mL of ice water, followed by extraction with ethyl acetate (20 mL×3). The organic layer was washed with an aqueous saturated sodium chloride solution (20 mL×2), dried over anhydrous magnesium sulfate and then concentrated. The resultant residue was subjected to basic alumina column chromatography (ethyl acetate:hexane=1:3) to obtain 1.9 g of ethyl 2-[2-(2,6-diethyl-4-methylphenylacetyl)-2-methylhydrazono]propanoate [compound VI-2] as a white crystal.

The compound VI-2 and other compounds represented by the formula (VI) produced in the same manner as Reference Example 3 are shown in Table 5.

The compound represented by the formula (VI):

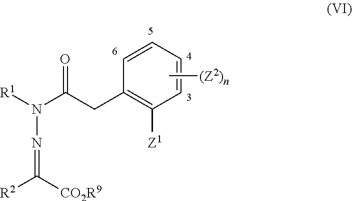

TABLE 5

| | | | | | | Melting |
|---|---|---|---|---|---|---|
| No. | R¹ | R² | Z¹ | (Z²)ₙ | R⁹ | point/° C. |
| VI-1 | Me | Me | Me | 4-Me, 6-Me | Et | 90-91 |
| VI-2 | Me | Me | Et | 4-Me, 6-Et | Et | 73-76 |
| VI-3 | Me | Me | Et | — | Et | * |
| VI-4 | Me | Me | Et | 4-Me | Et | * |
| VI-5 | Me | Me | Et | 4-Et, 6-Et | Et | 63-66 |
| VI-6 | Me | Me | Et | 4-Me, 6-Me | Et | * |
| VI-7 | Me | Et | Et | 4-Me, 6-Et | Et | * |
| VI-8 | Me | Et | Et | 4-Me | Et | * |
| VI-9 | Me | Et | Et | 4-Me, 6-Me | Et | * |
| VI-10 | Me | Et | Me | 4-Me, 6-Me | Et | * |
| VI-11 | Me | i-Pr | Et | 4-Me, 6-Et | Et | * |
| VI-12 | Me | Pr | Et | 4-Me, 6-Et | Et | * |
| VI-13 | Me | Et | Et | 4-Et, 6-Et | Et | * |
| VI-14 | Me | Pr | Et | 4-Et, 6-Et | Et | * |
| VI-15 | Me | Me | Et | 4-Et | Et | * |
| VI-16 | Me | Et | Et | 4-Et | Et | * |
| VI-17 | Me | Me | Et | 4-Et, 6-Me | Et | * |
| VI-18 | Me | Me | Et | 6-Et | Et | * |
| VI-19 | Me | Me | Me | 4-Me, 6-Me | Me | * |
| VI-20 | Me | Me | Et | 4-Et, 6-Et | Me | * |

Regarding the compounds with asterisk (*) in the column of melting point in Table 5, ¹H NMR data are shown below.

### Compound VI-3:

¹H NMR (CDCl₃) δ ppm: 1.1-9 (3H, t, J=7.6 Hz), 1.37 (3H, t, J=7.2 Hz), 2.20 (3H, br.s), 2.67 (2H, q, J=7.7 Hz), 3.37 (3H, br.s), 4.03 (2H, br.s), 4.33 (2H, q, J=7.0 Hz), 7.06-7.30 (4H, m).

### Compound VI-4:

¹H NMR (CDCl₃) δ ppm: 1.18 (3H, t, J=7.6 Hz), 1.37 (3H, t, J=7.2 Hz), 2.20 (3H, br.s), 2.30 (3H, s), 2.63 (2H, q, J=7.7 Hz), 3.36 (3H, br.s), 3.99 (2H, br.s), 4.33 (2H, q, J=7.1 Hz), 6.93 (1H, br.d, J=7.1 Hz), 7.00 (1H, br.s), 7.12 (1H, br.d, J=7.8 Hz).

### Compound VI-6:

¹H NMR (CDCl₃) δ ppm: 1.16 (3H, t, J=7.7 Hz), 1.36 (3H, t, J=7.2 Hz), 2.22 (3H, s), 2.27 (3H, s), 2.30 (3H, br.s), 2.56 (2H, q, J=7.7 Hz), 3.39 (3H, br.s), 4.02 (2H, br.s), 4.32 (2H, q, J=7.1 Hz), 6.86 (2H, br.s).

Compound VI-7(E/Z isomer mixture):

¹H NMR (CDCl₃) δ ppm: 1.13-1.25 (9H, m), 1.31-1.41 (3H, m), 2.29 (3H, s), 2.50-2.81 (6H, m), 3.23, 3.43 (3H, each br.s), 4.05 (2H, br.s), 4.27-4.39 (2H, m), 6.89 (2H, s).

Compound VI-8(E/Z isomer mixture):

¹H NMR (CDCl₃) δ ppm: 1.06-1.22 (6H, m), 1.31-1.40 (3H, m), 2.30, 2.31 (3H, each s), 2.50-2.70 (4H, m), 3.22, 3.38 (3H, each s), 4.00 (2H, br.s), 4.27-4.37 (2H, m), 6.90-6.98 (1H, m), 6.98-7.02 (1H, m), 7.02-7.14 (1H, m).

Compound VI-9(E/Z isomer mixture):

¹H NMR (CDCl₃) δ ppm: 1.12-1.25 (6H, m), 1.31-1.41 (3H, m), 2.22 (3H, s), 2.27 (3H, s), 2.50-2.81 (4H, m), 3.23, 3.43 (3H, each br.s), 4.02 (2H, br.s), 4.26-4.37 (2H, m), 6.87 (2H, br.s).

Compound VI-10(E/Z isomer mixture):

¹H NMR (CDCl₃) δ ppm: 1.16-1.24 (3H, m), 1.32-1.40 (3H, m), 2.22 (6H, s), 2.25 (3H, s), 2.55-2.80 (2H, m), 3.23, 3.43 (3H, each br.s), 4.00 (2H, br.s), 4.27-4.38 (2H, m), 6.85 (2H, s).

### Compound VI-11:

¹H NMR (CDCl₃) δ ppm: 1.18 (6H, t, J=7.6 Hz), 1.24 (6H, d, J=6.8 Hz), 1.37 (3H, t, J=7.1 Hz), 2.29 (3H, s), 2.55 (4H, q, J=7.6 Hz), 2.85 (1H, septet, J=6.8 Hz), 3.22 (3H, s), 4.04 (2H, s), 4.34 (2H, q, J=7.2 Hz), 6.88 (2H, s).

Compound VI-12(E/Z isomer mixture):

¹H NMR (CDCl₃) δ ppm: 1.01 (3H, t, J=7.4 Hz), 1.17 (6H, t, J=7.6 Hz), 1.31-1.40 (3H, m), 1.57-1.74 (2H, m), 2.30 (3H, s), 2.50-2.76 (6H, m), 3.22, 3.42 (3H, each s), 4.03, 4.05 (2H, each br.s), 4.26-4.36 (2H, m), 6.89 (2H, s)

Compound VI-13(E/Z isomer mixture):

¹H NMR (CDCl₃) δ ppm: 1.13-1.28 (12H, m), 1.30-1.40 (3H, m), 2.50-2.80 (8H, m), 3.23, 3.44 (3H, each s), 4.06 (2H, br.s), 4.28-4.39 (2H, m), 6.91 (2H, s).

Compound VI-14(E/Z isomer mixture):

¹H NMR (CDCl₃) δ ppm: 1.01 (3H, br.t, J=7.2 Hz), 1.13-1.26 (9H, m), 1.30-1.40 (3H, m), 1.56-1.73 (2H, m), 2.50-2.76 (8H, m), 3.22, 3.42 (3H, each s), 4.03, 4.06 (2H, each br.s), 4.26-4.37 (2H, m), 6.91 (2H, s).

### Compound VI-15:

¹H NMR (CDCl₃) δ ppm: 1.15-1.25 (6H, m), 1.37 (3H, t, J=7.2 Hz), 2.20 (3H, br.s), 2.55-2.70 (4H, m), 3.36 (3H, br.s), 3.99 (2H, br.s), 4.33 (2H, q, J=7.1 Hz), 6.96 (1H, br.d, J=7.3 Hz), 7.02 (1H, br.s), 7.15 (1H, br.d, J=7.8 Hz).

Compound VI-16(E/Z isomer mixture):

¹H NMR (CDCl₃) δ ppm: 1.05-1.25 (9H, m), 1.32-1.40 (3H, m), 2.50-2.69 (6H, m), 3.22, 3.38 (3H, each s), 4.00 (2H, br.s), 4.26-4.36 (2H, m), 6.93-7.00 (1H, m), 7.00-7.04 (1H, m), 7.06-7.18 (1H, m).

### Compound VI-17:

¹H NMR (CDCl₃) δ ppm: 1.17 (3H, t, J=7.6 Hz), 1.22 (3H, t, J=7.6 Hz), 1.36 (3H, t, J=7.1 Hz), 2.24 (3H, s), 2.30 (3H, br.s), 2.58 (4H, q, J=7.6 Hz), 3.40 (3H, br.s), 4.03 (2H, br.s), 4.32 (2H, q, J=7.2 Hz), 6.89 (2H, s).

### Compound VI-18:

¹H NMR (CDCl₃) δ ppm: 1.19 (6H, t, J=7.6 Hz), 1.36 (3H, t, J=7.2 Hz), 2.32 (3H, br.s), 2.60 (4H, q, J=7.7 Hz), 3.40 (3H, br.s), 4.09 (2H, br.s), 4.33 (2H, q, J=7.2 Hz), 7.07 (2H, d, J=7.6 Hz), 7.18 (1H, t, J=7.6 Hz).

### Compound VI-19:

¹H NMR (CDCl₃) δ ppm: 2.21 (6H, s), 2.25 (3H, s), 2.29 (3H, br.s), 3.39 (3H, br.s), 3.88 (3H, s), 3.99 (2H, br.s), 6.85 (2H, s).

### Compound VI-20:

¹H-NMR (CDCl₃) δ ppm: 1.18 (6H, t, J=7.6 Hz), 1.23 (3H, t, J=7.6 Hz), 2.32 (3H, br.s), 2.57 (4H, q, J=7.6 Hz), 2.60 (2H, q, J=7.6 Hz), 3.40 (3H, br.s), 3.88 (3H, s), 4.04 (2H, br.s), 6.90 (2H, s).

Formulation Examples will be shown below.

### Formulation Example 1

Suspension concentrate

| | |
|---|---|
| Compound I-a-1 | 10% by weight |
| Metsulfuron-methyl | 1% by weight |
| Fenchlorazole-ethyl | 5% by weight |
| Polyoxyethylenesorbitan monoleate | 3% by weight |
| Carboxymethyl cellulose | 3% by weight |
| Water | 78% by weight |

The above ingredients are mixed and then ground by a wet grinding method until the particle size becomes 5 micron or less to obtain a suspension concentrate.

Each of the compounds I-a-2 to I-a-30 and I-b-1 to 1-b-48 is used instead of the compound I-a-1 to obtain a suspension concentrate of each compound.

### Formulation Example 2

Wettable powder

| | |
|---|---|
| Compound I-a-12 | 20% by weight |
| Thifensulfuron-methyl | 10% by weight |
| Fenchlorazole-ethyl | 10% by weight |
| Lignin sodium sulfonate | 5% by weight |
| Polyoxyethylene alkyl ether | 5% by weight |
| White carbon | 5% by weight |
| Clay | 45% by weight |

The above ingredients are mixed and ground to obtain a wettable powder.

Each of the compounds I-a-1 to I-a-11, I-a-13 to I-a-30 and I-b-1 to I-b-48 is used instead of the compound I-a-12 to obtain a wettable powder of each compound.

### Formulation Example 3

Suspension concentrate

| | |
|---|---|
| Compound I-a-14 | 10% by weight |
| Tribenuron-methyl | 10% by weight |
| Fenchlorazole-ethyl | 5% by weight |
| Polyoxyethylenesorbitan monoleate | 3% by weight |
| Carboxymethyl cellulose | 3% by weight |
| Water | 69% by weight |

The above ingredients are mixed and ground by a wet grinding method until the particle size becomes 5 micron or less to obtain a suspension concentrate.

Each of the compounds I-a-1 to I-a-13, I-a-15 to I-a-30 and I-b-1 to I-b-48 is used instead of the compound I-a-14 to obtain a suspension concentrate of each compound.

### Formulation Example 4

Wettable powder

| | |
|---|---|
| Compound I-a-16 | 20% by weight |
| Chlorsulfuron | 10% by weight |
| Fenchlorazole-ethyl | 5% by weight |
| Lignin sodium sulfonate | 5% by weight |
| Polyoxyethylene alkyl ether | 5% by weight |
| White carbon | 5% by weight |
| Clay | 50% by weight |

The above ingredients are mixed and ground to obtain a wettable powder.

Each of the compounds I-a-1 to I-a-15, I-a-17 to I-a-30 and I-b-1 to I-b-48 is used instead of the compound I-a-16 to obtain a wettable powder of each compound.

### Formulation Example 5

Suspension concentrate

| | |
|---|---|
| Compound I-a-17 | 20% by weight |
| Florasulam | 2% by weight |
| Fenchlorazole-ethyl | 5% by weight |
| Polyoxyethylenesorbitan monoleate | 3% by weight |
| Carboxymethyl cellulose | 3% by weight |
| Water | 67% by weight |

The above ingredients are mixed and ground by a wet grinding method until the particle size becomes 5 micron or less to obtain a suspension concentrate.

Each of the compounds I-a-1 to I-a-16, I-a-18 to I-a-30 and I-b-1 to I-b-48 is used instead of the compound I-a-17 to obtain a suspension concentrate of each compound.

### Formulation Example 6

Wettable powder

| | |
|---|---|
| Compound I-a-18 | 6% by weight |
| Bromoxynil octanoate | 20% by weight |
| Fenchlorazole-ethyl | 2% by weight |
| Lignin sodium sulfonate | 5% by weight |
| Polyoxyethylene alkyl ether | 5% by weight |
| White carbon | 5% by weight |
| Clay | 57% by weight |

The above ingredients are mixed and ground to obtain a wettable powder.

Each of the compounds I-a-1 to I-a-17, I-a-19 to I-a-30 and I-b-1 to I-b-48 is used instead of the compound I-a-18 to obtain a wettable powder of each compound.

### Formulation Example 7

Suspension concentrate

| | |
|---|---|
| Compound I-a-19 | 15% by weight |
| Pyrasulfotole | 5% by weight |
| Fenchlorazole-ethyl | 4% by weight |
| Polyoxyethylenesorbitan monoleate | 3% by weight |
| Carboxymethyl cellulose | 3% by weight |
| Water | 70% by weight |

The above ingredients are mixed and ground by a wet grinding method until the particle size becomes 5 micron or less to obtain a suspension concentrate.

Each of the compounds I-a-1 to I-a-18, I-a-20 to I-a-30 and I-b-1 to I-b-48 is used instead of the compound I-a-19 to obtain a suspension concentrate of each compound.

### Formulation Example 8

Wettable powder

| | |
|---|---|
| Compound I-a-20 | 8% by weight |
| Dicamba-dimethylammonium | 20% by weight |
| Fenchlorazole-ethyl | 2% by weight |
| Lignin sodium sulfonate | 5% by weight |
| Polyoxyethylene alkyl ether | 5% by weight |
| White carbon | 5% by weight |
| Clay | 55% by weight |

The above ingredients are mixed and ground to obtain a wettable powder.

Each of the compounds I-a-1 to I-a-19, I-a-21 to I-a-30 and I-b-1 to I-b-48 is used instead of the compound I-a-20 to obtain a wettable powder of each compound.

### Formulation Example 9

Suspension concentrate

| | |
|---|---|
| Compound I-a-21 | 7% by weight |
| Fluroxypyr-meptyl | 14% by weight |
| Fenchlorazole-ethyl | 3% by weight |
| Polyoxyethylenesorbitan monoleate | 3% by weight |
| Carboxymethyl cellulose | 3% by weight |
| Water | 70% by weight |

The above ingredients are mixed and ground by a wet grinding method until the particle size becomes 5 micron or less to obtain a suspension concentrate.

Each of the compounds I-a-1 to I-a-20, I-a-22 to I-a-30 and I-b-1 to I-b-48 is used instead of the compound I-a-21 to obtain a suspension concentrate of each compound.

### Formulation Example 10

Wettable powder

| | |
|---|---|
| Compound I-a-22 | 2% by weight |
| 2,4-D dimethylammonium | 20% by weight |
| Fenchlorazole-ethyl | 2% by weight |
| Lignin sodium sulfonate | 5% by weight |
| Polyoxyethylene alkyl ether | 5% by weight |
| White carbon | 5% by weight |
| Clay | 61% by weight |

The above ingredients are mixed and ground to obtain a wettable powder.

Each of the compounds I-a-1 to I-a-21, I-a-23 to I-a-30 and I-b-1 to I-b-48 is used instead of the compound I-a-22 to obtain a wettable powder of each compound.

### Formulation Example 11

Suspension concentrate

| | |
|---|---|
| Compound I-a-25 | 7% by weight |
| Clopyralid | 7% by weight |
| Fenchlorazole-ethyl | 3% by weight |
| Polyoxyethylenesorbitan monoleate | 3% by weight |
| Carboxymethyl cellulose | 3% by weight |
| Water | 77% by weight |

The above ingredients are mixed and ground by a wet grinding method until the particle size becomes 5 micron or less to obtain a suspension concentrate.

Each of the compounds I-a-1 to I-a-24, I-a-26 to I-a-30 and I-b-1 to I-b-48 is used instead of the compound I-a-25 to obtain a suspension concentrate of each compound.

### Formulation Example 12

Wettable powder

| | |
|---|---|
| Compound I-a-27 | 15% by weight |
| Metsulfuron-methyl | 3% by weight |
| Cloquintocet-mexyl | 2% by weight |
| Lignin sodium sulfonate | 5% by weight |
| Polyoxyethylene alkyl ether | 5% by weight |
| White carbon | 5% by weight |
| Clay | 65% by weight |

The above ingredients are mixed and ground to obtain a wettable powder.

Each of the compounds I-a-1 to I-a-26, I-a-28 to I-a-30 and I-b-1 to I-b-48 is used instead of the compound I-a-27 to obtain a wettable powder of each compound.

### Formulation Example 13

Suspension concentrate

| | |
|---|---|
| Compound I-a-29 | 10% by weight |
| Thifensulfuron-methyl | 5% by weight |
| Cloquintocet-mexyl | 3% by weight |
| Polyoxyethylenesorbitan monoleate | 3% by weight |
| Carboxymethyl cellulose | 3% by weight |
| Water | 76% by weight |

The above ingredients are mixed and ground by a wet grinding method until the particle size becomes 5 micron or less to obtain a suspension concentrate.

Each of the compounds I-a-1 to I-a-28, I-a-30 and I-b-1 to I-b-48 is used instead of the compound I-a-29 to obtain a suspension concentrate of each compound.

### Formulation Example 14

Wettable powder

| | |
|---|---|
| Compound I-a-30 | 20% by weight |
| Tribenuron-methyl | 10% by weight |
| Cloquintocet-mexyl | 5% by weight |
| Lignin sodium sulfonate | 5% by weight |
| Polyoxyethylene alkyl ether | 5% by weight |
| White carbon | 5% by weight |
| Clay | 50% by weight |

The above ingredients are mixed and ground to obtain a wettable powder.

Each of the compounds I-a-1 to I-a-29 and I-b-1 to 1-b-48 is used instead of the compound I-a-30 to obtain a wettable powder of each compound.

### Formulation Example 15

Suspension concentrate

| | |
|---|---|
| Compound I-b-1 | 10% by weight |
| Chlorsulfuron | 10% by weight |
| Cloquintocet-mexyl | 3% by weight |
| Polyoxyethylenesorbitan monoleate | 3% by weight |
| Carboxymethyl cellulose | 3% by weight |
| Water | 71% by weight |

The above ingredients are mixed and ground by a wet grinding method until the particle size becomes 5 micron or less to obtain a suspension concentrate.

Each of the compounds I-a-1 to I-a-30 and I-b-2 to 1-b-48 is used instead of the compound I-b-1 to obtain a suspension concentrate of each compound.

### Formulation Example 16

Wettable powder

| | |
|---|---|
| Compound I-b-12 | 12% by weight |
| Florasulam | 6% by weight |
| Cloquintocet-mexyl | 3% by weight |
| Lignin sodium sulfonate | 5% by weight |
| Polyoxyethylene alkyl ether | 5% by weight |
| White carbon | 5% by weight |
| Clay | 64% by weight |

The above ingredients are mixed and ground to obtain a wettable powder.

Each of the compounds I-a-1 to I-a-30,1-b-1 to I-b-11 and I-b-13 to I-b-48 is used instead of the compound I-b-12 to obtain a wettable powder of each compound.

### Formulation Example 17

Suspension concentrate

| | |
|---|---|
| Compound I-b-13 | 3% by weight |
| Bromoxynil octanoate | 20% by weight |
| Cloquintocet-mexyl | 2% by weight |
| Polyoxyethylenesorbitan monoleate | 3% by weight |
| Carboxymethyl cellulose | 3% by weight |
| Water | 69% by weight |

The above ingredients are mixed and ground by a wet grinding method until the particle size becomes 5 micron or less to obtain a suspension concentrate.

Each of the compounds I-a-1 to I-a-30,1-b-1 to I-b-12 and I-b-14 to I-b-48 is used instead of the compound I-b-13 to obtain a suspension concentrate of each compound.

### Formulation Example 18

Wettable powder

| | |
|---|---|
| Compound I-b-14 | 18% by weight |
| Pyrasulfotole | 6% by weight |
| Cloquintocet-mexyl | 3% by weight |
| Lignin sodium sulfonate | 5% by weight |
| Polyoxyethylene alkyl ether | 5% by weight |
| White carbon | 5% by weight |
| Clay | 58% by weight |

The above ingredients are mixed and ground to obtain a wettable powder.

Each of the compounds I-a-1 to I-a-30,1-b-1 to I-b-13 and I-b-15 to I-b-48 is used instead of the compound I-b-14 to obtain a wettable powder of each compound.

### Formulation Example 19

Suspension concentrate

| | |
|---|---|
| Compound I-b-16 | 6% by weight |
| Dicamba-dimethylammonium | 18% by weight |
| Cloquintocet-mexyl | 4% by weight |
| Polyoxyethylenesorbitan monoleate | 3% by weight |
| Carboxymethyl cellulose | 3% by weight |
| Water | 66% by weight |

The above ingredients are mixed and ground by a wet grinding method until the particle size becomes 5 micron or less to obtain a suspension concentrate.

Each of the compounds I-a-1 to I-a-30,1-b-1 to I-b-15 and I-b-17 to I-b-48 is used instead of the compound I-b-16 to obtain a suspension concentrate of each compound.

### Formulation Example 20

Wettable powder

| | |
|---|---|
| Compound I-b-18 | 3% by weight |
| Fluroxypyr-meptyl | 12% by weight |
| Cloquintocet-mexyl | 1% by weight |
| Lignin sodium sulfonate | 5% by weight |
| Polyoxyethylene alkyl ether | 5% by weight |
| White carbon | 5% by weight |
| Clay | 69% by weight |

The above ingredients are mixed and ground to obtain a wettable powder.

Each of the compounds I-a-1 to I-a-30,1-b-1 to I-b-17 and I-b-19 to I-b-48 is used instead of the compound I-b-18 to obtain a wettable powder of each compound.

### Formulation Example 21

Suspension concentrate

| | |
|---|---|
| Compound I-b-20 | 5% by weight |
| 2,4-D-dimethylammonium | 20% by weight |
| Cloquintocet-mexyl | 2% by weight |
| Polyoxyethylenesorbitan monoleate | 3% by weight |
| Carboxymethyl cellulose | 3% by weight |
| Water | 67% by weight |

The above ingredients are mixed and ground by a wet grinding method until the particle size becomes 5 micron or less to obtain a suspension concentrate.

Each of the compounds I-a-1 to I-a-30,1-b-1 to I-b-19 and I-b-21 to I-b-48 is used instead of the compound I-b-20 to obtain a suspension concentrate of each compound.

### Formulation Example 22

Wettable powder

| | |
|---|---|
| Compound I-b-21 | 10% by weight |
| Clopyralid | 20% by weight |
| Cloquintocet-mexyl | 3% by weight |
| Lignin sodium sulfonate | 5% by weight |
| Polyoxyethylene alkyl ether | 5% by weight |
| White carbon | 5% by weight |
| Clay | 52% by weight |

The above ingredients are mixed and ground to obtain a wettable powder.

Each of the compounds I-a-1 to I-a-30,1-b-1 to I-b-20 and I-b-22 to I-b-48 is used instead of the compound I-b-21 to obtain a wettable powder of each compound.

### Formulation Example 23

Suspension concentrate

| | |
|---|---|
| Compound I-b-22 | 10% by weight |
| Metsulfuron-methyl | 7% by weight |
| Mefenpyr-diethyl | 3% by weight |
| Polyoxyethylenesorbitan monoleate | 3% by weight |
| Carboxymethyl cellulose | 3% by weight |
| Water | 74% by weight |

The above ingredients are mixed and ground by a wet grinding method until the particle size becomes 5 micron or less to obtain a suspension concentrate.

Each of the compounds I-a-1 to I-a-30,1-b-1 to I-b-21 and I-b-23 to I-b-48 is used instead of the compound I-b-22 to obtain a suspension concentrate of each compound.

### Formulation Example 24

Wettable powder

| | |
|---|---|
| Compound I-b-23 | 10% by weight |
| Thifensulfuron-methyl | 10% by weight |
| Mefenpyr-diethyl | 3% by weight |
| Lignin sodium sulfonate | 5% by weight |
| Polyoxyethylene alkyl ether | 5% by weight |
| White carbon | 5% by weight |
| Clay | 62% by weight |

The above ingredients are mixed and ground to obtain a wettable powder.

Each of the compounds I-a-1 to I-a-30,1-b-1 to I-b-22 and I-b-24 to I-b-48 is used instead of the compound I-b-23 to obtain a wettable powder of each compound.

### Formulation Example 25

Suspension concentrate

| | |
|---|---|
| Compound I-b-24 | 20% by weight |
| Tribenuron-methyl | 2% by weight |
| Mefenpyr-diethyl | 5% by weight |
| Polyoxyethylenesorbitan monoleate | 3% by weight |
| Carboxymethyl cellulose | 3% by weight |
| Water | 67% by weight |

The above ingredients are mixed and ground by a wet grinding method until the particle size becomes 5 micron or less to obtain a suspension concentrate.

Each of the compounds I-a-1 to I-a-30,1-b-1 to I-b-23 and I-b-25 to I-b-48 is used instead of the compound I-b-24 to obtain a suspension concentrate of each compound.

### Formulation Example 26

Wettable powder

| | |
|---|---|
| Compound I-b-25 | 10% by weight |
| Chlorsulfuron | 3% by weight |
| Mefenpyr-diethyl | 3% by weight |
| Lignin sodium sulfonate | 5% by weight |
| Polyoxyethylene alkyl ether | 5% by weight |
| White carbon | 5% by weight |
| Clay | 69% by weight |

The above ingredients are mixed and ground to obtain a wettable powder.

Each of the compounds I-a-1 to I-a-30,1-b-1 to I-b-24 and I-b-26 to I-b-48 is used instead of the compound I-b-25 to obtain a wettable powder of each compound.

### Formulation Example 27

Suspension concentrate

| | |
|---|---|
| Compound I-b-26 | 25% by weight |
| Florasulam | 2% by weight |
| Mefenpyr-diethyl | 4% by weight |
| Polyoxyethylenesorbitan monoleate | 3% by weight |
| Carboxymethyl cellulose | 3% by weight |
| Water | 63% by weight |

The above ingredients are mixed and ground by a wet grinding method until the particle size becomes 5 micron or less to obtain a suspension concentrate.

Each of the compounds I-a-1 to I-a-30,1-b-1 to I-b-25 and I-b-27 to I-b-48 is used instead of the compound I-b-26 to obtain a suspension concentrate of each compound.

### Formulation Example 28

Wettable powder

| | |
|---|---|
| Compound I-b-28 | 7% by weight |
| Bromoxynil octanoate | 21% by weight |
| Mefenpyr-diethyl | 2% by weight |
| Lignin sodium sulfonate | 5% by weight |
| Polyoxyethylene alkyl ether | 5% by weight |
| White carbon | 5% by weight |
| Clay | 55% by weight |

The above ingredients are mixed and ground to obtain a wettable powder.

Each of the compounds I-a-1 to I-a-30,1-b-1 to I-b-27 and I-b-29 to I-b-48 is used instead of the compound I-b-28 to obtain a wettable powder of each compound.

### Formulation Example 29

Suspension concentrate

| | |
|---|---|
| Compound I-b-35 | 12% by weight |
| Pyrasulfotole | 3% by weight |
| Mefenpyr-diethyl | 3% by weight |
| Polyoxyethylenesorbitan monoleate | 3% by weight |
| Carboxymethyl cellulose | 3% by weight |
| Water | 76% by weight |

The above ingredients are mixed and ground by a wet grinding method until the particle size becomes 5 micron or less to obtain a suspension concentrate.

Each of the compounds I-a-1 to I-a-30,1-b-1 to I-b-34 and I-b-36 to I-b-48 is used instead of the compound I-b-35 to obtain a suspension concentrate of each compound.

### Formulation Example 30

Wettable powder

| | |
|---|---|
| Compound I-b-36 | 5% by weight |
| Dicamba-dimethylammonium | 10% by weight |
| Mefenpyr-diethyl | 3% by weight |
| Lignin sodium sulfonate | 5% by weight |
| Polyoxyethylene alkyl ether | 5% by weight |
| White carbon | 5% by weight |
| Clay | 67% by weight |

The above ingredients are mixed and ground to obtain a wettable powder.

Each of the compounds I-a-1 to I-a-30 and I-b-1 to 1-b-35 and I-b-37 to I-b-48 is used instead of the compound I-b-36 to obtain a wettable powder of each compound.

### Formulation Example 31

Suspension concentrate

| | |
|---|---|
| Compound I-b-37 | 7% by weight |
| Fluroxypyr-meptyl | 20% by weight |
| Mefenpyr-diethyl | 2% by weight |
| Polyoxyethylenesorbitan monoleate | 3% by weight |
| Carboxymethyl cellulose | 3% by weight |
| Water | 65% by weight |

The above ingredients are mixed and ground by a wet grinding method until the particle size becomes 5 micron or less to obtain a suspension concentrate.

Each of the compounds I-a-1 to I-a-30,1-b-1 to I-b-36 and I-b-38 to I-b-48 is used instead of the compound I-b-37 to obtain a suspension concentrate of each compound.

### Formulation Example 32

Wettable powder

| | |
|---|---|
| Compound I-b-38 | 3% by weight |
| 2,4-D-dimethylammonium | 15% by weight |
| Mefenpyr-diethyl | 2% by weight |
| Lignin sodium sulfonate | 5% by weight |
| Polyoxyethylene alkyl ether | 5% by weight |
| White carbon | 5% by weight |
| Clay | 65% by weight |

The above ingredients are mixed and ground to obtain a wettable powder.

Each of the compounds I-a-1 to I-a-30,1-b-1 to I-b-37, 1-b-39 and I-b-48 is used instead of the compound I-b-38 to obtain a wettable powder of each compound.

### Formulation Example 33

Suspension concentrate

| | |
|---|---|
| Compound I-b-39 | 5% by weight |
| Clopyralid | 10% by weight |
| Mefenpyr-diethyl | 3% by weight |
| Polyoxyethylenesorbitan monoleate | 3% by weight |
| Carboxymethyl cellulose | 3% by weight |
| Water | 76% by weight |

The above ingredients are mixed and ground by a wet grinding method until the particle size becomes 5 micron or less to obtain a suspension concentrate.

Each of the compounds I-a-1 to I-a-30,1-b-1 to I-b-38 and I-b-48 is used instead of the compound I-b-39 to obtain a suspension concentrate of each compound.

### Formulation Example 34

To a mixture of 4 parts of sodium lauryl sulfate, 2 parts of lignin calcium sulfonate, 20 parts of a synthetic hydrous silicon oxide fine powder and 61 parts of diatomaceous earth are added 5 parts of the compound I-b-1, 1 part of metsulfuron-methyl, 2 parts of fenchlorazole-ethyl and 5 parts of any one compound selected from Group C as shown below, stirred well and further mixed to obtain a wettable powder.

Each of the compounds I-a-1 to I-a-30 and I-b-2 to 1-b-48 is used instead of the compound I-b-1 to obtain a wettable powder of each compound.

### Group C:

Group consisting of MCP, MCPB, phenothiol, triclopyr, clomeprop, naproanilide, 2,3,6-TBA, picloram, aminopyralid, quinclorac, quinmerac, diuron, linuron, chlortoluron, isoproturon, fluometuron, isouron, tebuthiuron, methabenzthiazuron, cumyluron, daimuron, methyl-daimuron, atrazine, ametoryn, cyanazine, simazine, propazine, simetryn, dimethametryn, prometryn, metribuzin, triaziflam, indaziflam, paraquat, diquat, ioxynil, pendimethalin, prodiamine, trifluralin, amiprofos-methyl, butamifos, bensulide, piperophos, anilofos, glyphosate, glufosinate, glufosinate-P, bialaphos, di-allate, tri-allate, EPTC, butylate, benthiocarb, esprocarb, molinate, dimepiperate, swep, chlorpropham, phenmedipham, phenisopham, pyributicarb, asulam, propanil, propyzamide, bromobutide, etobenzanid, acetochlor, alachlor, butachlor, dimethenamid, propachlor, metazachlor, metolachlor, pretilachlor, thenylchlor, pethoxamid, acifluorfen-sodium, bifenox, oxyfluorfen, lactofen, fomesafen, chlomethoxynil, aclonifen, oxadiazon, cinidon-ethyl, carfentrazone-ethyl, surfentrazone, flumiclorac-pentyl, flumioxazin, pyraflufen-ethyl, oxadiargyl, pentoxazone, fluthiacet-methyl, butafenacil, benzfendizone, bencarbazone, saflufenacil, benzo[enap, pyrazolate, pyrazoxyfen, topramezone, isoxaflutole, benzobicyclon, sulcotrione, mesotrione, tembotrione, tefuryltrione, bicyclopyrone, clodinafop-propargyl, cyhalofop-butyl, diclofop-methyl, fenoxaprop-ethyl, fluazifop-butyl, haloxyfop-methyl, quizalofop-ethyl, metamifop, alloxydim-sodium, sethoxydim, butroxydim, clethodim, cloproxydim, cycloxydim, tepraloxydim, tralkoxydim, profoxydim, sulfometuron-methyl, chlorimuron-ethyl, triasulfuron, bensulfuron-methyl, pyrazosulfuron-ethyl, primisulfuron-methyl, nicosulfuron, amidosulfuron, cinosulfuron, imazosulfuron, rimsulfuron, halosulfuron-methyl, prosulfuron, ethametsulfuron-methyl, triflusulfuron-methyl, flazasulfuron, cyclosulfamuron, flupyrsulfuron, sulfosulfuron, azimsulfuron, ethoxysulfuron, oxasulfuron, iodosulfuron-methyl-sodium, foramsulfuron, mesosulfuron-methyl, trifloxysulfuron, tritosulfuron, orthosulfamuron,flucetosulfuron, propyrisulfuron, metazosulfuron, imazamethabenz-methyl, imazamethapyr, imazamox, imazapyr, imazaquin, imazethapyr, flumetsulam, metosulam, diclosulam, cloransulam-methyl, penoxsulam, pyroxsulam, pyrithiobac-sodium, bispyribac-sodium, pyriminobac-methyl, pyribenzoxim, pyriftalid, pyrimisulfan, bentazon, bromacil, terbacil, chlorthiamid, isoxaben, dinoseb, amitrole, cinmethylin, tridiphane, dalapon, diflufenzopyr-sodium, dithiopyr, thiazopyr, flucarbazone-sodium, propoxycarbazone-sodium, mefenacet, flufenacet, fentrazamide, cafénstrole, indanofan, oxaziclomefone, benfuresate, ACN, pyridate, chloridazon, norflurazon, flurtamone, diflufenican, picolinafen, beflubutamid, clomazone, amicarbazone, pinoxaden, pyraclonil, pyroxasulfone, thiencarbazone-methyl, aminocyclopyrachlor, ipfencarbazone, methiozolin, fenoxasulfone, furilazole, dichlormid, benoxacor, allidochlor, isoxadifen-ethyl, fenclorim, cyprosulfamide, cyometrinil, oxabetrinil, fluxofenim, flurazole, 2-dichloromethyl-2-methyl-1,3-dioxolane, and 1,8-naphthalic anhydride.

### Formulation Example 35

A mixture of 25 parts of the compound I-b-12, 5 parts of thifensulfuron-methyl, 2 parts of fenchlorazole-ethyl, 5 parts of any one compound selected from Group C, 3 parts of polyoxyethylenesorbitan monoleate, 3 parts of carboxymethyl cellulose, and 77 parts of water is ground by a wet grinding method until the particle size becomes 5 micron or less to obtain a suspension concentrate.

Each of the compounds I-a-1 to I-a-30,1-b-1 to I-b-11 and I-b-13 to I-b-48 is used instead of the compound I-b-12 to obtain a suspension concentrate of each compound.

### Formulation Example 36

To a mixture of 4 parts of sodium lauryl sulfate, 2 parts of lignin calcium sulfonate, 20 parts of a synthetic hydrous silicon oxide fine powder and 53 parts of diatomaceous earth are added 10 parts of the compound I-b-13, 5 parts of tribenuron-methyl, 3 parts of fenchlorazole-ethyl and 3 parts of any one compound selected from Group C, followed by well stirring to obtain a wettable powder.

Each of the compounds I-a-1 to I-a-30,1-b-1 to I-b-12 and I-b-14 to I-b-48 is used instead of the compound I-b-13 to obtain a wettable powder of each compound.

### Formulation Example 37

A mixture of 10 parts of the compound I-b-14, 5 parts of chlorsulfuron, 3 parts of fenchlorazole-ethyl, 5 parts of any one compound selected from Group C, 3 parts of polyoxyethylenesorbitan monoleate, 3 parts of carboxymethyl cellulose, and 71 parts of water is ground by a wet grinding method until the particle size becomes 5 micron or less to obtain a suspension concentrate.

Each of the compounds I-a-1 to I-a-30,1-b-1 to I-b-13 and I-b-15 to I-b-48 is used instead of the compound I-b-14 to obtain a suspension concentrate of each compound.

### Formulation Example 38

To a mixture of 4 parts of sodium lauryl sulfate, 2 parts of lignin calcium sulfonate, 20 parts of a synthetic hydrous silicon oxide fine powder and 61 parts of diatomaceous earth are added 6 parts of the compound I-b-16, 2 parts of florasulam, 2 parts of fenchlorazole-ethyl and 3 parts of any one compound selected from Group C, followed by well stirring to obtain a wettable powder.

Each of the compounds I-a-1 to I-a-30,1-b-1 to I-b-15 and I-b-17 to I-b-48 is used instead of the compound I-b-16 to obtain a wettable powder of each compound.

### Formulation Example 39

A mixture of 3 parts of the compound I-b-18, 15 parts of bromoxynil octanoate, 2 parts of fenchlorazole-ethyl, 5 parts of any one compound selected from Group C, 3 parts of polyoxyethylenesorbitan monoleate, 3 parts of carboxymethyl cellulose, and 69 parts of water is ground by a wet grinding method until the particle size becomes 5 micron or less to obtain a suspension concentrate.

Each of the compounds I-a-1 to I-a-30,1-b-1 to I-b-17 and I-b-19 to I-b-48 is used instead of the compound I-b-18 to obtain a suspension concentrate of each compound.

### Formulation Example 40

To a mixture of 4 parts of sodium lauryl sulfate, 2 parts of lignin calcium sulfonate, 20 parts of a synthetic hydrous silicon oxide fine powder and 58 parts of diatomaceous earth are added 6 parts of the compound I-b-20, 3 parts of pyrasulfotole, 2 parts of fenchlorazole-ethyl and 5 parts of any one compound selected from Group C, followed by well stirring to obtain a wettable powder.

Each of the compounds I-a-1 to I-a-30,1-b-1 to I-b-19 and I-b-21 to I-b-48 is used instead of the compound I-b-20 to obtain a wettable powder of each compound.

### Formulation Example 41

A mixture of 5 parts of the compound I-b-21, 10 parts of dicamba-dimethylammonium, 2 parts of fenchlorazole-ethyl, 5 parts of any one compound selected from Group C, 3 parts of polyoxyethylenesorbitan monoleate, 3 parts of carboxymethyl cellulose, and 72 parts of water is ground by a wet grinding method until the particle size becomes 5 micron or less to obtain a suspension concentrate.

Each of the compounds I-a-1 to I-a-30,1-b-1 to I-b-20 and I-b-22 to I-b-48 is used instead of the compound I-b-21 to obtain a suspension concentrate of each compound.

### Formulation Example 42

To a mixture of 4 parts of sodium lauryl sulfate, 2 parts of lignin calcium sulfonate, 20 parts of a synthetic hydrous silicon oxide fine powder and 52 parts of diatomaceous earth are added 5 parts of the compound I-b-22, parts of fluoroxypyr-meptyl, 2 parts of fenchlorazole-ethyl and 5 parts of any one compound selected from Group C, followed by well stirring to obtain a wettable powder.

Each of the compounds I-a-1 to I-a-30,1-b-1 to I-b-21 and I-b-22 to I-b-48 is used instead of the compound I-b-22 to obtain a wettable powder of each compound.

### Formulation Example 43

A mixture of 5 parts of the compound I-b-23, 15 parts of 2,4-D-dimethylammonium, 2 parts of fenchlorazole-ethyl, 5 parts of any one compound selected from Group C, 3 parts of polyoxyethylenesorbitan monoleate, 3 parts of carboxymethyl cellulose, and 67 parts of water is ground by a wet grinding method until the particle size becomes 5 micron or less to obtain a suspension concentrate.

Each of the compounds I-a-1 to I-a-30,1-b-1 to I-b-22 and I-b-24 to I-b-48 is used instead of the compound I-b-23 to obtain a suspension concentrate of each compound.

### Formulation Example 44

To a mixture of 4 parts of sodium lauryl sulfate, 2 parts of lignin calcium sulfonate, 20 parts of a synthetic hydrous silicon oxide fine powder and 57 parts of diatomaceous earth are added 5 parts of the compound I-b-24, 5 parts of clopyralid, 2 parts of fenchlorazole-ethyl and 5 parts of any one compound selected from Group C, followed by well stirring to obtain a wettable powder.

Each of the compounds I-a-1 to I-a-30,1-b-1 to I-b-23 and I-b-25 to I-b-48 is used instead of the compound I-b-24 to obtain a wettable powder of each compound.

### Formulation Example 45

A mixture of 10 parts of the compound I-b-25, 3 parts of metsulfuron-methyl, 2 parts of cloquintocet-mexyl, 5 parts of any one compound selected from Group C, 3 parts of polyoxyethylenesorbitan monoleate, 3 parts of carboxymethyl cellulose, and 74 parts of water is ground by a wet grinding method until the particle size becomes 5 micron or less to obtain a suspension concentrate.

Each of the compounds I-a-1 to I-a-30,1-b-1 to I-b-24 and I-b-26 to I-b-48 is used instead of the compound I-b-25 to obtain a suspension concentrate of each compound.

### Formulation Example 46

To a mixture of 4 parts of sodium lauryl sulfate, 2 parts of lignin calcium sulfonate, 20 parts of a synthetic hydrous silicon oxide fine powder and 54 parts of diatomaceous earth are added 8 parts of the compound I-b-26, 5 parts of thifensulfuron-methyl, 2 parts of cloquintocet-mexyl and 5 parts of any one compound selected from Group C, followed by well stirring to obtain a wettable powder.

Each of the compounds I-a-1 to I-a-30,1-b-1 to I-b-25 and I-b-27 to I-b-48 is used instead of the compound I-b-26 to obtain a wettable powder of each compound.

### Formulation Example 47

A mixture of 12 parts of the compound I-b-28, 4 parts of tribenuron-methyl, 3 parts of cloquintocet-mexyl, 5 parts of any one compound selected from Group C, 3 parts of polyoxyethylenesorbitan monoleate, 3 parts of carboxymethyl cellulose, and 70 parts of water is ground by a wet grinding method until the particle size becomes 5 micron or less to obtain a suspension concentrate.

Each of the compounds I-a-1 to I-a-30,1-b-1 to I-b-27 and I-b-29 to I-b-48 is used instead of the compound I-b-28 to obtain a suspension concentrate of each compound.

### Formulation Example 48

To a mixture of 4 parts of sodium lauryl sulfate, 2 parts of lignin calcium sulfonate, 20 parts of a synthetic hydrous silicon oxide fine powder and 40 parts of diatomaceous earth are added 20 parts of the compound I-b-35, 5 parts of chlorsulfuron, 4 parts of cloquintocet-mexyl and 5 parts of any one compound selected from Group C, followed by well stirring to obtain a wettable powder.

Each of the compounds I-a-1 to I-a-30,1-b-1 to I-b-34 and I-b-36 to I-b-48 is used instead of the compound I-b-35 to obtain a wettable powder of each compound.

### Formulation Example 49

A mixture of 12 parts of the compound I-b-36, 3 parts of florasulam, 3 parts of cloquintocet-mexyl, 10 parts of any one compound selected from Group C, 3 parts of polyoxyethylenesorbitan monoleate, 3 parts of carboxymethyl cellulose, and 66 parts of water is ground by a wet grinding method until the particle size becomes 5 micron or less to obtain a suspension concentrate.

Each of the compounds I-a-1 to I-a-30,1-b-1 to I-b-35 and I-b-37 to I-b-48 is used instead of the compound I-b-36 to obtain a suspension concentrate of each compound.

### Formulation Example 50

To a mixture of 4 parts of sodium lauryl sulfate, 2 parts of lignin calcium sulfonate, 20 parts of a synthetic hydrous silicon oxide fine powder and 52 parts of diatomaceous earth are added 5 parts of the compound I-b-37, parts of bromoxynil octanoate, 2 parts of cloquintocet-mexyl and 5 parts of any one compound selected from Group C, followed by well stirring to obtain a wettable powder.

Each of the compounds I-a-1 to I-a-30,1-b-1 to I-b-36 and I-b-38 to I-b-48 is used instead of the compound I-b-37 to obtain a wettable powder of each compound.

### Formulation Example 51

A mixture of 10 parts of the compound I-b-38, 4 parts of pyrasulfotole, 4 parts of cloquintocet-mexyl, 10 parts of any one compound selected from Group C, 3 parts of polyoxyethylenesorbitan monoleate, 3 parts of carboxymethyl cellulose, and 66 parts of water is ground by a wet grinding method until the particle size becomes 5 micron or less to obtain a suspension concentrate.

Each of the compounds I-a-1 to I-a-30,1-b-1 to I-b-37 and I-b-39 to I-b-48 is used instead of the compound I-b-38 to obtain a suspension concentrate of each compound.

### Formulation Example 52

To a mixture of 4 parts of sodium lauryl sulfate, 2 parts of lignin calcium sulfonate, 20 parts of a synthetic hydrous silicon oxide fine powder and 57 parts of diatomaceous earth are added 5 parts of the compound I-b-39, 5 parts of dicamba-dimethylammonium, 2 parts of cloquintocet-mexyl and 5 parts of any one compound selected from Group C, followed by well stirring to obtain a wettable powder.

Each of the compounds I-a-1 to I-a-30,1-b-1 to I-b-38 and I-b-40 to I-b-48 is used instead of the compound I-b-39 to obtain a wettable powder of each compound.

### Formulation Example 53

A mixture of 3 parts of the compound I-a-1, 10 parts of fluoroxypyr-meptyl, 3 parts of cloquintocet-mexyl, 5 parts of any one compound selected from Group C, 3 parts of polyoxyethylenesorbitan monoleate, 3 parts of carboxymethyl cellulose, and 73 parts of water is ground by a wet grinding method until the particle size becomes 5 micron or less to obtain a suspension concentrate.

Each of the compounds I-a-2 to I-a-30 and I-b-1 to 1-b-48 is used instead of the compound I-a-1 to obtain a suspension concentrate of each compound.

### Formulation Example 54

To a mixture of 4 parts of sodium lauryl sulfate, 2 parts of lignin calcium sulfonate, 20 parts of a synthetic hydrous silicon oxide fine powder and 49 parts of diatomaceous earth are added 5 parts of the compound I-a-12, parts of 2,4-D-dimethylammonium, 5 parts of cloquintocet-mexyl and 5 parts of any one compound selected from Group C, followed by well stirring to obtain a wettable powder.

Each of the compounds I-a-1 to I-a-11, I-a-13 to I-a-30, and I-b-1 to I-b-48 is used instead of the compound 1-a-12 to obtain a wettable powder of each compound.

### Formulation Example 55

A mixture of 5 parts of the compound I-a-14, 20 parts of clopyralid, 2 parts of cloquintocet-mexyl, 5 parts of any one compound selected from Group C, 3 parts of polyoxyethylenesorbitan monoleate, 3 parts of carboxymethyl cellulose, and 62 parts of water is ground by a wet grinding method until the particle size becomes 5 micron or less to obtain a suspension concentrate.

Each of the compounds I-a-1 to I-a-13, I-a-15 to I-a-30, and I-b-1 to I-b-48 is used instead of the compound 1-a-14 to obtain a suspension concentrate of each compound.

### Formulation Example 56

To a mixture of 4 parts of sodium lauryl sulfate, 2 parts of lignin calcium sulfonate, 20 parts of a synthetic hydrous silicon oxide fine powder and 50 parts of diatomaceous earth are added 10 parts of the compound I-a-16, 2 parts of metsulfuron-methyl, 2 parts of mefenpyr-diethyl and 10 parts of any one compound selected from Group C, followed by well stirring to obtain a wettable powder.

Each of the compounds I-a-1 to I-a-15, I-a-17 to I-a-30, and I-b-1 to I-b-48 is used instead of the compound 1-a-16 to obtain a wettable powder of each compound.

### Formulation Example 57

A mixture of 10 parts of the compound I-a-17, 8 parts of thifensulfuron-methyl, 2 parts of mefenpyr-diethyl, 10 parts of any one compound selected from Group C, 3 parts of polyoxyethylenesorbitan monoleate, 3 parts of carboxymethyl cellulose, and 64 parts of water is ground by a wet grinding method until the particle size becomes 5 micron or less to obtain a suspension concentrate.

Each of the compounds I-a-1 to I-a-16, I-a-18 to I-a-30, and I-b-1 to I-b-48 is used instead of the compound 1-a-17 to obtain a suspension concentrate of each compound.

### Formulation Example 58

To a mixture of 4 parts of sodium lauryl sulfate, 2 parts of lignin calcium sulfonate, 20 parts of a synthetic hydrous silicon oxide fine powder and 49 parts of diatomaceous earth are added 10 parts of the compound I-a-18, 7 parts of tribenuron-methyl, 3 parts of mefenpyr-diethyl and 5 parts of any one compound selected from Group C, followed by well stirring to obtain a wettable powder.

Each of the compounds I-a-1 to I-a-17, I-a-19 to I-a-30, and I-b-1 to I-b-48 is used instead of the compound 1-a-18 to obtain a wettable powder of each compound.

### Formulation Example 59

A mixture of 12 parts of the compound I-a-19, 4 parts of chlorsulfuron, 3 parts of mefenpyr-diethyl, 3 parts of any one compound selected from Group C, 3 parts of polyoxyethylenesorbitan monoleate, 3 parts of carboxymethyl cellulose, and 72 parts of water is ground by a wet grinding method until the particle size becomes 5 micron or less to obtain a suspension concentrate.

Each of the compounds I-a-1 to I-a-18, I-a-20 to I-a-30, and I-b-1 to I-b-48 is used instead of the compound 1-a-19 to obtain a suspension concentrate of each compound.

### Formulation Example 60

To a mixture of 4 parts of sodium lauryl sulfate, 2 parts of lignin calcium sulfonate, 20 parts of a synthetic hydrous silicon oxide fine powder and 43 parts of diatomaceous earth are added 20 parts of the compound I-a-20, 2 parts of florasulam, 4 parts of mefenpyr-diethyl and 5 parts of any one compound selected from Group C, followed by well stirring to obtain a wettable powder.

Each of the compounds I-a-1 to I-a-19, I-a-21 to I-a-30, and I-b-1 to I-b-48 is used instead of the compound 1-a-20 to obtain a wettable powder of each compound.

### Formulation Example 61

A mixture of 6 parts of the compound I-a-21, 15 parts of bromoxynil octanoate, 2 parts of mefenpyr-diethyl, 5 parts of any one compound selected from Group C, 3 parts of polyoxyethylenesorbitan monoleate, 3 parts of carboxymethyl cellulose, and 66 parts of water is ground by a wet grinding method until the particle size becomes 5 micron or less to obtain a suspension concentrate.

Each of the compounds I-a-1 to I-a-20, I-a-22 to I-a-30, and I-b-1 to I-b-48 is used instead of the compound 1-a-21 to obtain a suspension concentrate of each compound.

### Formulation Example 62

To a mixture of 4 parts of sodium lauryl sulfate, 2 parts of lignin calcium sulfonate, 20 parts of a synthetic hydrous silicon oxide fine powder and 53 parts of diatomaceous earth are added 10 parts of the compound I-a-22, 4 parts of pyrasulfotole, 2 parts of mefenpyr-diethyl and 5 parts of any one compound selected from Group C, followed by well stirring to obtain a wettable powder.

Each of the compounds I-a-1 to I-a-21, I-a-23 to I-a-30, and I-b-1 to I-b-48 is used instead of the compound 1-a-22 to obtain a wettable powder of each compound.

### Formulation Example 63

A mixture of 5 parts of the compound I-a-25, 15 parts of dicamba-dimethylammonium, 3 parts of mefenpyr-diethyl, 5 parts of any one compound selected from Group C, 3 parts of polyoxyethylenesorbitan monoleate, 3 parts of carboxymethyl cellulose, and 66 parts of water is ground by a wet grinding method until the particle size becomes 5 micron or less to obtain a suspension concentrate.

Each of the compounds I-a-1 to I-a-24, I-a-26 to I-a-30, and I-b-1 to I-b-48 is used instead of the compound 1-a-25 to obtain a suspension concentrate of each compound.

### Formulation Example 64

To a mixture of 4 parts of sodium lauryl sulfate, 2 parts of lignin calcium sulfonate, 20 parts of a synthetic hydrous silicon oxide fine powder and 54 parts of diatomaceous earth are added 3 parts of the compound I-a-27, parts of fluoroxypyr-meptyl, 2 parts of mefenpyr-diethyl and 5 parts of any one compound selected from Group C, followed by well stirring to obtain a wettable powder.

Each of the compounds I-a-1 to I-a-26, I-a-28 to I-a-30, and I-b-1 to I-b-48 is used instead of the compound 1-a-27 to obtain a wettable powder of each compound.

### Formulation Example 65

A mixture of 2 parts of the compound I-a-29, 20 parts of 2,4-D-dimethylammonium, 2 parts of mefenpyr-diethyl, 5 parts of any one compound selected from Group C, 3 parts of polyoxyethylenesorbitan monoleate, 3 parts of carboxymethyl cellulose, and 65 parts of water is ground by a wet grinding method until the particle size becomes 5 micron or less to obtain a suspension concentrate.

Each of the compounds I-a-1 to I-a-28, I-a-30, and 1-b-1 to I-b-48 is used instead of the compound I-a-29 to obtain a suspension concentrate of each compound.

### Formulation Example 66

To a mixture of 4 parts of sodium lauryl sulfate, 2 parts of lignin calcium sulfonate, 20 parts of a synthetic hydrous silicon oxide fine powder and 43 parts of diatomaceous earth are added 8 parts of the compound I-a-30, parts of clopyralid, 3 parts of mefenpyr-diethyl and 5 parts of any one compound selected from Group C, followed by well stirring to obtain a wettable powder.

Each of the compounds I-a-1 to I-a-29 and I-b-1 to 1-b-48 is used instead of the compound I-a-30 to obtain a wettable powder of each compound.

Test Examples will be shown below.

### Test Example 1

A plastic cup with a diameter of 8 cm and a depth of 6.5 cm was filled with soil. Seeds of wheat (Triticum aestivum) and one or more kinds of test plant selected from Alopecurus myosuroides, Lolium multiflorum, Setaria viridis, Sinapis arvensis and Stellaria media were sowed in the cup, and then grown in a greenhouse until Triticum aestivum was grown in the second to third leaf stage. Then, a test dilution containing predetermined amounts of the present compound, a compound selected from Group A and a compound selected from Group B was sprayed onto the whole plants uniformly. The test dilution was prepared by dissolving a predetermined amount of each compound in a 2% solution of Tween 20 (polyoxyethylene sorbitan fatty acid ester, MP Biomedicals, Inc.) in dimethylformamide and then diluting the solution with water, and then mixing the respective water dilutions thus obtained of the present compound, a compound selected from Group A and a compound selected from Group B. After the spray treatment, the plants were grown in a greenhouse for 21 days. The herbicidal effect was rated in 101 levels from 0 (no effect) to 100 (complete death).

The results are shown in Table 6 to Table 57.

TABLE 6

| | Amount of | | | |
|---|---|---|---|---|
| | chemical | Triticum | Lolium | Sinapis |
| | (g/ha) | aestivum | multiflorum | arvensis |
| I-a-17 | 5 | 5 | 10 | 30 |
| Pyrasulfotole | 20 | 15 | 0 | 70 |
| Fenchlorazole- | 5 | 0 | 0 | 0 |
| ethyl | | | | |
| I-a-17 + | 5 + 20 + 5 | 0 | 80 | 100 |
| pyrasulfotole + | | | | |
| fenchlorazole- | | | | |
| ethyl | | | | |

TABLE 7

| | Amount of | | | |
|---|---|---|---|---|
| | chemical | Triticum | Lolium | Sinapis |
| | (g/ha) | aestivum | multiflorum | arvensis |
| I-a-17 + | 5 + 20 | 25 | 30 | 100 |
| pyrasulfotole | | | | |
| Fenchlorazole- | 5 | 0 | 0 | 0 |
| ethyl | | | | |
| I-a-17 + | 5 + 20 + 5 | 0 | 80 | 100 |
| pyrasulfotole + | | | | |
| fenchlorazole- | | | | |
| ethyl | | | | |

TABLE 8

| | Amount | | | |
|---|---|---|---|---|
| | of | | | |
| | chemical | Triticum | Lolium | Sinapis |
| | (g/ha) | aestivum | multiflorum | arvensis |
| I-a-17 + | 5 + 5 | 0 | 10 | 30 |
| fenchlorazole- | | | | |
| ethyl | | | | |
| Pyrasulfotole | 20 | 15 | 0 | 70 |
| I-a-17 + | 5 + 20 + 5 | 0 | 80 | 100 |
| pyrasulfotole + | | | | |
| fenchlorazole- | | | | |
| ethyl | | | | |

TABLE 9

| | Amount | | | |
|---|---|---|---|---|
| | of | | | |
| | chemical | Triticum | Lolium | Sinapis |
| | (g/ha) | aestivum | multiflorum | arvensis |
| Pyrasulfotole + | 20 + 5 | 0 | 0 | 65 |
| fenchlorazole- | | | | |
| ethyl | | | | |
| I-a-17 | 5 | 5 | 10 | 30 |
| I-a-17 + | 5 + 20 + 5 | 0 | 80 | 100 |
| pyrasulfotole + | | | | |
| fenchlorazole- | | | | |
| ethyl | | | | |

TABLE 10

| | Amount of | | | |
|---|---|---|---|---|
| | chemical | Triticum | Lolium | Sinapis |
| | (g/ha) | aestivum | multiflorum | arvensis |
| I-a-14 | 25 | 10 | 90 | 60 |
| Metsulfuron-methyl | 0.1 | 0 | 0 | 70 |
| Cloquintocet-mexyl | 6.3 | 0 | 0 | 0 |
| I-a-14 + | 25 + 0.1 + 6.3 | 0 | 98 | 100 |
| metsulfuron- | | | | |
| methyl + | | | | |
| cloquintocet- | | | | |
| mexyl | | | | |

TABLE 11

| | Amount of | | | |
|---|---|---|---|---|
| | chemical | Triticum | Lolium | Sinapis |
| | (g/ha) | aestivum | multiflorum | arvensis |
| I-a-14 + | 25 + 0.1 | 10 | 90 | 98 |
| metsulfuron- | | | | |
| methyl | | | | |
| Cloquintocet- | 6.3 | 0 | 0 | 0 |
| mexyl | | | | |
| I-a-14 + | 25 + 0.1 + 6.3 | 0 | 98 | 100 |
| metsulfuron- | | | | |
| methyl + | | | | |
| cloquintocet- | | | | |
| mexyl | | | | |

TABLE 12

| | Amount of | | | |
|---|---|---|---|---|
| | chemical | Triticum | Lolium | Sinapis |
| | (g/ha) | aestivum | multiflorum | arvensis |
| I-a-14 + | 25 + 6.3 | 0 | 95 | 60 |
| cloquintocet- | | | | |
| mexyl | | | | |
| Metsulfuron- | 0.1 | 0 | 0 | 70 |
| methyl | | | | |
| I-a-14 + | 25 + 0.1 + 6.3 | 0 | 98 | 100 |
| metsulfuron- | | | | |
| methyl + | | | | |
| cloquintocet- | | | | |
| mexyl | | | | |

TABLE 13

| | Amount of | | | |
|---|---|---|---|---|
| | chemical | Triticum | Lolium | Sinapis |
| | (g/ha) | aestivum | multiflorum | arvensis |
| Metsulfuron- | 0.1 + 6.3 | 0 | 0 | 80 |
| methyl + | | | | |
| cloquintocet- | | | | |
| mexyl | | | | |
| I-a-14 | 25 | 10 | 90 | 60 |
| I-a-14 + | 25 + 0.1 + 6.3 | 0 | 98 | 100 |
| metsulfuron- | | | | |
| methyl + | | | | |
| cloquintocet- | | | | |
| mexyl | | | | |

TABLE 14

| | Amount of | | | |
|---|---|---|---|---|
| | chemical | Triticum | Alopecurus | Stellaria |
| | (g/ha) | aestivum | myosuroides | media |
| I-a-14 | 25 | 10 | 90 | 50 |
| Fluroxypyr | 25 | 0 | 0 | 40 |
| Cloquintocet- | 6.3 | 0 | 0 | 0 |
| mexyl | | | | |
| I-a-14 + | 25 + 25 + 6.3 | 0 | 100 | 90 |
| fluroxypyr + | | | | |
| cloquintocet- | | | | |
| mexyl | | | | |

TABLE 15

| | Amount of | | | |
|---|---|---|---|---|
| | chemical | Triticum | Alopecurus | Stellaria |
| | (g/ha) | aestivum | myosuroides | media |
| I-a-14 + | 25 + 25 | 5 | 95 | 85 |
| fluroxypyr | | | | |
| Cloquintocet- | 6.3 | 0 | 0 | 0 |
| mexyl | | | | |
| I-a-14 + | 25 + 25 + 6.3 | 0 | 100 | 90 |
| fluroxypyr + | | | | |
| cloquintocet- | | | | |
| mexyl | | | | |

TABLE 16

| | Amount of | | | |
|---|---|---|---|---|
| | chemical | Triticum | Alopecurus | Stellaria |
| | (g/ha) | aestivum | myosuroides | media |
| I-a-14 + | 25 + 6.3 | 0 | 98 | 50 |
| cloquintocet- | | | | |
| mexyl | | | | |
| Fluroxypyr | 25 | 0 | 0 | 40 |
| I-a-14 + | 25 + 25 + 6.3 | 0 | 100 | 90 |
| fluroxypyr + | | | | |
| cloquintocet- | | | | |
| mexyl | | | | |

TABLE 17

| | Amount of | | | |
|---|---|---|---|---|
| | chemical | Triticum | Alopecurus | Stellaria |
| | (g/ha) | aestivum | myosuroides | media |
| Fluroxypyr + | 25 + 6.3 | 0 | 0 | 30 |
| cloquintocet- | | | | |
| mexyl | | | | |
| I-a-14 | 25 | 10 | 90 | 50 |
| I-a-14 + | 25 + 25 + 6.3 | 0 | 100 | 90 |
| fluroxypyr + | | | | |
| cloquintocet- | | | | |
| mexyl | | | | |

TABLE 18

| | Amount of | | | |
|---|---|---|---|---|
| | chemical | Triticum | Lolium | Stellaria |
| | (g/ha) | aestivum | multiflorum | media |
| I-a-14 | 25 | 10 | 90 | 50 |
| Bromoxynil | 20 | 0 | 0 | 0 |
| Mefenpyr-diethyl | 6.3 | 0 | 0 | 0 |
| I-a-14 + | 25 + 20 + 6.3 | 0 | 95 | 99 |
| bromoxynil + | | | | |
| mefenpyr-diethyl | | | | |

TABLE 19

| | Amount of | | | |
|---|---|---|---|---|
| | chemical | Triticum | Lolium | Stellaria |
| | (g/ha) | aestivum | multiflorum | media |
| I-a-14 + | 25 + 20 | 10 | 95 | 98 |
| bromoxynil | | | | |
| Mefenpyr-diethyl | 6.3 | 0 | 0 | 0 |
| I-a-14 + | 25 + 20 + 6.3 | 0 | 95 | 99 |
| bromoxynil + | | | | |
| mefenpyr- | | | | |
| diethyl | | | | |

TABLE 20

| | Amount of | | | |
|---|---|---|---|---|
| | chemical | Triticum | Lolium | Stellaria |
| | (g/ha) | aestivum | multiflorum | media |
| I-a-14 + | 25 + 6.3 | 0 | 90 | 50 |
| mefenpyr-diethyl | | | | |
| Bromoxynil | 20 | 0 | 0 | 0 |
| I-a-14 + | 25 + 20 + 6.3 | 0 | 95 | 99 |
| bromoxynil + | | | | |
| mefenpyr-diethyl | | | | |

TABLE 21

| | Amount of | | | |
|---|---|---|---|---|
| | chemical | Triticum | Lolium | Stellaria |
| | (g/ha) | aestivum | multiflorum | media |
| Bromoxynil + | 20 + 6.3 | 0 | 0 | 10 |
| mefenpyr-diethyl | | | | |
| I-a-14 | 25 | 10 | 90 | 50 |
| I-a-14 + | 25 + 20 + 6.3 | 0 | 95 | 99 |
| bromoxynil + | | | | |
| mefenpyr-diethyl | | | | |

TABLE 22

| | Amount of | | | |
|---|---|---|---|---|
| | chemical | Triticum | Lolium | Stellaria |
| | (g/ha) | aestivum | multiflorum | media |
| I-a-14 | 25 | 10 | 90 | 50 |
| Bromoxynil | 200 | 5 | 0 | 10 |
| Mefenpyr-diethyl | 6.3 | 0 | 0 | 0 |
| I-a-14 + | 25 + 200 + 6.3 | 0 | 95 | 100 |
| bromoxynil + | | | | |
| mefenpyr-diethyl | | | | |

TABLE 23

| | Amount of | | | |
|---|---|---|---|---|
| | chemical | Triticum | Lolium | Stellaria |
| | (g/ha) | aestivum | multiflorum | media |
| I-a-14 + | 25 + 200 | 15 | 80 | 100 |
| bromoxynil | | | | |
| Mefenpyr-diethyl | 6.3 | 0 | 0 | 0 |
| I-a-14 + | 25 + 200 + 6.3 | 0 | 95 | 100 |
| bromoxynil + | | | | |
| mefenpyr-diethyl | | | | |

TABLE 24

| | Amount of | | | |
|---|---|---|---|---|
| | chemical | Triticum | Lolium | Stellaria |
| | (g/ha) | aestivum | multiflorum | media |
| I-a-14 + | 25 + 6.3 | 0 | 90 | 50 |
| mefenpyr-diethyl | | | | |
| Bromoxynil | 200 | 5 | 0 | 10 |
| I-a-14 + | 25 + 200 + 6.3 | 0 | 95 | 100 |
| bromoxynil + | | | | |
| mefenpyr-diethyl | | | | |

TABLE 25

| | Amount of | | | |
|---|---|---|---|---|
| | chemical | Triticum | Lolium | Stellaria |
| | (g/ha) | aestivum | multiflorum | media |
| Bromoxynil + | 200 + 6.3 | 0 | 0 | 20 |
| mefenpyr- | | | | |
| diethyl | | | | |
| I-a-14 | 25 | 10 | 90 | 50 |
| I-a-14 + | 25 + 200 + 6.3 | 0 | 95 | 100 |
| bromoxynil + | | | | |
| mefenpyr- | | | | |
| diethyl | | | | |

TABLE 26

| | Amount of | | | |
|---|---|---|---|---|
| | chemical | Triticum | Lolium | Stellaria |
| | (g/ha) | aestivum | multiflorum | media |
| I-a-18 | 6.3 | 5 | 60 | 5 |
| Tribenuron- | 0.25 | 0 | 0 | 90 |
| methyl | | | | |
| Mefenpyr- | 3.1 | 0 | 0 | 0 |
| diethyl | | | | |
| I-a-18 + | 6.3 + 0.25 + 3.1 | 0 | 80 | 100 |
| tribenuron- | | | | |
| methyl + | | | | |
| mefenpyr- | | | | |
| diethyl | | | | |

TABLE 27

| | Amount of | | | |
|---|---|---|---|---|
| | chemical | Triticum | Lolium | Stellaria |
| | (g/ha) | aestivum | multiflorum | media |
| I-a-18 + | 6.3 + 0.25 | 5 | 80 | 100 |
| tribenuron- | | | | |
| methyl | | | | |
| Mefenpyr- | 3.1 | 0 | 0 | 0 |
| diethyl | | | | |
| I-a-18 + | 6.3 + 0.25 + 3.1 | 0 | 80 | 100 |
| tribenuron- | | | | |
| methyl + | | | | |
| mefenpyr- | | | | |
| diethyl | | | | |

TABLE 28

| | Amount of | | | |
|---|---|---|---|---|
| | chemical | Triticum | Lolium | Stellaria |
| | (g/ha) | aestivum | multiflorum | media |
| I-a-18 + | 6.3 + 3.1 | 0 | 60 | 10 |
| mefenpyr- | | | | |
| diethyl | | | | |
| Tribenuron- | 0.25 | 0 | 0 | 80 |
| methyl | | | | |
| I-a-18 + | 6.3 + 0.25 + 3.1 | 0 | 80 | 100 |
| tribenuron- | | | | |
| methyl + | | | | |
| mefenpyr- | | | | |
| diethyl | | | | |

TABLE 29

| | Amount of | | | |
|---|---|---|---|---|
| | chemical | Triticum | Lolium | Stellaria |
| | (g/ha) | aestivum | multiflorum | media |
| Tribenuron- | 0.25 + 3.1 | 0 | 0 | 85 |
| methyl + | | | | |
| mefenpyr- | | | | |
| diethyl | | | | |
| I-a-18 | 6.3 | 5 | 60 | 5 |
| I-a-18 + | 6.3 + 0.25 + 3.1 | 0 | 80 | 100 |
| tribenuron- | | | | |
| methyl + | | | | |
| mefenpyr- | | | | |
| diethyl | | | | |

TABLE 30

| | Amount of | | |
|---|---|---|---|
| | chemical | Triticum | Lolium |
| | (g/ha) | aestivum | multiflorum |
| I-b-14 | 6.3 | 5 | 70 |
| Florasulam | 0.2 | 0 | 0 |
| Mefenpyr-diethyl | 6.3 | 0 | 0 |
| I-b-14 + | 6.3 + 0.2 + 6.3 | 0 | 90 |
| florasulam + | | | |
| mefenpyr-diethyl | | | |

TABLE 31

| | Amount of | | |
|---|---|---|---|
| | chemical | Triticum | Lolium |
| | (g/ha) | aestivum | multiflorum |
| I-b-14 + | 6.3 + 0.2 | 5 | 80 |
| florasulam | | | |
| Mefenpyr-diethyl | 6.3 | 0 | 0 |
| I-b-14 + | 6.3 + 0.2 + 6.3 | 0 | 90 |
| florasulam + | | | |
| mefenpyr-diethyl | | | |

TABLE 32

| | Amount of | | |
|---|---|---|---|
| | chemical | Triticum | Lolium |
| | (g/ha) | aestivum | multiflorum |
| I-b-14 + | 6.3 + 6.3 | 0 | 70 |
| mefenpyr-diethyl | | | |
| Florasulam | 0.2 | 0 | 0 |
| I-b-14 + | 6.3 + 0.2 + 6.3 | 0 | 90 |
| florasulam + | | | |
| mefenpyr-diethyl | | | |

TABLE 33

| | Amount of | | |
|---|---|---|---|
| | chemical | Triticum | Lolium |
| | (g/ha) | aestivum | multiflorum |
| Florasulam + | 0.2 + 6.3 | 0 | 0 |
| mefenpyr-diethyl | | | |
| I-b-14 | 6.3 | 5 | 70 |
| I-b-14 + | 6.3 + 0.2 + 6.3 | 0 | 90 |
| florasulam + | | | |
| mefenpyr-diethyl | | | |

TABLE 34

| | Amount of | | |
|---|---|---|---|
| | chemical | Triticum | Lolium |
| | (g/ha) | aestivum | multiflorum |
| I-b-18 | 25 | 10 | 30 |
| Florasulam | 0.1 | 0 | 0 |
| Fenchlorazole-ethyl | 6.3 | 0 | 0 |
| I-b-18 + | 25 + 0.1 + 6.3 | 0 | 70 |
| florasulam + | | | |
| fenchlorazole-ethyl | | | |

TABLE 35

| | Amount of | | |
|---|---|---|---|
| | chemical | Triticum | Lolium |
| | (g/ha) | aestivum | multiflorum |
| I-b-18 + | 25 + 0.1 | 10 | 60 |
| florasulam | | | |
| Fenchlorazole-ethyl | 6.3 | 0 | 0 |
| I-b-18 + | 25 + 0.1 + 6.3 | 0 | 70 |
| florasulam + | | | |
| fenchlorazole-ethyl | | | |

TABLE 36

| | Amount of | | |
|---|---|---|---|
| | chemical | Triticum | Lolium |
| | (g/ha) | aestivum | multiflorum |
| I-b-18 + | 25 + 6.3 | 0 | 20 |
| fenchlorazole-ethyl | | | |
| Florasulam | 0.1 | 0 | 0 |
| I-b-18 + | 25 + 0.1 + 6.3 | 0 | 70 |
| florasulam + | | | |
| fenchlorazole-ethyl | | | |

TABLE 37

| | Amount of | | |
|---|---|---|---|
| | chemical | Triticum | Lolium |
| | (g/ha) | aestivum | multiflorum |
| Florasulam + | 0.1 + 6.3 | 0 | 0 |
| fenchlorazole-ethyl | | | |
| I-b-18 | 25 | 10 | 30 |
| I-b-18 + | 25 + 0.1 + 6.3 | 0 | 70 |
| florasulam + | | | |
| fenchlorazole-ethyl | | | |

TABLE 38

| | Amount of | | |
|---|---|---|---|
| | chemical | Triticum | |
| | (g/ha) | aestivum | Stellaria media |
| I-b-18 | 25 | 10 | 5 |
| Thifensulfuron- | 1 | 0 | 50 |
| methyl | | | |
| Mefenpyr-diethyl | 6.3 | 0 | 0 |
| I-b-18 + | 25 + 1 + 6.3 | 0 | 100 |
| thifensulfuron- | | | |
| methyl + | | | |
| mefenpyr-diethyl | | | |

TABLE 39

| | Amount of | | |
|---|---|---|---|
| | chemical | Triticum | |
| | (g/ha) | aestivum | Stellaria media |
| I-b-18 + | 25 + 1 | 15 | 95 |
| thifensulfuron- | | | |
| methyl | | | |
| Mefenpyr-diethyl | 6.3 | 0 | 0 |
| I-b-18 + | 25 + 1 + 6.3 | 0 | 100 |
| thifensulfuron- | | | |
| methyl + | | | |
| mefenpyr-diethyl | | | |

TABLE 40

| | Amount of | | |
|---|---|---|---|
| | chemical | Triticum | |
| | (g/ha) | aestivum | Stellaria media |
| I-b-18 + | 25 + 6.3 | 0 | 5 |
| mefenpyr-diethyl | | | |
| Thifensulfuron- | 1 | 0 | 50 |
| methyl | | | |
| I-b-18 + | 25 + 1 + 6.3 | 0 | 100 |
| thifensulfuron- | | | |
| methyl + | | | |
| mefenpyr-diethyl | | | |

TABLE 41

| | Amount of | | |
|---|---|---|---|
| | chemical | Triticum | |
| | (g/ha) | aestivum | Stellaria media |
| Thifensulfuron- | 1 + 6.3 | 0 | 70 |
| methyl + | | | |
| mefenpyr-diethyl | | | |
| I-b-18 | 25 | 10 | 5 |
| I-b-18 + | 25 + 1 + 6.3 | 0 | 100 |
| thifensulfuron- | | | |
| methyl + | | | |
| mefenpyr-diethyl | | | |

TABLE 42

| | Amount of | | |
|---|---|---|---|
| | chemical | Triticum | Lolium |
| | (g/ha) | aestivum | multiflorum |
| I-b-18 | 25 | 10 | 30 |
| Dicamba | 50 | 0 | 0 |
| Mefenpyr-diethyl | 6.3 | 0 | 0 |
| I-b-18 + | 25 + 50 + 6.3 | 0 | 80 |
| dicamba + | | | |
| mefenpyr-diethyl | | | |

TABLE 43

| | Amount of | | |
|---|---|---|---|
| | chemical | Triticum | Lolium |
| | (g/ha) | aestivum | multiflorum |
| I-b-18 + | 25 + 50 | 15 | 75 |
| dicamba | | | |
| Mefenpyr-diethyl | 6.3 | 0 | 0 |
| I-b-18 + | 25 + 50 + 6.3 | 0 | 80 |
| dicamba + | | | |
| mefenpyr-diethyl | | | |

TABLE 44

| | Amount of | | |
|---|---|---|---|
| | chemical | Triticum | Lolium |
| | (g/ha) | aestivum | multiflorum |
| I-b-18 + | 25 + 6.3 | 0 | 50 |
| mefenpyr-diethyl | | | |
| Dicamba | 50 | 0 | 0 |
| I-b-18 + | 25 + 50 + 6.3 | 0 | 80 |
| dicamba + | | | |
| mefenpyr-diethyl | | | |

TABLE 45

| | Amount of | | |
|---|---|---|---|
| | chemical | Triticum | Lolium |
| | (g/ha) | aestivum | multiflorum |
| Dicamba + | 50 + 6.3 | 0 | 0 |
| mefenpyr-diethyl | | | |
| I-b-18 | 25 | 10 | 30 |
| I-b-18 + | 25 + 50 + 6.3 | 0 | 80 |
| dicamba + | | | |
| mefenpyr-diethyl | | | |

TABLE 46

| | Amount of | | | |
|---|---|---|---|---|
| | chemical | Triticum | Setaria | Sinapis |
| | (g/ha) | aestivum | viridis | arvensis |
| I-b-25 | 25 | 5 | 95 | 20 |
| 2,4-D | 25 | 0 | 0 | 80 |
| Fenchlorazole- | 6.3 | 0 | 0 | 0 |
| ethyl | | | | |
| I-b-25 + | 25 + 25 + 6.3 | 0 | 100 | 100 |
| 2,4-D + | | | | |
| fenchlorazole- | | | | |
| ethyl | | | | |

TABLE 47

| | Amount of | | | |
|---|---|---|---|---|
| | chemical | Triticum | Setaria | Sinapis |
| | (g/ha) | aestivum | viridis | arvensis |
| I-b-25 + | 25 + 25 | 5 | 100 | 99 |
| 2,4-D | | | | |
| Fenchlorazole- | 6.3 | 0 | 0 | 0 |
| ethyl | | | | |
| I-b-25 + | 25 + 25 + 6.3 | 0 | 100 | 100 |
| 2,4-D + | | | | |
| fenchlorazole- | | | | |
| ethyl | | | | |

TABLE 48

| | Amount of | | | |
|---|---|---|---|---|
| | chemical | Triticum | Setaria | Sinapis |
| | (g/ha) | aestivum | viridis | arvensis |
| I-b-25 + | 25 + 6.3 | 0 | 95 | 20 |
| fenchlorazole- | | | | |
| ethyl | | | | |
| 2,4-D | 25 | 0 | 0 | 80 |
| I-b-25 + | 25 + 25 + 6.3 | 0 | 100 | 100 |
| 2,4-D + | | | | |
| fenchlorazole- | | | | |
| ethyl | | | | |

TABLE 49

| | Amount of | | | |
|---|---|---|---|---|
| | chemical | Triticum | Setaria | Sinapis |
| | (g/ha) | aestivum | viridis | arvensis |
| 2,4-D + | 25 + 6.3 | 0 | 0 | 70 |
| fenchlorazole- | | | | |
| ethyl | | | | |
| I-b-25 | 25 | 5 | 95 | 20 |
| I-b-25 + | 25 + 25 + 6.3 | 0 | 100 | 100 |
| 2,4-D + | | | | |
| fenchlorazole- | | | | |
| ethyl | | | | |

TABLE 50

| | Amount of | | |
|---|---|---|---|
| | chemical | Triticum | Alopecurus |
| | (g/ha) | aestivum | myosuroides |
| I-b-35 | 25 | 10 | 50 |
| Clopyralid | 100 | 0 | 0 |
| Cloquintocet-mexyl | 6.3 | 0 | 0 |
| I-b-35 + | 25 + 100 + 6.3 | 0 | 98 |
| clopyralid + | | | |
| cloquintocet-mexyl | | | |

TABLE 51

| | Amount of | | |
|---|---|---|---|
| | chemical | Triticum | Alopecurus |
| | (g/ha) | aestivum | myosuroides |
| I-b-35 + | 25 + 100 | 10 | 90 |
| clopyralid | | | |
| Cloquintocet-mexyl | 6.3 | 0 | 0 |
| I-b-35 + | 25 + 100 + 6.3 | 0 | 98 |
| clopyralid + | | | |
| cloquintocet-mexyl | | | |

TABLE 52

| | Amount of | | |
|---|---|---|---|
| | chemical | Triticum | Alopecurus |
| | (g/ha) | aestivum | myosuroides |
| I-b-35 + | 25 + 6.3 | 0 | 80 |
| cloquintocet-mexyl | | | |
| Clopyralid | 100 | 0 | 0 |
| I-b-35 + | 25 + 100 + 6.3 | 0 | 98 |
| clopyralid + | | | |
| cloquintocet-mexyl | | | |

TABLE 53

| | Amount of | | |
|---|---|---|---|
| | chemical | Triticum | Alopecurus |
| | (g/ha) | aestivum | myosuroides |
| Clopyralid + | 100 + 6.3 | 0 | 0 |
| cloquintocet-mexyl | | | |
| I-b-35 | 25 | 10 | 50 |
| I-b-35 + | 25 + 100 + 6.3 | 0 | 98 |
| clopyralid + | | | |
| cloquintocet-mexyl | | | |

TABLE 54

| | Amount of | | |
|---|---|---|---|
| | chemical | Triticum | Alopecurus |
| | (g/ha) | aestivum | myosuroides |
| I-b-36 | 25 | 10 | 50 |
| Chlorsulfuron | 1 | 0 | 0 |
| Cloquintocet-mexyl | 6.3 | 0 | 0 |
| I-b-36 + | 25 + 1 + 6.3 | 0 | 90 |
| chlorsulfuron + | | | |
| cloquintocet-mexyl | | | |

TABLE 55

| | Amount of | | |
|---|---|---|---|
| | chemical | Triticum | Alopecurus |
| | (g/ha) | aestivum | myosuroides |
| I-b-36 + | 25 + 1 | 10 | 90 |
| chlorsulfuron | | | |
| cloquintocet-mexyl | 6.3 | 0 | 0 |
| I-b-36 + | 25 + 1 + 6.3 | 0 | 90 |
| chlorsulfuron + | | | |
| cloquintocet-mexyl | | | |

TABLE 56

| | Amount of | | |
|---|---|---|---|
| | chemical | Triticum | Alopecurus |
| | (g/ha) | aestivum | myosuroides |
| I-b-36 + | 25 + 6.3 | 0 | 60 |
| cloquintocet-mexyl | | | |
| Chlorsulfuron | 1 | 0 | 0 |
| I-b-36 + | 25 + 1 + 6.3 | 0 | 90 |
| chlorsulfuron + | | | |
| cloquintocet-mexyl | | | |

TABLE 57

| | Amount of | | |
|---|---|---|---|
| | chemical | Triticum | Alopecurus |
| | (g/ha) | aestivum | myosuroides |
| Chlorsulfuron + | 1 + 6.3 | 0 | 0 |
| cloquintocet-mexyl | | | |
| I-b-36 | 25 | 10 | 50 |
| I-b-36 + | 25 + 1 + 6.3 | 0 | 90 |
| chlorsulfuron + | | | |
| cloquintocet-mexyl | | | |

### INDUSTRIAL APPLICABILITY

The herbicidal composition of the present invention is useful for control of weeds.

1. A herbicidal composition containing a pyridazinone compound represented by the formula (I), at least one compound selected from Group A and at least one compound selected from group B. 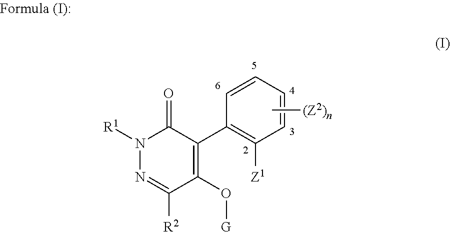
wherein R¹ represents a C₁₋₆ alkyl group or a (C₁₋₆ alkyloxy)C₁₋₆ alkyl group,
R² represents hydrogen or a C₁₋₆ alkyl group,
G represents hydrogen, a group represented by the formula: 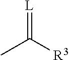
a group represented by the formula: 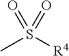
or a group represented by the formula: 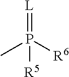
[wherein L represents oxygen or sulfur,
R³ represents a C₁₋₆ alkyl group, a C₃₋₈ cycloalkyl group, a C₂₋₆ alkenyl group, a C₂₋₆ alkynyl group, a C₆₋₁₀ aryl group, a (C₆₋₁₀ aryl)C₁₋₆ alkyl group, a C₁₋₆ alkyloxy group, a C₃₋₈ cycloalkyloxy group, a C₂₋₆ alkenyloxy group, a C₂₋₆ alkynyloxy group, a C₆₋₁₀ aryloxy group, a (C₆₋₁₀ aryl)C₁₋₆ alkyloxy group, an amino group, a C₁₋₆ alkylamino group, a C₂₋₆ alkenylamino group, a C₆₋₁₀ arylamino group, a di(C₁₋₆ alkyl)amino group, a di(C₂₋₆ alkenyl)amino group, a (C₁₋₆ alkyl) (C₆₋₁₀ aryl)amino group, or a 3- to 8-membered nitrogen-containing heterocyclic group,
R⁴ represents a C₁₋₆ alkyl group, a C₆₋₁₀aryl group, a C₁₋₆ alkylamino group or a di(C₁₋₆ alkyl)amino group, and
R⁵ and R⁶ may be the same or different, and represent a C₁₋₆ alkyl group, a C₃₋₈ cycloalkyl group, a C₂₋₆ alkenyl group, a C₆₋₁₀ aryl group, a C₁₋₆ alkyloxy group, a C₃₋₈ cycloalkyloxy group, a C₆₋₁₀ aryloxy group, a (C₆₋₁₀ aryl)C₁₋₆ alkyloxy group, a C₁₋₆ alkylthio group, a C₁₋₆ alkylamino group or a di(C₁₋₆ alkyl)amino group,
wherein, each group represented by R³, R⁴, R⁵ and R⁶ is optionally halogenated, and the C₃₋₈ cycloalkyl group, the C₆₋₁₀ aryl group, the aryl moiety of the (C₆₋₁₀ aryl)C₁₋₆ alkyl group, the C₃₋₈ cycloalkyloxy group, the C₆₋₁₀ aryloxy group, the aryl moiety of the (C₆₋₁₀ aryl)C₁₋₆ alkyloxy group, the aryl moiety of the C₆₋₁₀ arylamino group, the aryl moiety of the (C₁₋₆ alkyl)(C₆₋₁₀ aryl)amino group, and the 3- to 8-membered nitrogen-containing heterocyclic group are optionally C₁₋₆ alkylated],
Z¹ represents a C₁₋₆ alkyl group,
Z² represents a C₁₋₆ alkyl group, and
n represents 0, 1, 2, 3 or 4, and when n represents an integer of 2 or more, each Z² may be the same or different, provided that the total number of carbon atoms in the groups represented by Z¹ and (Z²)n is two or more.
Group A: a group consisting of metsulfuron-methyl, thifensulfuron-methyl, tribenuron-methyl, chlorsulfuron, florasulam, bromoxynil or an agriculturally acceptable ester or salt thereof, pyrasulfotole, dicamba or an agriculturally acceptable ester or salt thereof, fluoroxypyr or an agriculturally acceptable ester thereof, 2,4-D or an agriculturally acceptable ester or salt thereof, and clopyralid or an agriculturally acceptable salt thereof.
Group B: a group consisting of: fenchlorazole-ethyl, cloquintocet-mexyl, and mefenpyr-diethyl.

2. The herbicidal composition according to claim 1, wherein the pyridazinone compound represented by the formula (I) is the compound in which n is an integer of 1 or more.

3. The herbicidal composition according to claim 1, wherein the pyridazinone compound represented by the formula (I) is the compound in which n is 0 and Z¹ is a C₂₋₆ alkyl group.

4. The herbicidal composition according to claim 1, wherein the pyridazinone compound represented by the formula (I) is the compound in which n is 1 or 2 and Z² is attached to the 4- and/or 6-position of the benzene ring.

5. The herbicidal composition according to claim 1, wherein the pyridazinone compound represented by the formula (I) is the compound in which Z¹ is a C₁₋₃ alkyl group and Z² is a C₁₋₃ alkyl group.

6. The herbicidal composition according to claim 1, wherein the pyridazinone compound represented by the formula (I) is the compound in which G is hydrogen, a group represented by the formula: 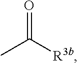
a group represented by the formula: 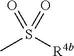
or a group represented by the formula: 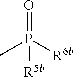
[wherein R^{3b} represents a C₁₋₆ alkyl group, a C₃₋₈ cycloalkyl group, a C₂₋₆ alkenyl group, a C₂₋₆ alkynyl group, a C₆₋₁₀ aryl group, a (C₆₋₁₀ aryl)C₁₋₆ alkyl group, a C₁₋₆ alkyloxy group, a C₃₋₈ cycloalkyloxy group, a C₂₋₆ alkenyloxy group, a C₆₋₁₀ aryloxy group, a (C₆₋₁₀ aryl)C₁₋₆ alkyloxy group, a C₁₋₆ alkylamino group, a C₆₋₁₀ arylamino group or a di(C₁₋₆ alkyl)amino group,
R^{4b} represents a C₁₋₆ alkyl group or a C₆₋₁₀ aryl group, and
R^{5b} and R^{6b} may be the same or different, and represent a C₁₋₆ alkyl group, a C₁₋₆ alkyloxy group, a C₆₋₁₀ aryloxy group or a C₁₋₆ alkylthio group,
wherein, each group represented by R^{3b}, R^{4b}, R^{5b} and R^{6b} is optionally halogenated, and the C₂₋₈ cycloalkyl group, the C₆₋₁₀ aryl group, the aryl moiety of the (C₆₋₁₀ aryl)C₁₋₆ alkyl group, the C₃₋₈ cycloalkyloxy group, the C₆₋₁₀ aryloxy group, the aryl moiety of the (C₆₋₁₀ aryl)C₁₋₆ alkyloxy group, and the aryl moiety of the C₆₋₁₀ arylamino group are optionally C₁₋₆ alkylated].

7. The herbicidal composition according to claim 1, wherein the pyridazinone compound represented by the formula (I) is the compound in which G is hydrogen, a group represented by the formula: 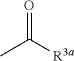
or a group represented by the formula: 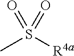
[wherein R^{3a} represents a C₁₋₆ alkyl group, a C₃₋₈ cycloalkyl group, a C₆₋₁₀ aryl group, a C₁₋₆ alkyloxy group, a C₂₋₆ alkenyloxy group or a di(C₁₋₆ alkyl)amino group, and R^{4a} represents a C₁₋₆ alkyl group,
wherein, each group represented by R^{3a} and R^{4a} is optionally halogenated, and the C₃₋₈ cycloalkyl group and the C₆₋₁₀ aryl group are optionally C₁₋₆ alkylated].

8. The herbicidal composition according to claim 1, wherein the pyridazinone compound represented by the formula (I) is the compound in which R² is hydrogen or a C₁₋₃ alkyl group.

9. The herbicidal composition according to claim 1, wherein the pyridazinone compound represented by the formula (I) is the compound in which R² is hydrogen or a methyl group.

10. The herbicidal composition according to claim 1, which contains the pyridazinone compound represented by the formula (I) in which R¹ is a C₁₋₃ alkyl group or a (C₁₋₃ alkyloxy)C₁₋₃ alkyl group.

11. A method of controlling weeds, which comprises the step of applying effective amounts of a pyridazinone compound represented by the formula (I), at least one compound selected from Group A and at least one compound selected from group B to weeds or soil where weeds grow. 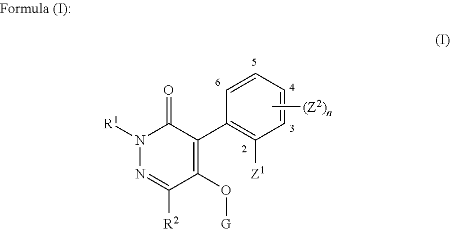
wherein R¹ represents a C₁₋₆ alkyl group or a (C₁₋₆ alkyloxy)C₁₋₆ alkyl group,
R² represents hydrogen or a C₁₋₆ alkyl group,
G represents hydrogen, a group represented by the formula: 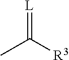
a group represented by the formula: 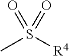
or a group represented by the formula: 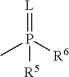
[wherein L represents oxygen or sulfur,
R³ represents a C₁₋₆ alkyl group, a C₃₋₈ cycloalkyl group, a C₂₋₆ alkenyl group, a C₂₋₆ alkynyl group, a C₆₋₁₀ aryl group, a (C₆₋₁₀ aryl)C₁₋₆ alkyl group, a C₁₋₆ alkyloxy group, a C₃₋₈ cycloalkyloxy group, a C₂₋₆ alkenyloxy group, a C₂₋₆ alkynyloxy group, a C₆₋₁₀ aryloxy group, a (C₆₋₁₀ aryl)C₁₋₆ alkyloxy group, an amino group, a C₁₋₆ alkylamino group, a C₂₋₆ alkenylamino group, a C₆₋₁₀ arylamino group, a di(C₁₋₆ alkyl)amino group, a di(C₂₋₆ alkenyl)amino group, a (C₁₋₆ alkyl)(C₆₋₁₀ aryl)amino group, or a 3- to 8-membered nitrogen-containing heterocyclic group,
R⁴ represents a C₁₋₆ alkyl group, a C₆₋₁₀aryl group, a C₁₋₆ alkylamino group or a di(C₁₋₆ alkyl)amino group, and
R⁵ and R⁶ may be the same or different, and represent a C₁₋₆ alkyl group, a C₃₋₈ cycloalkyl group, a C₂₋₆ alkenyl group, a C₆₋₁₀ aryl group, a C₁₋₆ alkyloxy group, a C₃₋₈ cycloalkyloxy group, a C₆₋₁₀ aryloxy group, a (C₆₋₁₀ aryl)C₁₋₆ alkyloxy group, a C₁₋₆ alkylthio group, a C₁₋₆ alkylamino group or a di(C₁₋₆ alkyl)amino group,
wherein, each group represented by R³, R⁴, R⁵ and R⁶ is optionally halogenated, and the C₃₋₈ cycloalkyl group, the C₆₋₁₀ aryl group, the aryl moiety of the (C₆₋₁₀ aryl)C₁₋₆ alkyl group, the C₃₋₈ cycloalkyloxy group, the C₆₋₁₀ aryloxy group, the aryl moiety of the (C₆₋₁₀ aryl)C₁₋₆ alkyloxy group, the aryl moiety of the C₆₋₁₀ arylamino group, the aryl moiety of the (C₁₋₆ alkyl)(C₆₋₁₀ aryl)amino group, and the 3- to 8-membered nitrogen-containing heterocyclic group are optionally C₁₋₆ alkylated],
Z¹ represents a C₁₋₆ alkyl group,
Z² represents a C₁₋₆ alkyl group, and
n represents 0, 1, 2, 3 or 4, and when n represents an integer of 2 or more, each Z² may be the same or diffrent, provided that the total number of carbon atoms in the groups represented by Z¹ and (Z²)n is two or more.
Group A: a group consisting of metsulfuron-methyl, thifensulfuron-methyl, tribenuron-methyl, chlorsulfuron, florasulam, bromoxynil or an agriculturally acceptable ester or salt thereof, pyrasulfotole, dicamba or an agriculturally acceptable ester or salt thereof, fluoroxypyr or an agriculturally acceptable ester thereof, 2,4-D or an agriculturally acceptable ester or salt thereof, and clopyralid or an agriculturally acceptable salt thereof.
Group B: a group consisting of fenchlorazole-ethyl, cloquintocet-mexyl, and mefenpyr-diethyl.

12. Use of a composition containing a compound represented by the formula (I), at least one compound selected from Group A and at least one compound selected from group B for weed control. 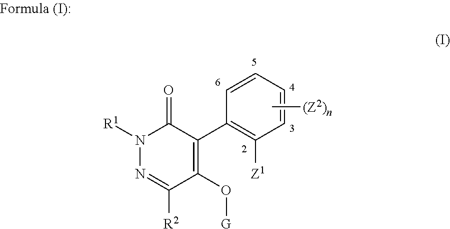
wherein R¹ represents a C₁₋₆ alkyl group or a (C₁₋₆ alkyloxy)C₁₋₆ alkyl group,
R² represents hydrogen or a C₁₋₆ alkyl group,
G represents hydrogen, a group represented by the formula: 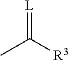
a group represented by the formula: 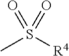
or a group represented by the formula: 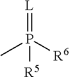
[wherein L represents oxygen or sulfur,
R³ represents a C₁₋₆ alkyl group, a C₃₋₈ cycloalkyl group, a C₂₋₆ alkenyl group, a C₂₋₆ alkynyl group, a C₆₋₁₀ aryl group, a (C₆₋₁₀ aryl)C₁₋₆ alkyl group, a C₁₋₆ alkyloxy group, a C₃₋₈ cycloalkyloxy group, a C₂₋₆ alkenyloxy group, a C₂₋₆ alkynyloxy group, a C₆₋₁₀ aryloxy group, a (C₆₋₁₀ aryl)C₁₋₆ alkyloxy group, an amino group, a C₁₋₆ alkylamino group, a C₂₋₆ alkenylamino group, a C₆₋₁₀ arylamino group, a di(C₁₋₆ alkyl)amino group, a di(C₂₋₆ alkenyl)amino group, a (C₁₋₆ alkyl)(C₆₋₁₀ aryl)amino group, or a 3- to 8-membered nitrogen-containing heterocyclic group,
R⁴ represents a C₁₋₆ alkyl group, a C₆₋₁₀aryl group, a C₁₋₆ alkylamino group or a di(C₁₋₆ alkyl)amino group, and
R⁵ and R⁶ may be the same or different, and represent a C₁₋₆ alkyl group, a C₂₋₈ cycloalkyl group, a C₂₋₆ alkenyl group, a C₆₋₁₀ aryl group, a C₁₋₆ alkyloxy group, a C₃₋₈ cycloalkyloxy group, a C₆₋₁₀ aryloxy group, a (C₆₋₁₀ aryl)C₁₋₆ alkyloxy group, a C₁₋₆ alkylthio group, a C₁₋₆ alkylamino group or a di(C₁₋₆ alkyl)amino group,
wherein, each group represented by R³, R⁴, R⁵ and R⁶ is optionally halogenated, and the C₃₋₈ cycloalkyl group, the C₆₋₁₀ aryl group, the aryl moiety of the (C₆₋₁₀ aryl)C₁₋₆ alkyl group, the C₃₋₈ cycloalkyloxy group, the C₆₋₁₀ aryloxy group, the aryl moiety of the (C₆₋₁₀ aryl)C₁₋₆ alkyloxy group, the aryl moiety of the C₆₋₁₀ arylamino group, the aryl moiety of the (C₁₋₆ alkyl)(C₆₋₁₀ aryl)amino group, and the 3- to 8-membered nitrogen-containing heterocyclic group are optionally C₁₋₆ alkylated],
Z¹ represents a C₁₋₆ alkyl group,
Z² represents a C₁₋₆ alkyl group, and
n represents 0, 1, 2, 3 or 4, and when n represents an integer of 2 or more, each Z² may be the same or different, provided that the total number of carbon atoms in the groups represented by Z¹ and (Z²)n is two or more.
Group A: a group consisting of metsulfuron-methyl, thifensulfuron-methyl, tribenuron-methyl, chlorsulfuron, florasulam, bromoxynil or an agriculturally acceptable ester or salt thereof, pyrasulfotole, dicamba or an agriculturally acceptable ester or salt thereof, fluoroxypyr or an agriculturally acceptable ester thereof, 2,4-D or an agriculturally acceptable ester or salt thereof, and clopyralid or an agriculturally acceptable salt thereof.
Group B: a group consisting of: fenchlorazole-ethyl, cloquintocet-mexyl, and mefenpyr-diethyl.
